(19) United States
(12) Patent Application Publication
(10) Pub. No.: US 2003/0040976 A1
(43) Pub. Date: Feb. 27, 2003

(54) Method of selling products and/or services

(76) Inventors: Peter Adler, Wellesley, MA (US); Roland A. LeBlanc, Holliston, MA (US)

Correspondence Address: IANDIORIO & TESKA, INTELLECTUAL PROPERTY LAW ATTORNEYS, 260 Bear Hill Road, Waltham, MA, 02451-1018, US

(21) Appl. No.: 10/155,425

(22) Filed: May 24, 2002

Related U.S. Application Data
(60) Provisional application No. 60/293,418, filed on May 24, 2001.

(51) Int. Cl. G06F 17/60

(52) U.S. Cl. 705/26

(57) ABSTRACT

A method of selling products and/or services, the method including the steps of obtaining product or service data, seller's data, and Web site choices for each seller of a proposed marketplace, generating a marketplace including selected products or services of each seller based on the seller's product or service data, and generating for each seller of a number of sellers, a business-to-business Web site or a business-to-consumer Web site or both.

### RELATED APPLICATIONS

This application claims priority of Provisional Application No. 60/293,418 filed May 24, 2001, incorporated by reference herein.

### FIELD OF THE INVENTION

This invention relates to an online marketplace, and more particularly to a method of selling products and/or services.

### BACKGROUND OF THE INVENTION

Analysts estimate that of $3.7 trillion in ecommerce sales by 2004, twenty percent will occur business-to-consumer (“B2C”)forty percent single business-to-business (“B2B”), and forty percent through marketplaces. Marketplaces bring many sellers and buyers together, usually at wholesale, and may be public or private.

There are approximately two million retailers in the United States and many more worldwide. The majority of these retailers still do not have Web sites. Those retailers which do have Web sites usually have to design the site, enter product information, and make graphics, which is time consuming and expensive. Most B2C sites are poorly designed and ineffective, lacking such features as useful search functions, shopping carts, and online credit card ordering. In the wholesale arena, there are an estimated 250,000 companies worldwide. These include manufacturers, importers, distributors and wholesalers. Increasingly, these companies are starting their own B2B Web site, but a significant percentage of these companies still do not have Web sites. As in the B2C arena, these Web site are expensive to build and are typically of poor design. Moreover, these Web sites are rarely designed for wholesaling. They do not allow for volume discounts or provide for the parties to negotiate terms, as is common in larger, wholesale transactions.

Marketplaces are notoriously expensive: in 2000, the median price just to start one was five million dollars. Even a “starter marketplace” can cost two to three million dollars. Teams of consultants, designers and programmers are involved in evaluating, designing and building these marketplaces, and adding vendors and their products. Therefore trade groups and smaller companies typically cannot afford to build their own marketplaces.

Moreover, it costs more to maintain Web sites and marketplaces than to build them. Companies spend more on software than on hardware, and tech spending accounts for more than forty percent of the U.S. gross national product.

An Ernst & Young™ ecommerce document advises all wholesalers and retailers not only to sell online, but also to sell through multiple channels (e.g., a B2B site and a wholesale marketplace). This is expensive and inefficient. Each site and marketplace must be built and maintained. Companies must provide product information to the different ecommerce platforms and keep the information current in both places. They receive orders in different ways from the different sites and marketplaces. It also is inefficient for companies to sell their products in one place and to buy products in other places (e.g., their different suppliers' sites and marketplaces).

### BRIEF SUMMARY OF THE INVENTION

It is therefore an object of this invention to provide a unified automated online marketplace and associated seller Web site generation and transaction system.

It is a further object of this invention to provide such a system which automates the formation of marketplaces and sub-marketplaces for goods and services.

It is a further object of this invention to provide such a system which eliminates the costs associated with developing a marketplace.

It is a further object of this invention to provide such a system which dynamically generates marketplaces and Web sites for sellers.

It is a further object of this invention to provide such a system which provides buyers with the ability to form and join buying groups.

It is a further object of this invention to provide such a system which provides buyers with the ability to pool their purchases to qualify for volume discounts.

It is a further object of this invention to provide such a system which provides sellers with the ability to form and join selling groups to increase quantities available for sale.

It is a further object of this invention to provide such a system which integrates shopping in marketplaces and private sites by enabling buyers to move seamlessly between any marketplace and the seller's own associated Web site.

It is a further object of this invention to provide such a system which easily and efficiently generates marketplaces for groups of companies.

It is a further object of this invention to provide such a system which automates online negotiations and transactions between sellers and buyers at wholesale and retail.

It is a further object of this invention to provide such a system which enables anyone easily to create his own marketplace groups and associated Web sites and to establish the rules for participation in the created marketplace.

It is a further object of this invention to provide such a system which enables sellers and buyers to buy and sell through any number and kind of ecommerce platforms.

It is a further object of this invention to provide such a system in which the seller's products are available in multiple marketplaces.

It is a further object of this invention to provide such a system which enables any number of sellers to automatically create new product categories and search criteria unique to each seller.

It is a further object of this invention to provide such a system which automates the creation of multiple marketplaces and associated Web sites for services.

The invention results from the realization that a truly innovative unified, automatic, online marketplace and associated seller website generation and transaction system which significantly reduces the costs associated with generating a marketplace and a seller's website associated with the marketplace is achieved by providing a seller's interface configured to receive the seller's product or service data, seller's data, and the seller's website choices, and a unique software engine configured to dynamically, automatically, and inexpensively generate one or more marketplaces based on the seller's product or service data, and then, based on that marketplace generate a customized Web site for each seller.

This invention features a method of selling products and/or services, the method including the steps of: obtaining product or service data, seller data, and Web site choices for each seller of a proposed marketplace, generating a marketplace including selected products or services of each seller based on the seller's product or service data, and generating for each seller of a number of sellers, a business-to-business Web site or a business-to-consumer Web site or both.

In one embodiment, the method of selling products and/or services further includes the step of generating a revenue model in which a percentage of each seller's sales is paid to a marketplace manager. Ideally, the marketplace manager provides advertising, locates sellers and manages the marketplace activity. In one example, a commission is paid to anyone who refers a company to use the method of selling products and/or services. In one design, the generated marketplace is a business-to-business marketplace or a business-to-consumer marketplace. Ideally, the generated marketplace may be an industry marketplace or region marketplace which includes all marketplaces for wholesale and retail industries and regions. In other examples, the generated marketplace is a public business-to-business wholesale marketplace based on each industry or region. Typically, a business-to-business wholesale group marketplace is based on a set of rules provided by the seller which allows the seller to select the product data available in the marketplace and which sellers can be members of the business-to-business wholesale group marketplace. Ideally, a public business-to-consumer wholesale marketplace is based on each industry or region.

In one example, the generated marketplace is a business-to-consumer wholesale group marketplace based on a set of rules provided by the seller which allow the seller to select the product data available in the marketplace and which sellers can be members of the business-to-business wholesale group marketplace.

### BRIEF DESCRIPTION OF THE DRAWINGS

Other objects, features and advantages will occur to those skilled in the art from the following description of a preferred embodiment and the accompanying drawings, in which:

FIG. 1 is a block diagram showing the primary components associated with one embodiment of the unified automatic online marketplace and associated Web site generation and transaction system in accordance with this invention;

FIG. 2 is a more detailed block diagram of the unified automatic online marketplace and associated Web site generation and transaction system shown in FIG. 1;

FIG. 3 is block diagram showing one example of a public wholesale marketplace, sellers' wholesale Web sites, and a wholesale group marketplace in accordance with this invention;

FIG. 4 is a block diagram of another embodiment of the unified automatic online marketplace and associated Web site generation and transaction system of this invention;

FIG. 5 is a flow chart showing one method for selling products and/or services in accordance with this invention;

FIG. 6A is a view of a Web site screen of the home page of the unified automatic online marketplace and associated seller Web site generation and transaction system in accordance with an embodiment of the subject invention;

FIG. 6B is a Web site screen showing an overview of features and benefits of the subject invention;

FIG. 6C is a block diagram showing the navigation between the various sites and marketplaces in accordance with this invention;

FIG. 6D is view of a Web site screen showing a drop down/select box allowing a buyer to select an industry marketplace or regional marketplace;

FIG. 6E is a view of a industry or regional Web site screen for the industry or region selected in FIG. 6D;

FIG. 6F is a view of a sample Web site screen for an industry of region

FIG. 6G is a view of an industry or regional Web site screen after the “Overview” link in FIG. 6F has been selected;

FIG. 6H is a view of a Web site screen of a selling page within a public wholesale marketplace in an industry;

FIG. 6I is a view of a group wholesale marketplace Web site screen within an industry;

FIG. 6J is a view of a group wholesale marketplace Web site screen for a group marketplace within the wood industry marketplace;

FIG. 6K is a view of a private wholesale Web site home page screen;

FIG. 6L is a view of a private wholesale Web site screen showing how a user can select a category to shop;

FIG. 6M is a view of a page within a private seller's wholesale Web site screen showing all of the products available in the category selected in FIG. 6L;

FIG. 6N is a view of a Web site screen of another seller's private wholesale Web site screen in a different industry;

FIG. 6O is a view of a public retail industry marketplace screen, a Block 6;

FIG. 6P is a view of a group retail marketplace Web site screen, a Block 7;

FIG. 6Q is a view of a seller's private retail Web site screen, a Block 8;

FIG. 7 is view of a sample store Web site screen for a wholesale group marketplace;

FIG. 8A is a view of a registration Web site screen;

FIG. 8B is a view of a Web site screen showing a user registering to sell through a marketplace.

FIG. 8C is another Web site screen showing a user registering to sell;

FIG. 8D is a view of a Web site screen showing the links for a user to select an industry or, if none are applicable, to create a new marketplace;

FIGS. 8E-F are a view of a Web site screen showing a user registering to sell and entering selling preferences;

FIG. 8G is a view of a Web site screen showing that a user that has registered to sell can now choose the various sites and marketplaces the user wishes to activate;

FIG. 9A is a view of a Control Panel Web site screen after the “Seller's Tools” link has been selected showing the various sellers' tools;

FIG. 9B is a view of a Control Panel Web site screen after the “Products” link in FIG. 9A has been selected;

FIG. 9C is a view of a Web site screen of the “About Us” section of a private wholesale site;

FIG. 9D is a view of a Control Panel Web site screen after the “Edit About Us” link in FIG. 9A has been selected.

FIG. 9E is a Web site screen showing a user editing a paragraph of the “About Us” in a seller's private wholesale site;

FIG. 9F is a Web site screen showing the change reflected in the “About Us” text;

FIG. 9G is a view of a Control Panel Web site screen after the “Edit Contact Us” link in FIG. 9A has been selected;

FIG. 9H is a view of a Control Panel Web site screen after the “Edit FAQ” link in FIG. 9A has been selected. Sellers and buyers can enter as many questions and answers as they like, and categories;

FIG. 9I is a view of the seller's Control Panel Web site screen after the “Edit Welcome” link in FIG. 9A has been selected;

FIG. 9J is a view of a Control Panel Web site screen after the “Edit What's New” link in FIG. 9A has been selected;

FIG. 9K is a view of a Control Panel Web site screen after the “Edit Logo” link in FIG. 9A has been selected;

FIG. 9L is a view of a Control Panel Web site screen after the “Edit Banner” link in FIG. 9A has been selected;

FIG. 9M is a view of a Control Panel Web site screen after the “Edit Features” link in FIG. 9A has been selected;

FIG. 9N is a view of a Control Panel Web site screen after the “Edit Clearance” link in FIG. 9A has been selected;

FIG. 9O is a view of a Control Panel Web site screen after the “Add Multiple Products” link in FIG. 9A has been selected;

FIG. 9P is a view of a Control Panel Web site after the “Add Single Product” link in FIG. 9A has been selected screen;

FIG. 9R is a view of a Control Panel Web site screen after the “Create a Category” link in FIG. 9A has been selected;

FIG. 9S is a view of a Control Panel Web site screen after the “Create a Category” hyper text link in FIG. 9A has been selected showing an additional category to be created;

FIG. 9T is a view of the Control Panel Web site screen for defining data fields;

FIG. 9U is a view of the Control Panel Web site screen after the “Power Manager!” link in FIG. 9A has been selected;

FIG. 9V is a continued view of the Control Panel Web site screen in FIG. 9U;

FIG. 9W is a continued view of the Control Panel Web site screen in FIG. 9U;

FIG. 9X is a view of the Control Panel Web site screen after the “Activate/Deactivate Brands” link in FIG. 9A has been selected;

FIG. 9Y is a view of a Control Panel Web site screen after the “Deactivate Products” link in FIG. 9A has been selected;

FIG. 9Z is a view of a Control Panel Web site screen after the “Edit Single Product” link in FIG. 9A has been selected;

FIG. 9AA is a continued view of Control Panel Web site screen in FIG. 9Z;

FIG. 9BB is a view of the Control Panel Web site screen showing the “Edit Prices” feature;

FIG. 9CC is a view of the Control Panel Web site screen after the “Delete Products” link in FIG. 9A has been selected;

FIG. 9DD is a view of the Control Panel Web site screen after the “Multiple Graphics” link in FIG. 9A has been selected;

FIG. 9EE is a view of the Control Panel Web site screen after the “Graphics For One Product” link in FIG. 9A has been selected;

FIG. 9FF is a view of the Control Panel Web site screen after the “Edit File Names” link in FIG. 9A has been selected;

FIG. 9GG is a view of the Control Panel Web site screen showing “Buyer's Tools;

FIG. 9HH is a view of the Control Panel Web site screen after the “Buyer's Tools” link in FIG. 9A has been selected;

FIG. 9II is a view of the Control Panel Web site screen after the “My Sites” link in FIG. 9A has been selected;

FIG. 9JJ is a view of the Control Panel Web site screen after the “Your Options” link in FIG. 9II has been selected;

FIG. 9KK is a view of a Control Panel Web site screen after the “Activate/Deactivate Sites” link in FIG. 9II has been selected;

FIG. 9LL is a view of a Control Panel Web site screen after the “Create New Marketplace” link in FIG. 9II has been selected;

FIG. 9MM is a continued view of the Control Panel Web site screen shown in FIG. 9LL;

FIG. 9NN is a view of a Control Panel Web site screen after the “Form or Join a Group” link in FIG. 9II has been selected;

FIG. 9OO is a view of the Control Panel screen after the “Manager's Tools” link in FIG. 9A has been selected;

FIG. 9PP is a view of a Control Panel Web site screen after the “Remove From Group” link in FIG. 9OO has been selected;

FIG. 9RR is a view of a Control Panel Web site screen after the “View Members Sites” link in FIG. 9OO has been selected;

FIG. 9SS is a view of a Control Panel Web site screen after the “Invite Others to Join” link in FIG. 9OO has been selected;

FIG. 9TT is a view of a Control Panel Web site screen after the “E-mail All Members” link in FIG. 9OO has been selected;

FIG. 9UU is a view of a Control Panel Web site screen after the “Create/Edit Links” link in FIG. 9OO has been selected;

FIG. 9VV is a view of a Control Panel Web site screen after the “Marketing” link in FIG. 9OO has been selected;

FIGS. 9WW-9ZZ are continued views of FIG. 9VV;

FIG. 10A is a view of a typical marketplace Web site screen;

FIG. 10B is a view of a typical marketplace Web site screen showing an overview of the benefits of selling through a particular marketplace in accordance with this invention;

FIG. 10C is a view of a marketplace Web site screen showing the general features, wholesale functionality, and dynamic pricing in accordance with this invention;

FIG. 10D is a view of a typical marketplace Web site screen showing multiple marketplaces driven from a single database;

FIG. 10E is a view of the automated features of the unified automatic online marketplace in accordance with the subject invention;

FIG. 10F is a view of a typical marketplace Web site screen showing the pricing required for a vendor to join the marketplace;

FIG. 10G is a view of a typical marketplace Web site screen showing an example of a link from a marketplace;

FIG. 10H is a view of a typical marketplace Web site screen showing one example of a travel section of services;

FIG. 10I is a view of a typical marketplace Web site screen showing how shoppers can select and browse links to various countries and regions;

FIG. 10J is a view of a typical marketplace Web site screen showing the search by category drop down box;

FIG. 10K is a view of a typical marketplace Web site screen after a search category has been selected;

FIG. 10L is a view of a private seller's Web site after the seller's link in FIG. 10K has been selected;

FIG. 10M is a Web site screen showing a view inside a marketplace and the various selected categories and the icons for the various products;

FIG. 10N is a view of a Web site screen showing another product selected from a marketplace;

FIG. 11A is a view of a typical marketplace Web site screen showing the shopping cart model feature in accordance with the subject invention;

FIG. 11B is a view of a transaction Web site screen where a buyer is reviewing pending orders;

FIG. 11C is a continuation of the view in FIG. 11B;

FIG. 11D is a view of a transaction Web site screen showing a buyer reviewing the proposed purchase order from a seller;

FIG. 11E is a view of a transaction Web site screen in which a buyer initiates negotiations;

FIG. 11F is a view of a transaction Web site screen where a buyer has placed a wholesale purchase order with one seller;

FIG. 11G is a view of a transaction Web site screen showing that a seller received an e-mail for a new order;

FIG. 11H is a view of a transaction Web site screen where a buyer has proposed terms of a transaction and the seller has not agreed;

FIG. 11I is a view of transaction Web site screen where the seller changes the status of the transaction to “Yes”;

FIG. 11J is a view of a transaction Web site screen where the buyer receives the seller's counter offer;

FIG. 11K is a view of a transaction Web site screen where the seller receives notice that the buyer has accepted the order;

FIG. 11L is a view of a transaction Web site screen showing that the seller has shipped an order;

FIG. 11M is a view of transaction Web site screen showing a company in the transaction section of its Control Panel;

FIG. 11N is a continued view of the Web site screen shown in FIG. 11M;

FIG. 11O is a continued view of the Web site screen shown in FIG. 11M;

FIG. 11P is a continued view of the Web site screen shown in FIG. 11M;

FIG. 11Q is a view of a Web site transaction screen showing how a buyer can use a closed transaction to reorder;

FIG. 12A is a view of one possible design of the various tables associated with a database in accordance with the subject invention;

FIG. 12B is a design view of the vendor table in accordance with one embodiment the subject invention;

FIG. 12C is an example of the vendor table showing the various fields associated with the vendor table;

FIG. 12D is a continued view of the vendor table shown in FIG. 12C;

FIG. 12E is a design view of one embodiment of the products table in accordance with the subject invention;

FIG. 12F is a continued view of the design view of the products table shown in FIG. 12E;

FIG. 12G is a view of one possible design of the products table of this invention showing the various fields associated with the products table;

FIG. 12H is a continued view of the products table shown in FIG. 12G;

FIG. 12I is a continued view of the products table shown in FIG. 12G;

FIG. 12J is a continued view of the products table shown in FIG. 12G;

FIG. 12K is a continued view of the products table shown in FIG. 12G;

FIG. 12L is a continued view of the products table shown in FIG. 12G;

FIG. 12M is an example showing the various search options that a seller has selected;

FIG. 13A is a flow chart showing the check-out process in accordance with the subject invention;

FIG. 13B is a continuation of flow chart shown in FIG. 13A;

FIG. 13C is a flow chart showing the various steps involved with registering to sell in accordance with the subject invention;

FIG. 13D is a flow chart showing the various steps involved in registering to buy in accordance with the subject invention;

FIG. 13E is a flow chart showing the various steps involved in adding a new product in accordance with the subject invention;

FIG. 13F is a continuation of the flow chart shown in FIG. 13E; and

FIG. 13G is flow chart showing the various steps involved in selecting a site to shop.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

As described in the Background section of the invention above, the planning and building of a marketplace is very expensive, typically costing millions of dollars to generate. This high cost is associated with hiring a team of consultants, designers and programmers to survey and create a marketplace. And, if a company desires to sell in multiple online marketplaces, such as business-to-business marketplace and a trade group marketplaces, or to sell through a marketplace and a company's own business-to-business Web site, each marketplace and Web site must be developed independently, further escalating the costs. Moreover, having separate marketplaces and Web sites requires companies to send all product information to multiple places and to receive orders for processing in a multitude of different ways. As can be seen, this technique is very inefficient and expensive, and results in more than four percent of the gross national product going to technology costs.

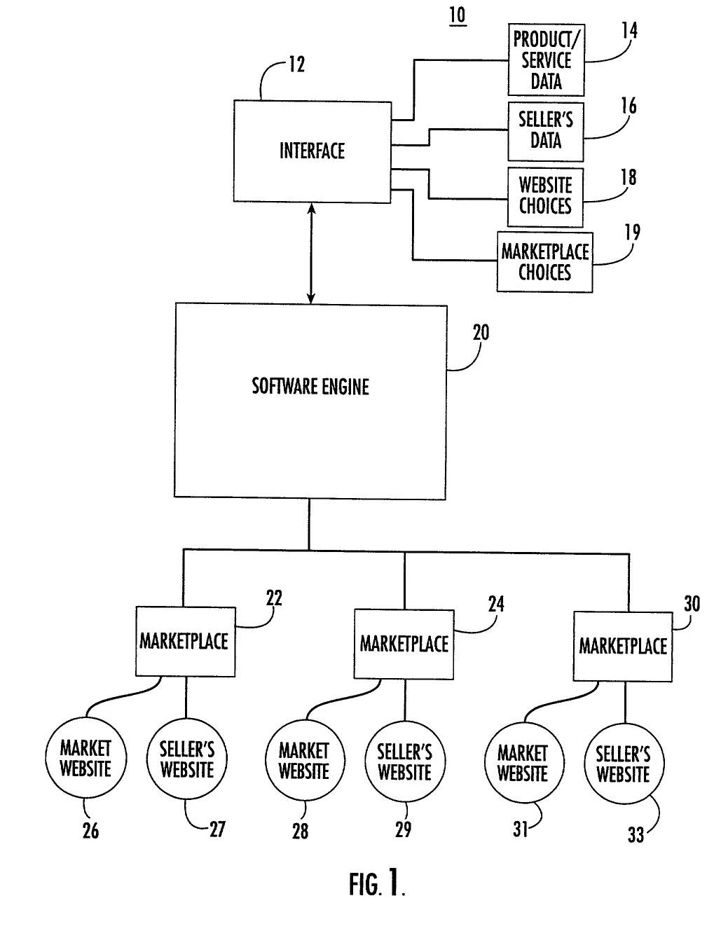

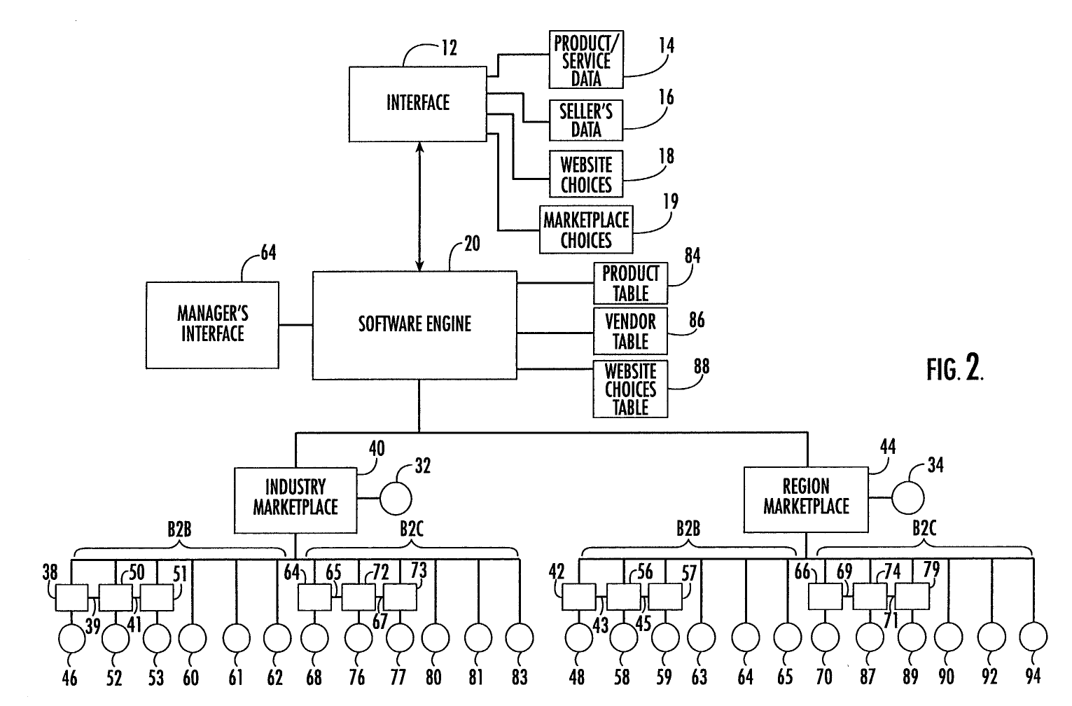

In sharp contrast, the unified automatic online marketplace and associated Web site generation and transaction system 10, FIG. 1 of this invention includes seller's interface 12 configured to receive seller's product or service data 14, data about the seller (seller's data 16), seller's Web site choices 18, and seller's marketplace choices 19. System 10 further includes software engine 20 configured to automatically and dynamically generate one or more marketplaces, such as business-to-business marketplace 22, business-to-consumer marketplace 24, or marketplaces for services 30 based on the seller's product or service data 14, and then, based on seller's data 16, Web site choices 18, and marketplace choices 19, generate company Web sites, such as Web sites 27, 29, and 31 for the seller.

In one design of this invention, software engine 20 is configured to generate business-to-business marketplace 22, Web site 26 showing all the products of all the sellers in the business-to-business marketplace 22, and Web site 27 for each of the sellers in the business-to-business marketplace 22. In another design, software engine 20 is configured to generate business-to-consumer marketplace 24, Web site 28 showing all of the products of all of the sellers in the business-to-consumer marketplace 24, and Web site 29 for each of the sellers in the business-to-consumer marketplace 24. Typically, a shopping cart model is used on the Web site for each of the sellers in the business-to-business marketplace or the business-to-business Web site to process orders from the buyer, e.g., Web sites 27 or 29 to process orders from a buyer. Ideally, a transaction record is generated for each negotiated offer and each counteroffer proposed by a buyer or seller. Ideally, the one or more marketplaces based on a buyer's selection criteria are efficiently, automatically, and dynamically generated by software engine 20.

In another design of this invention, software engine 20 is configured to generate a marketplace for services 30, Web site 31 showing all of the services of all of the service providers in the marketplace for services 30, and private Web site 33 for each of the providers for services in the marketplace for services 30.

The innovative design of the unified automatic online marketplace and associated Web site generation system of the subject invention dynamically generates one or more marketplaces, such as a business-to-business or a business-to-consumer marketplace or a marketplace for services (e.g., lodging, accounting services), based on the seller's product or service information. Then the same information dynamically and automatically generates Web sites—wholesale, retail or both, or services—for the seller, associated with the marketplace. There is no need for complicated and expensive market research and programming which requires teams of consultants and programmers to build the marketplace and then the Web site(s). Indeed, there is no need to plan or design a single Web page. Instead, the seller's marketplaces and its associated Web sites are dynamically generated by the unique software engine based on the seller's product or service data received by the system through the seller's interface. The result is the ability of a seller or a group of sellers to efficiently and easily develop a wide range of marketplaces, sub-marketplaces and associated Web sites at no cost, as opposed to five million dollars just to start a single marketplace.

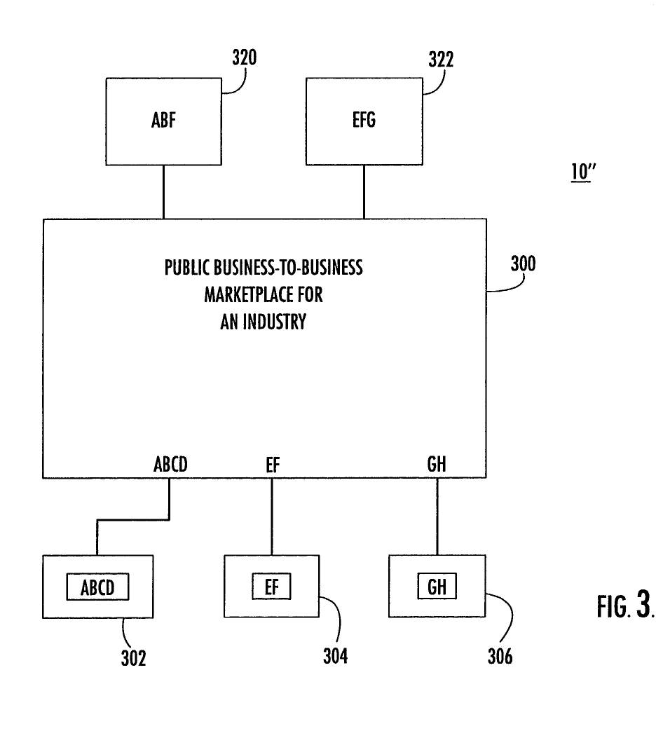

In one embodiment of this invention, the one or more marketplaces generated by software engine 20 may be industry marketplace 40, FIG. 2 and region marketplace 44 which includes all marketplaces for wholesale and retail industries in a given industry or region. Typically, Web sites are generated for each industry marketplace 40 or region marketplace 44, such as Web sites 32 and 34.

In one example of this invention, a public business-to-business wholesale marketplace is generated for each industry marketplace 40 or region marketplace 44. For example, public business-to-business wholesale marketplace 38 is generated for industry marketplace 40, and public business-to-business wholesale marketplace 42 is generated for region marketplace 44. Ideally, a public business-to-business Web site is generated for each public business-to-business wholesale marketplace, such as public business-to-business Web sites 46 and 48.

In one preferred design, business-to-business wholesale group marketplaces are generated based on a set of rules provided by the seller which allows the seller to select the product data available in business-to-business wholesale group marketplaces and which sellers can be a member of business-to-business wholesale group marketplaces. Typically, business-to-business wholesale group Web sites are generated for each the business-to-business group wholesale marketplace. For example, business-to-business wholesale group marketplaces 50 and 51 (for industry marketplace 40) and business-to-business wholesale group marketplace 56 and 57 (for region marketplace 44) are generated based on a set of rules provided by the seller which allows the seller to select the product data available in business-to-business wholesale group marketplaces and which sellers can be a member of business-to-business wholesale group marketplaces. Ideally, a business-to-business wholesale group Web site is generated for each of the business-to-business group wholesale marketplace, such as Web sites 52, 53, 58, and 59.

For example, public business-to-business marketplace 300, FIG. 3, such as a wood industry marketplace, is dynamically generated based on seller's 302, 304, and 306 product data and sellers data provided by the sellers 302-306. In this example, seller 302 offers wood products A, B, C, and D, seller 304 offers wood products E and F, and seller 306 offers wood: products G and H. Software engine 20, FIG. 2 dynamically and automatically generates public business-to-business marketplace 300, FIG. 3 which contains wood products A-H. Any of seller's 302, 304, and 306 can form a business-to-business wholesale group marketplace, such as private business-to-business whole groups 320 and 322 based on a set of rules which allows any of seller's 302, 304, or 306 to select the product data available in business-to-business wholesale group marketplace 320 and 322 and which sellers can be a member of business-to-business wholesale group marketplaces 320 and 322. In this example, seller 302 has formed business-to-business wholesale group 320 and selected products A and B to be available in business-to-business wholesale group 320, and has further allowed seller 304 to be a member of business-to-business wholesale group 320. Seller 304 in turn has elected to have only product F available in business-to-business wholesale group 320. Similarly, in this example, seller 304 has formed business-to-business wholesale group 322 and selected product E to be available in business-to-business wholesale group 322 and has allowed seller 306 to be a member of business-to-business wholesale group 322. Seller 306, in turn, has elected to have only product G available in business-to-business wholesale group 322.

In one example in accordance with this invention, software engine 20, FIG. 2 is configured to provide a manager's interface 64 which allows a seller manager to select the set of rules and product available in the business-to-business wholesale group marketplaces (e.g., marketplaces 50, 51, 56 or 57) and the rules that dictate which sellers can be a member of business-to-business wholesale group.

In one embodiment, a private business-to-business seller's Web site, such as Web site 60, 61, 62, 63, 64, or 65, is generated by software engine 12 based on the seller's selected product or service data.

In other examples, a public business-to-consumer wholesale marketplace is generated for each industry marketplace 40 or region marketplace 44. For example, public business-to-consumer wholesale marketplace 64 (for industry marketplace 40) is generated by software engine 20, and public business-to-consumer wholesale marketplace 66 (for region marketplace 44) is generated by software engine 20. In one preferred example, a public business-to-consumer Web site is generated for each public business-to-consumer wholesale marketplace, such as Web sites 68 and 70.

Ideally, business-to-consumer wholesale group marketplaces are generated based on a set of rules provided by the seller which allows the seller to select the product data available in business-to-consumer wholesale group marketplaces and which sellers can be a member of business-to-consumer wholesale group marketplaces. Ideally, a business-to-consumer wholesale group Web site is generated for each business-to-consumer group wholesale marketplace. Similarly to the above example, business-to-consumer wholesale group marketplaces 72 and 73 (for industry marketplace 40) and business-to-consumer wholesale group marketplaces 74 and 79 (for region marketplace 44) are generated based on a set of rules provided by the seller which allows the seller to select the product data available in business-to-consumer wholesale group marketplaces 72, 73, 74 and 79 and which sellers can be a member of business-to-consumer wholesale group marketplaces 72, 73, 74 and 79. Typically, a business-to-consumer wholesale group Web site is generated for the business-to-consumer group wholesale marketplace, such as Web sites 76, 77, 87 and 89.

Similarly, as described above for the business-to-business marketplaces, manager interface 64 allows a seller manager to select the set of rules and product available in the business-to-consumer wholesale group marketplaces and which sellers can be a member of business-to-consumer wholesale group marketplaces. In one example, a private business-to-consumer seller's Web site, such as Web site 80, 81, 83, 90, 92 or 94 is generated by software engine 12 based on the seller's selected product or service data.

In one design of this invention, buyers can enter through any of the public business-to-business marketplace and enter a business-to-business wholesale group marketplace, as indicated at lines 39, 41, 43 and 45. Similarly, buyers can enter through any of the public business-to-consumer marketplaces and enter a business-to-consumer wholesale group marketplace, as indicated at lines 65, 67, 69, and 71.

Thus, in accordance with this invention, software engine 20 is configured to dynamically generate one or more market groups based on the product or service data selected by the seller. Manager interface 64 ideally provides security passwords and codes selected by the seller generating the business-to-business wholesale marketplace or the business-to-consumer marketplace for restricting access to the market group. Typically, sellers can join the business-to-business wholesale marketplace or the business-to-consumer marketplace by entering security passwords and codes. Ideally, the seller's product or service data 14 are entered by an online form provided by seller's interface 12. In one example, the seller's product or service data and seller's data are received by software engine 20 in the form of an electronic spreadsheet. Typically, the seller's product or service data is in the form of digital images and text.

In one design, the seller's interface 12 is configured to add, delete, or update product or service data 14, seller data 16, and Web site choices 18. Seller's interface 12 may also be configured to allow a seller to provide search criteria based on the seller's product data or service data 14 used by a buyer when searching the marketplace or market group. Typically, seller's product or service data 16 includes model number, SKU number, price and product description, although this is not a necessary limitation of this invention, as seller's data may include any other information relevant to the seller's product. Seller data 14 typically includes company name, address, contact information, payment method and market group selections, although any other relevant information to seller data may be included. In one preferred design of this invention, seller's interface 12 is configured as a graphical seller's Control Panel. Ideally, software engine 20 dynamically generates marketplaces or market groups based on the marketplaces or market groups entered by the seller's.

Unified automatic online marketplace and associated Web site generation and transaction system 10, FIG. 2 typically includes a product table 84 having at least one record for each seller's product or service data. System 10 further includes vendor table 86 having at least one record for vendor. System 10 also includes Web site table 88 having at least one record for each vendor. Vendor table 86 typically includes fields for vendor type, vendor ID, vendor address information, and which marketplaces the vendor is a member of. Software engine 20 accesses vendor table 86 to determine the marketplaces or market groups which have been entered by the sellers though seller's interface 12. Ideally, software engine 20 dynamically generates marketplaces and market groups based on the marketplaces found in the vendor table 86. Typically, the product table 84 includes fields for product description, product graphics, product categories and search fields. In one example, software engine 20 accesses product table 84 and determines the products entered by the sellers though seller's interface 12. Software engine 20 dynamically generates marketplaces or market groups based on the products found in product table 84. Web site table 88 typically includes fields for banner and logo graphics and text. Software engine 20 accesses Web site table 88 to determine the seller's Web site choices. Ideally, software engine 20 dynamically generates the seller's Web site based on the Web site choices found in the Web site table 88.

In one embodiment of this invention, software engine 60 provides for unlimited data in a select field or a drop down select box of fixed length by allowing the width of the select field or drop down select box to be dynamically changed and further providing for words in the select field or drop down select box to wrap.

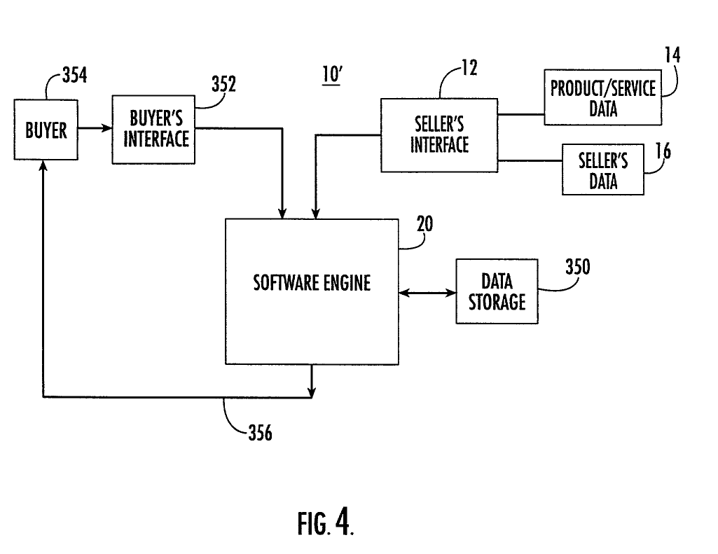

Unified automatic online marketplace and associated Web site generation and transaction system 10′, FIG. 4 includes seller's interface 12 configured to receive product or service data 14 and seller's data 16. System 10′ also includes data storage means 350, such as a database, table, or text file. System 10′ further includes buyers interface 352 configured to receive a selected marketplace from buyer 354. Software engine 20 is responsive to both seller's interface 12 and buyer's interface 352 and is configured to generate one or more records for data storage means 350 and to access data storage means 350. Software engine 20 provides for all seller's whose data indicates the seller's are a member of a selected marketplace, those seller's product or service data to buyer 354, as indicated at line 356. In one design, the selected marketplace may be a business-to-business marketplace or a business-to-consumer marketplace, or any of the marketplaces described above.

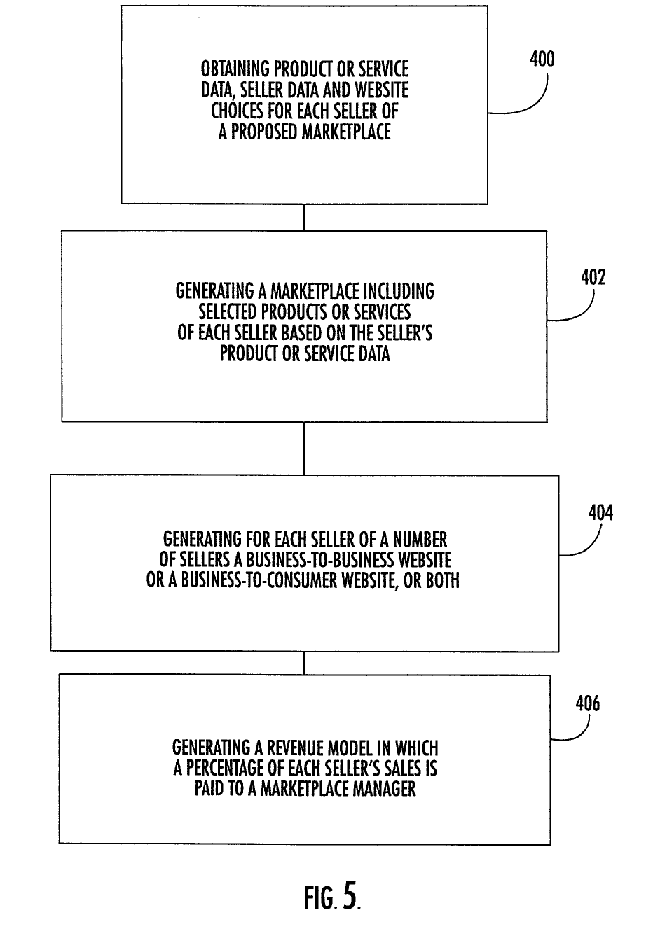

The method of selling products and/or services of this invention typically includes the steps of: obtaining product or service data, seller data, and Web site choices for each seller of a proposed marketplace, step 400, FIG. 5; generating a marketplace including selected product or services of each seller based on the sellers product or service data, step 402; and generating for each seller of a number of sellers, a business-to-business Web site or a business-to-consumer Web site, or both, step 404.

In one embodiment, the method of selling products further includes the step of generating a revenue model in which a percentage of each seller's sales is paid to a marketplace manager, step 406. Ideally, the marketplace manager provides advertising, locates sellers, and manages the marketplace activity. In one example, the generated marketplace is a business-to-business marketplace or a business-to-consumer marketplace. In other examples, the generated marketplace in accordance with the method of selling products and/or services of this invention is an industry or region marketplace which includes all marketplaces for wholesale and retail industries and regions, or a public business-to-business wholesale marketplace based on each industry or region. The generated marketplace in accordance with method of selling products and/or services of this invention may also be a business-to-business wholesale group marketplace based on a set of rules provided by the seller which allow the seller to select the product data available in the marketplace and which sellers can be members of the business-to-business wholesale group marketplace. The generated marketplace may also be a public business-to-consumer wholesale marketplace based on each industry or region. In another example, the generated marketplace is a business-to-consumer wholesale group marketplace based on a set of rules provided by the seller which allows the seller to select the product data available in the marketplace and which sellers can be members of the business-to-business wholesale group marketplace.

As shown above, the truly innovative design of the unified automatic online marketplace and associated Web site generation and transaction system of the subject invention provides the ability to efficiently and dynamically generate one or more marketplaces based on the seller's product or service information. The robust system automatically generates a Web site for each marketplace for the seller. The result is the elimination of expensive development costs associated with building marketplaces and the associated Web sites, which require teams of consultants and programmers and typically can cost millions of dollars to develop. Buyers can easily shop the marketplaces by selecting a marketplace to shop in and the unique system of the subject invention detects the user's selection and generates Web sites for the buyer's selection.

In one specific embodiment of the subject invention, the unified automatic online marketplace and associated seller Web site generation and transaction system is disclosed in accordance with the figures discussed below. As disclosed below, the Web site screens may represent seller's interface 12, FIGS. 1, 2, and 4 with the associated seller's product or service data 14 and seller's data 16, Web site choices 18, manager's interface 64, FIG. 2, or buyer's interface 352, FIG. 4.

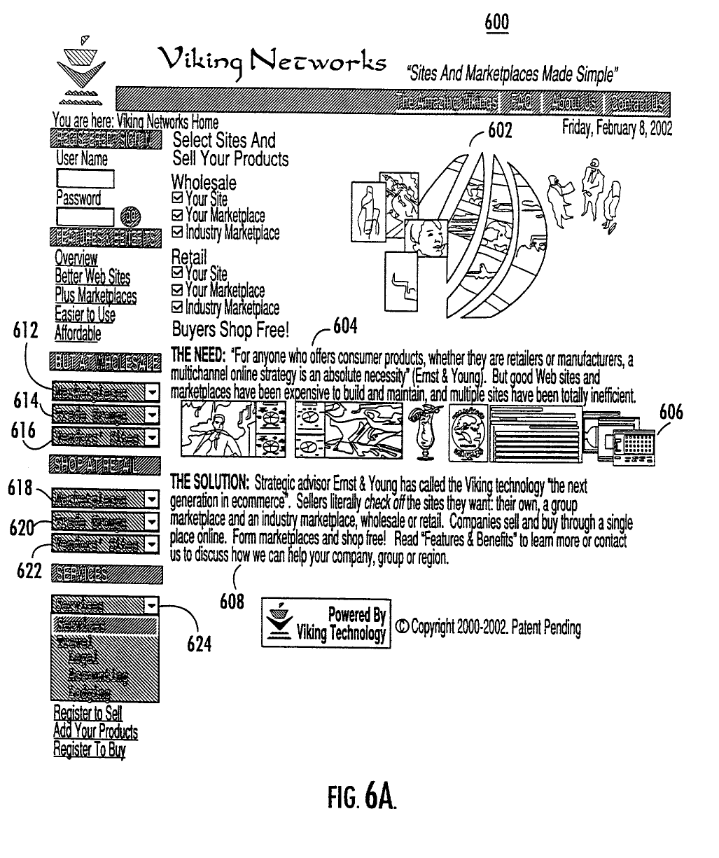

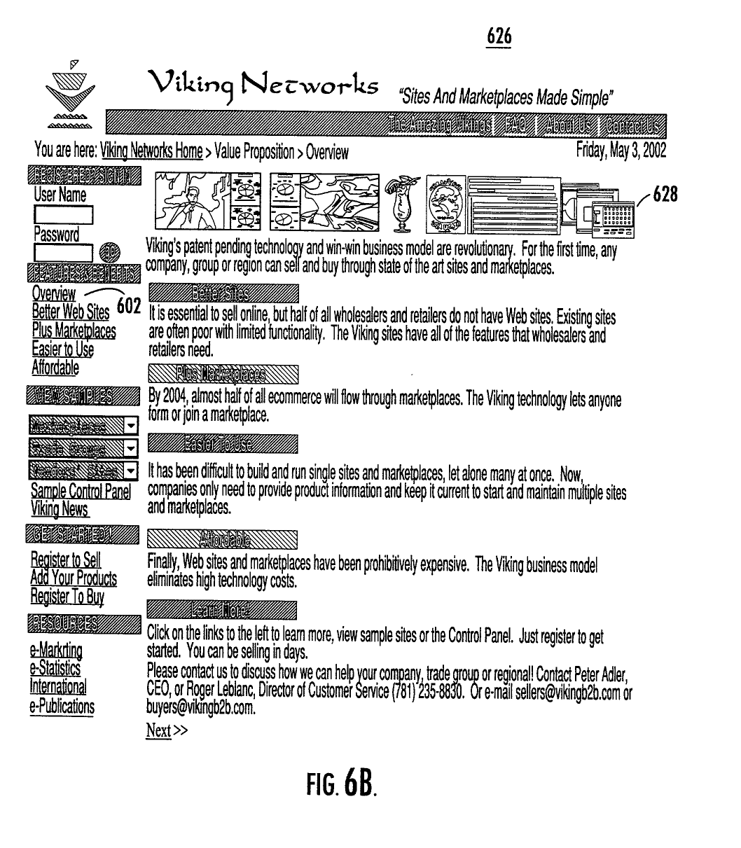

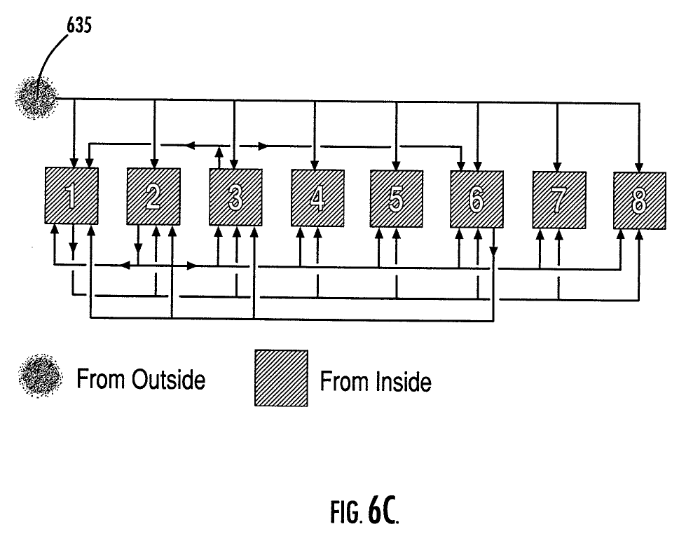

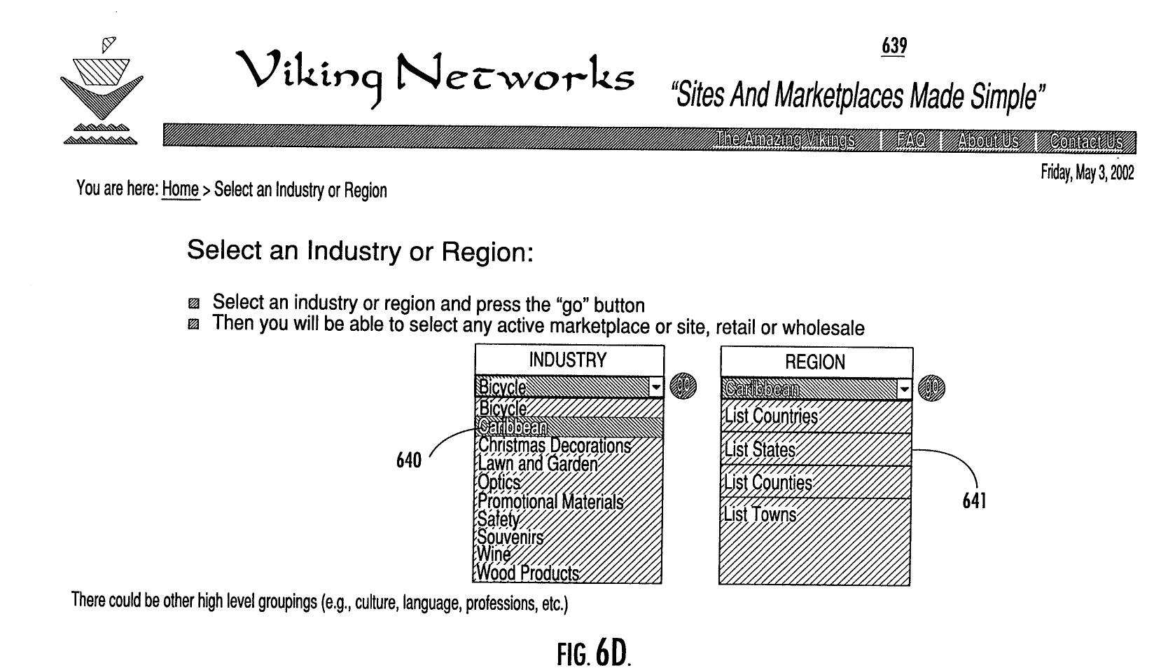

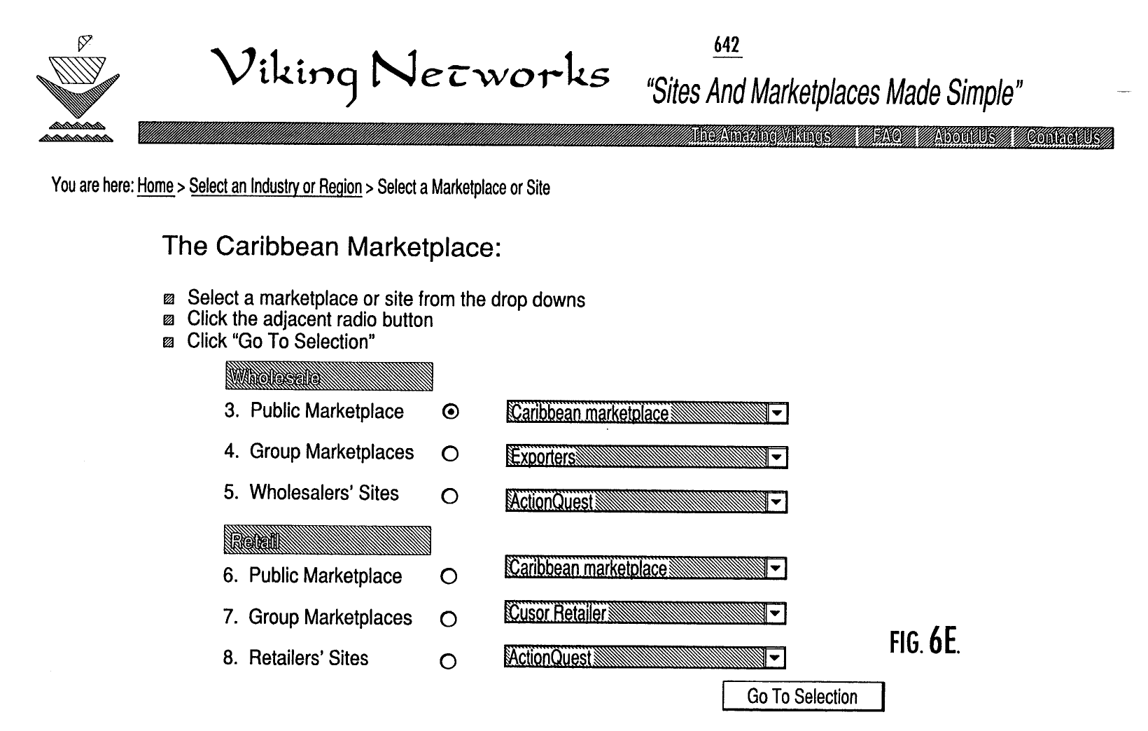

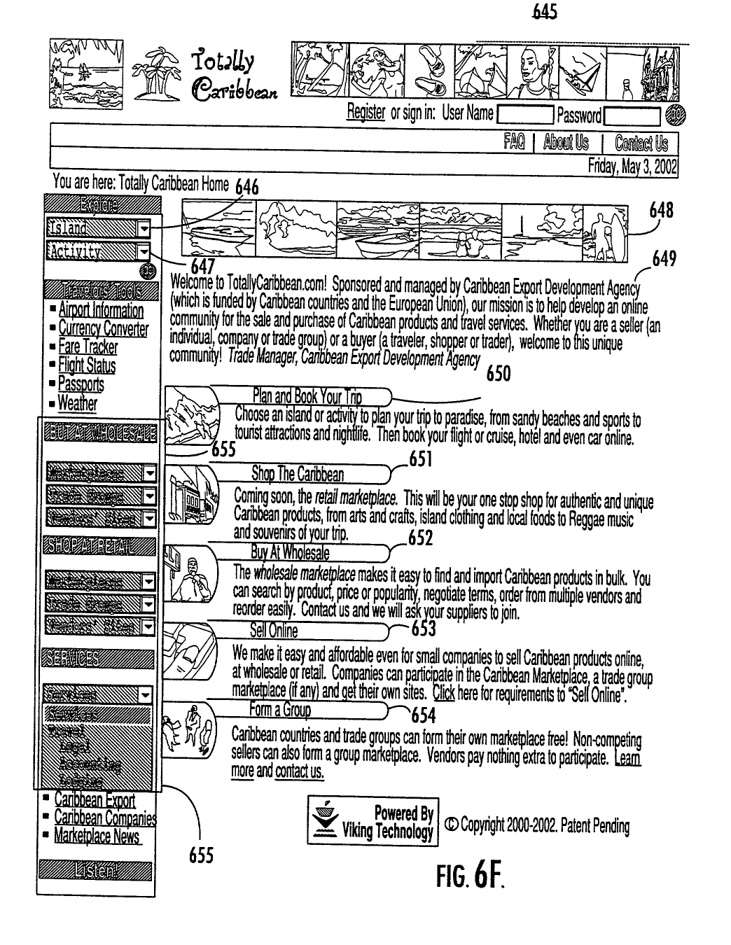

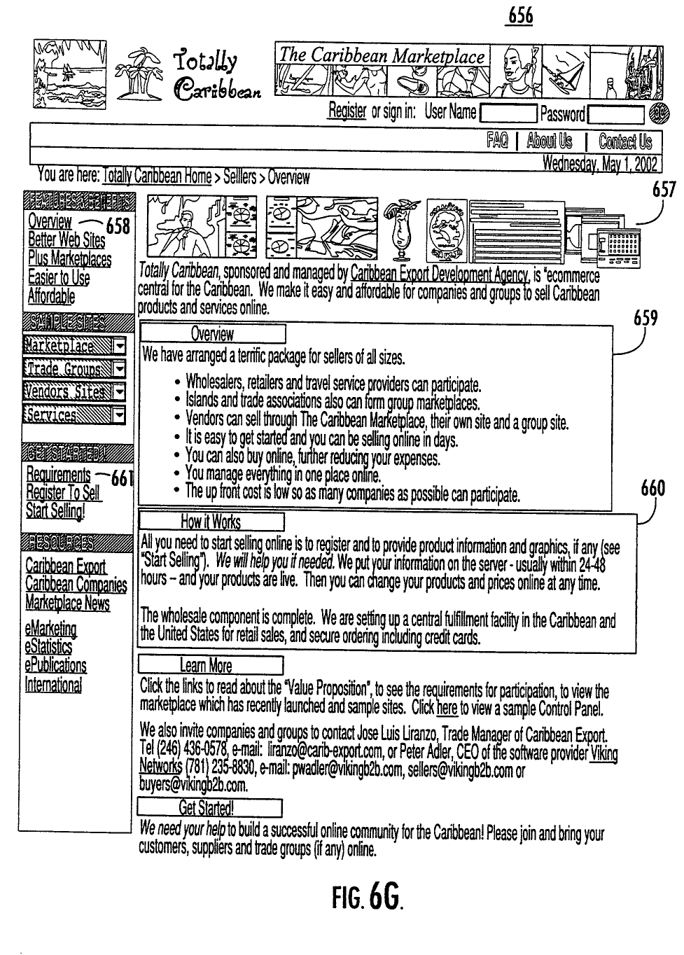

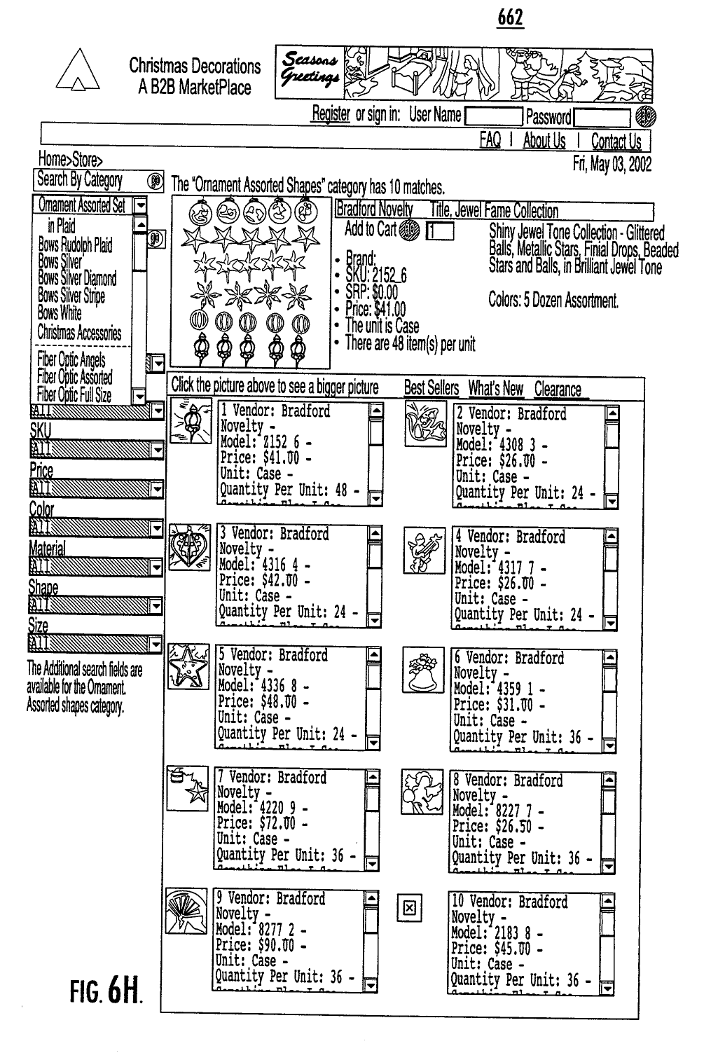

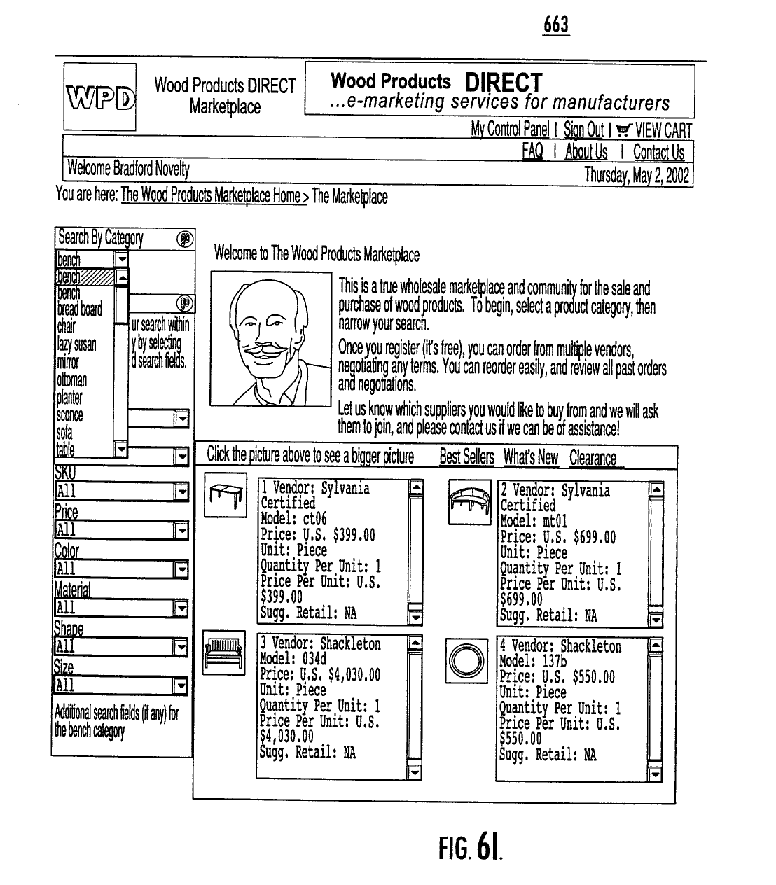

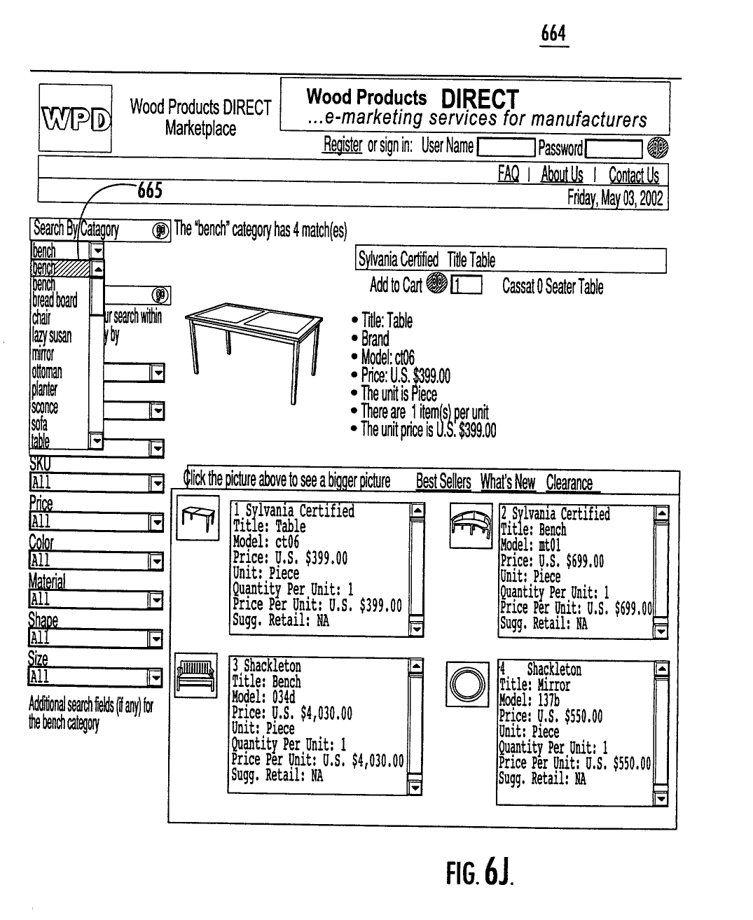

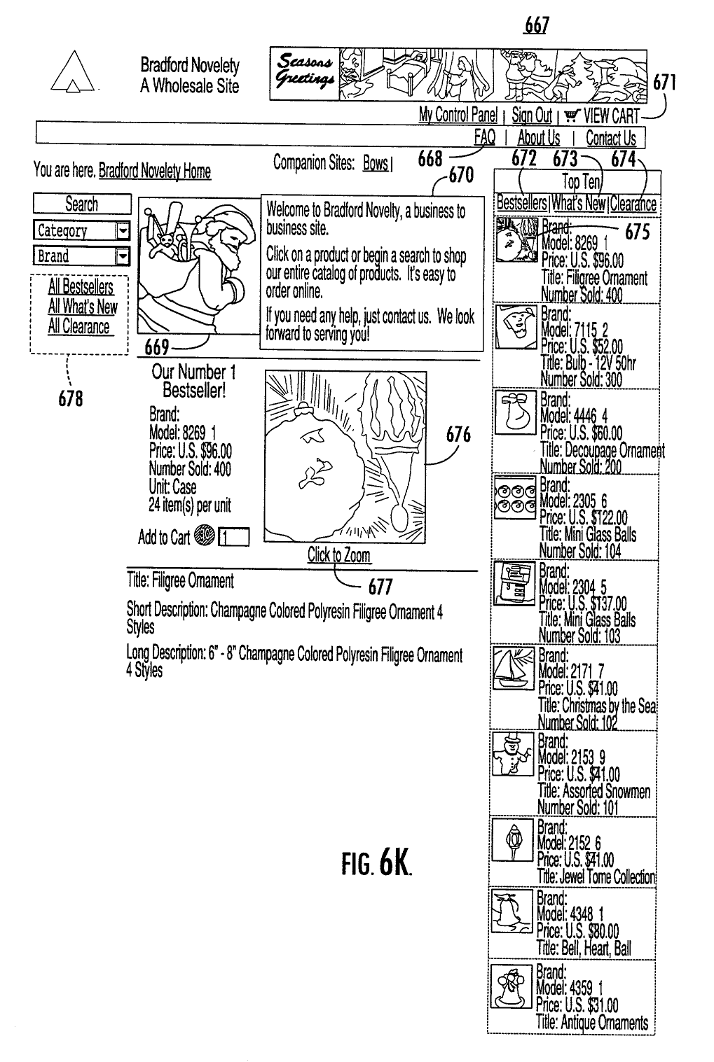

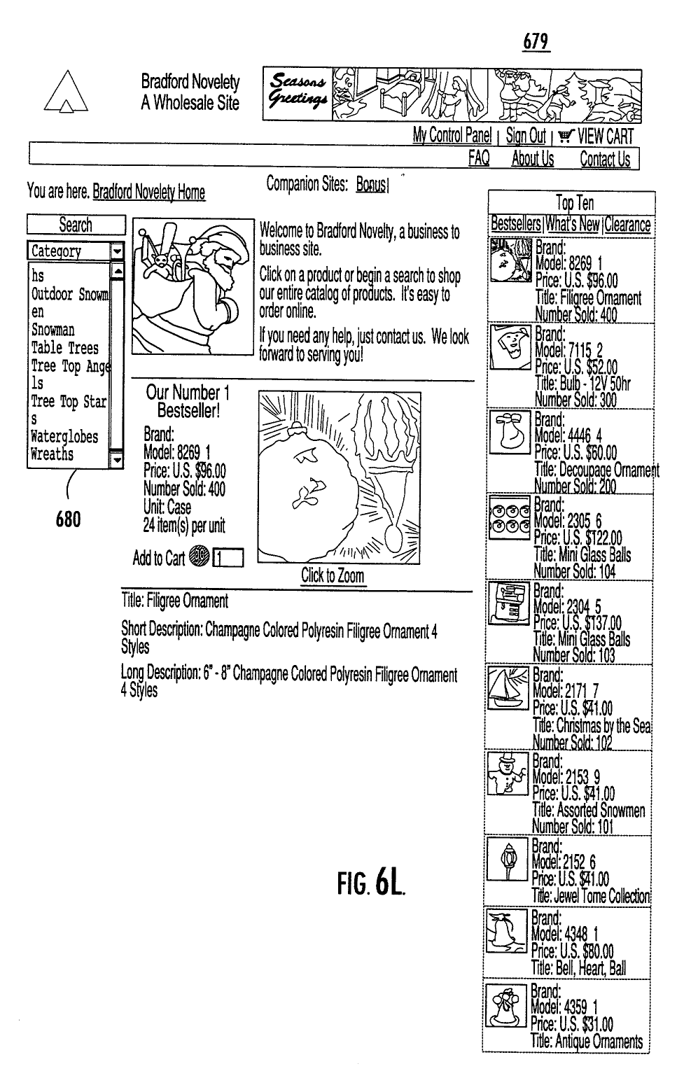

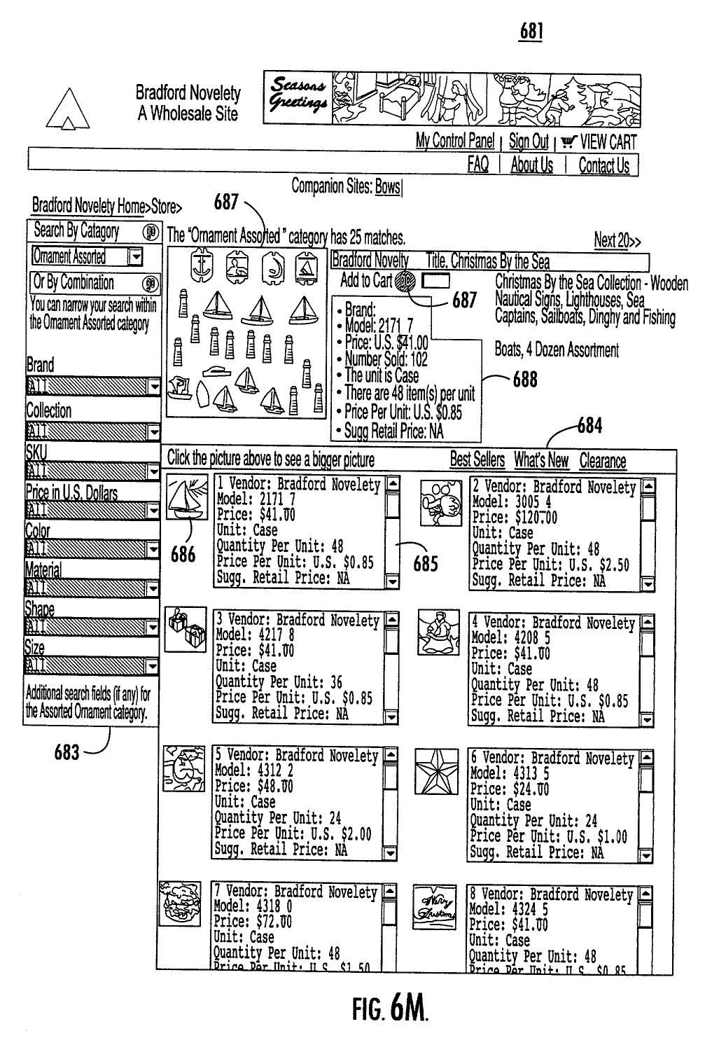

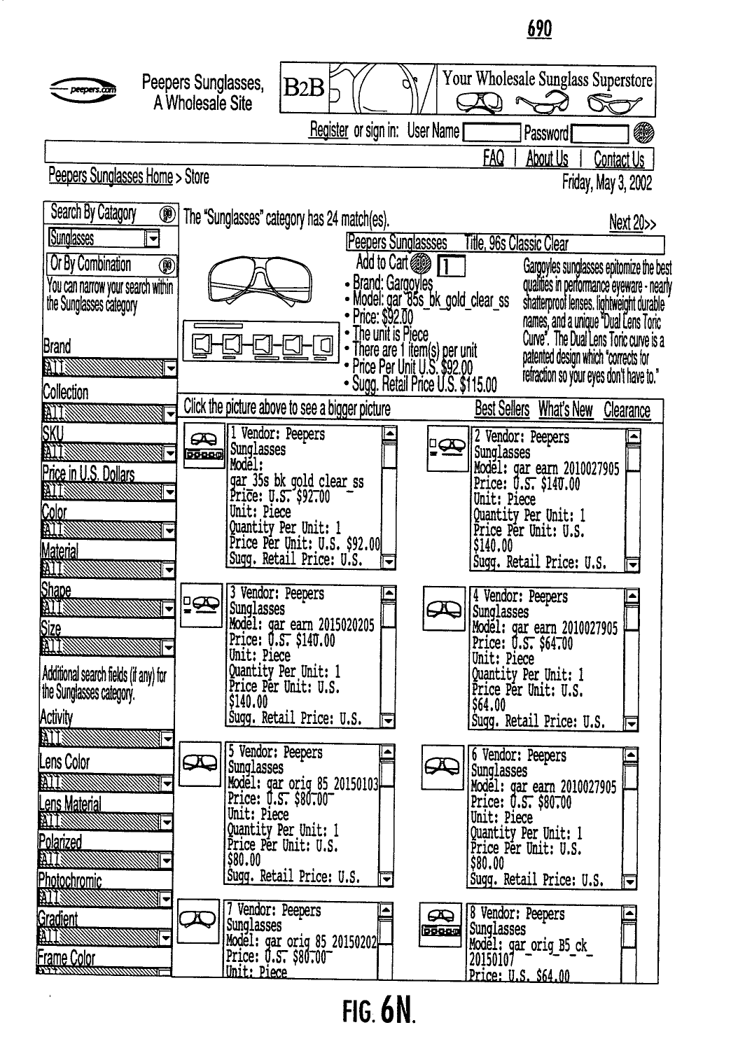

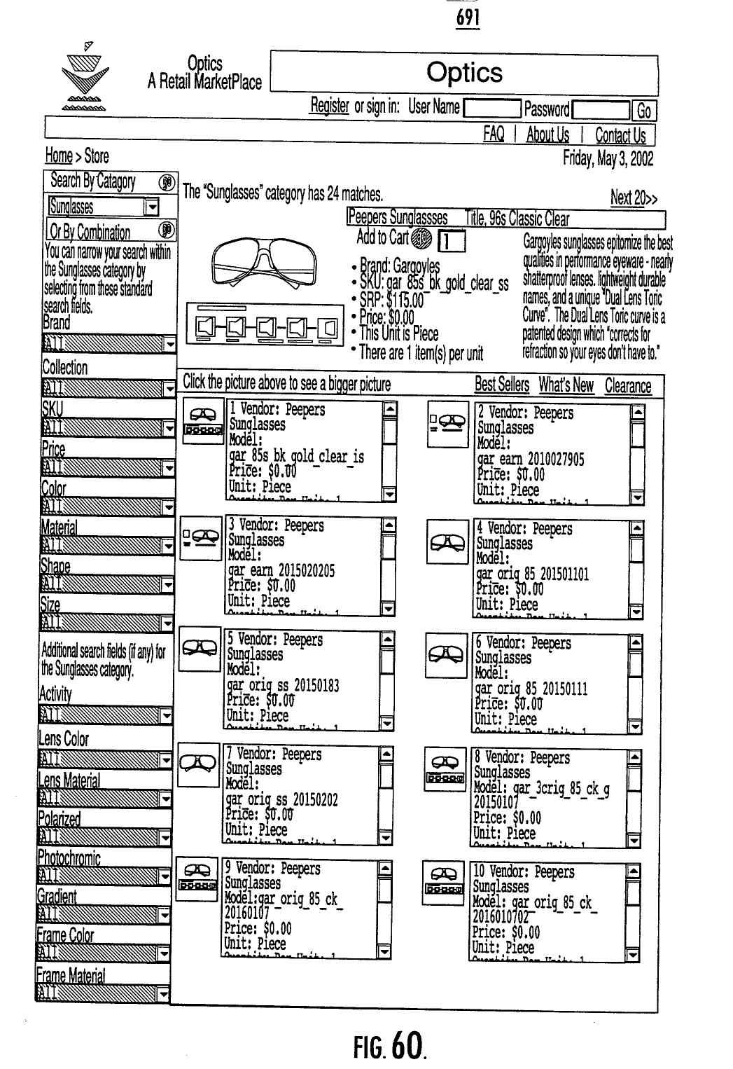

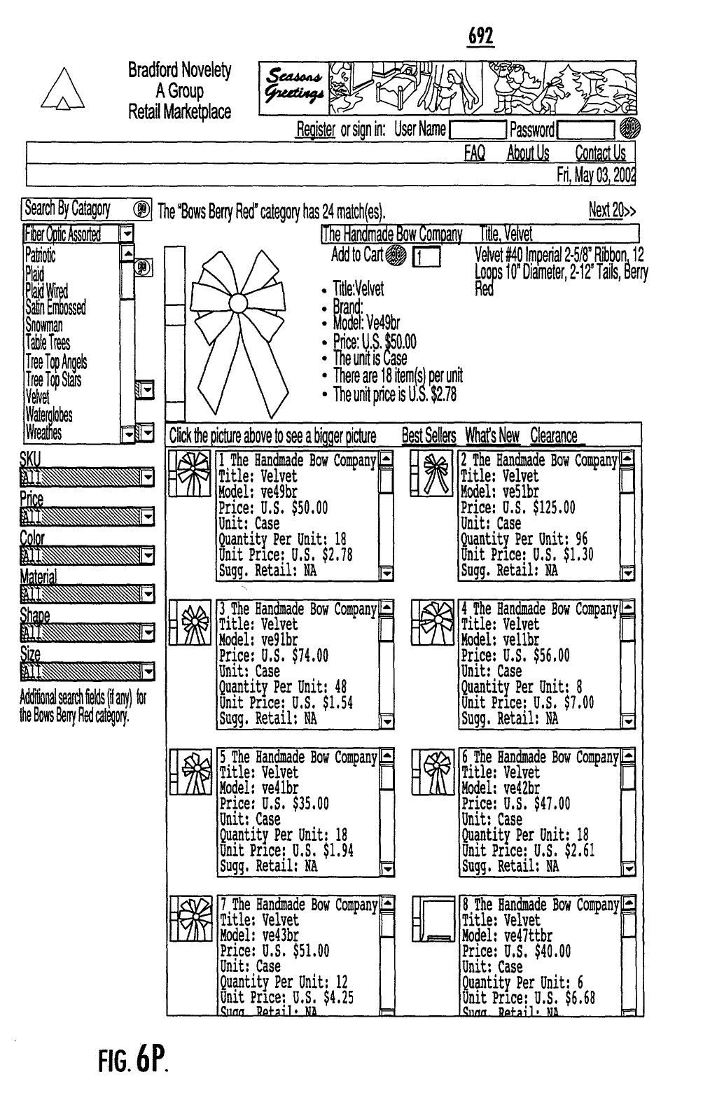

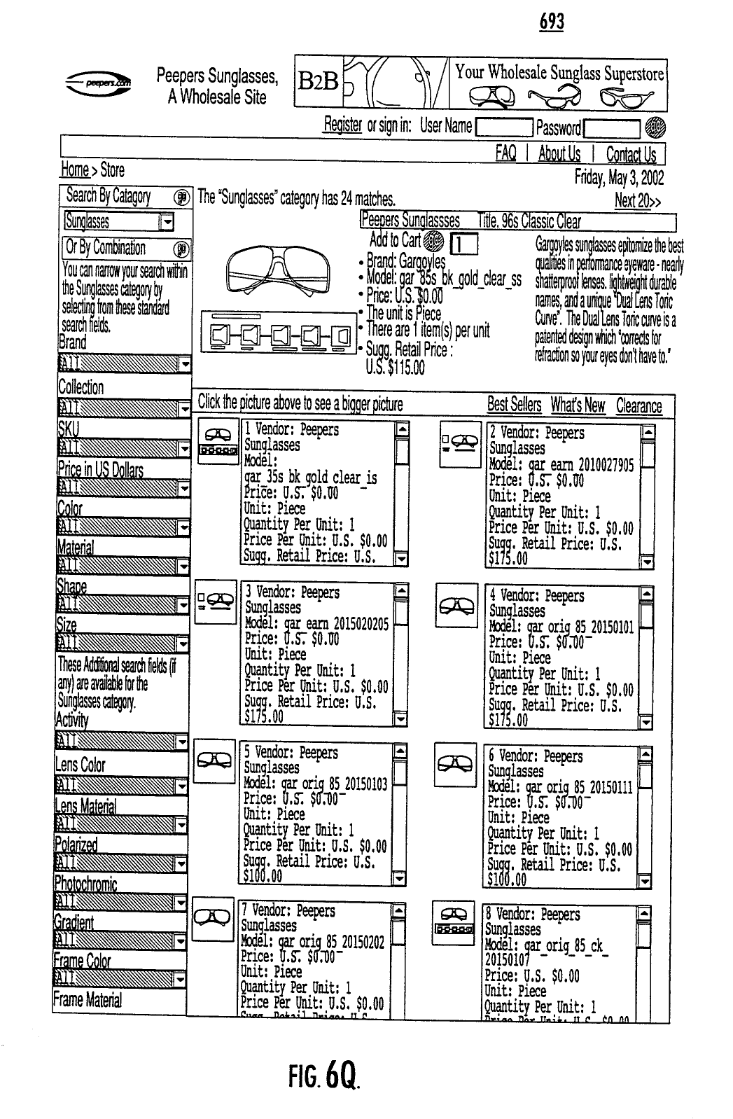

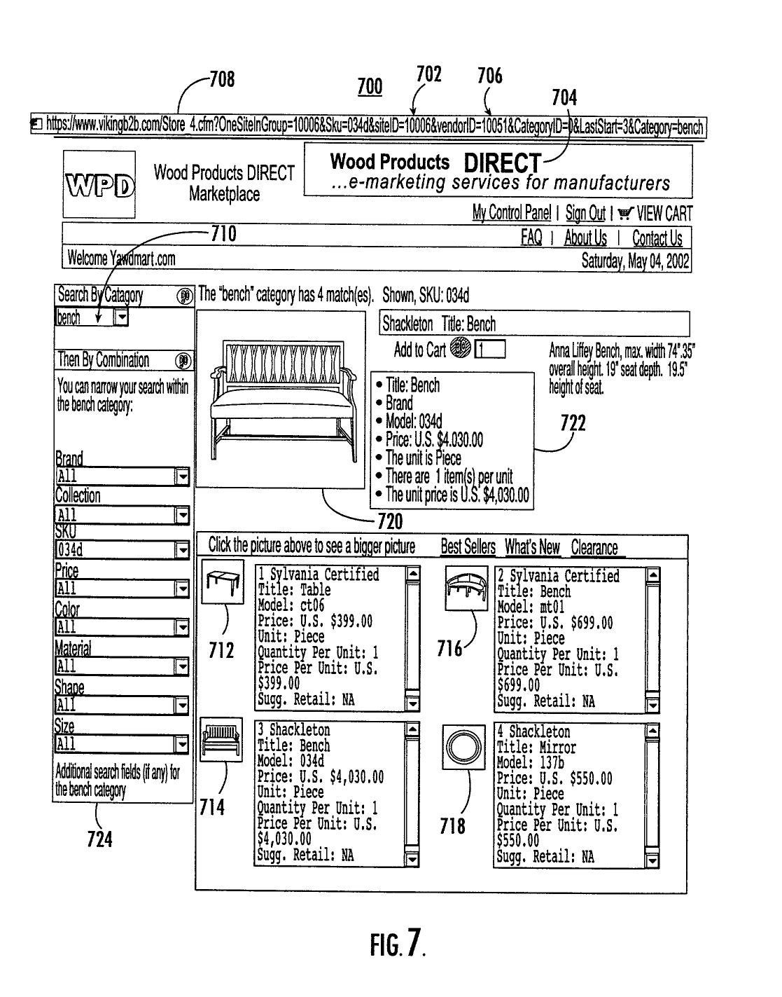

Home page Web site screen 600, FIG. 6A is a view of the home page of the unified automatic online marketplace and associated seller Web site generation and transaction system operating on a server in accordance with one embodiment of the subject invention. Home page Web site screen 600 includes graphics picture 602, graphics banner 606, text blocks 604 and 608, various links, such as “Overview” link 610, buy at wholesale drop-down boxes 612, 614, and 616, shop at retail drop-down boxes 618, 620, and 622, and services drop-down box 624. Web site screen 626, FIG. 6B shows an overview of the features and benefits of the subject invention after the “Overview” link 610 of Web site screen 600, FIG. 6A has been selected. FIG. 6C shows one likely navigation scheme through the various marketplaces in accordance with the subject invention. Block 1 represents the main company portal which contains all sites and marketplaces. Block 2 represents an industry or regional portal which contains all sites and marketplaces within the industry or region, wholesale or retail. Block 3 represents a public wholesale marketplace for an industry or region. Block 4 represents a group wholesale marketplace, for example, Cigar Growers of Dominican Republic, typically, but not always a sub-group of block 3. Block 5 depicts a private wholesale site. Block 6 represents a public retail marketplace, block 7 represents a group retail marketplace, and block 8 represents a seller's private retail site. FIG. 6C depicts a typical navigation from outside any site or marketplace indicated by circle 635. Any user can enter any of the ecommerce platforms 1-8 represented by blocks 1-8 directly. If a user is in a marketplace (Blocks 3 and 4, if wholesale, or blocks 6 and 7, if retail, it can move from there to the private site of any seller in the marketplace (Blocks 5 or 8, respectively). This is useful for buyers to obtain more information about the seller. On the other hand, if a user is in a seller's private site (e.g., block 5 private wholesale site or block 8 private retail), the user cannot get out of the site. The private seller does not want buyers to leave its Web site, especially not to go to a marketplace in the industry with competing sellers. By entering the main company portal, represented by block 1, a user can go to any of the marketplaces in accordance with the system of the subject invention. A user entering into an industry or regional portal, as represented by block 2, allows a user to enter any site or marketplace in that industry or region. A user entering into a public wholesale marketplace, represented by block 3, will see the products of all wholesale sellers in that industry or region. Thus, a buyer searching for “hats” within a wholesale marketplace will see all hats available for wholesale purchase, regardless of which company is selling the hats.

FIG. 6D is a view of a selected industry or region, Web site screen 639, showing drop-down/select boxes 640 and 641. These allow users to select any active retail or wholesale marketplace. Web site screen 642, FIG. 6E, is a sample view of an industry or regional Web site for the industry or region selected in FIG. 6D. A user selects the marketplace (all participating sellers), a group marketplace, or a seller's private site by selecting from a combination of radio buttons and drop-down boxes. Web site screen 645, FIG. 6F, is a sample regional portal which contains all sites and marketplaces in an industry or region (in this example, the Caribbean region). Marketplace managers can create custom links for their respective region or industry by selecting from drop-down boxes 646 and 647. Here, the links lead to information about 450 activities organized by Caribbean island. Welcome graphics logo 648 and welcome text 649 are typically displayed. Web site screen 645 also includes links to custom or region portals 650, shop at retail link 651, buy at wholesale link 652, sell online link 653, where a seller learns about selling registers and selects places to sell and provides data, and forms a group link 654, wherein any user can automatically form a group within the marketplace displayed. Users can buy or sell goods and services by clicking on any of the drop-down/select boxes in block 655.

Web site screen 656, FIG. 6G is an overview of the features and benefits for sellers showing graphic banner 657, which is unique to this marketplace. In this example, the user has selected the seller's Overview link 658. Text block 659 depicts some of the unique features in accordance with the subject invention, such as the ability for wholesalers, retailers, and travel providers to participate in the marketplace, the ability to form sub-group marketplaces, that vendors can sell through the marketplace (in this example, the Caribbean marketplace), sellers can have their own sites within subgroups, with up to six “places” to sell including wholesale and retail (although the possible number is unlimited), and the ability to buy online. Text block 660 shows that all that is needed to begin selling online is to register and provide product information and graphics. Clicking “Requirements” link 661 will show the requirements to join this group.

Web site screen 662, FIG. 6H is a view of a wholesale marketplace in an industry. In this example, the store or shopping page is within the Christmas decorations industry. All products display in this marketplace regardless of who sells them. This is a typical home page for this particular marketplace (e.g., this is a “store” page).

Web site screen 663, FIG. 61 shows a group wholesale marketplace within an industry (wood). Web site screen 664, FIG. 6J shows a group wholesale marketplace, a group marketplace within the wood industry marketplace. As can be seen in this example, the user has selected “bench” from drop down/select box 665.

Web site screen 666, FIG. 6K is an example of a private wholesale Web site home page. Users can add or change graphic banner 667 by clicking on “My Control Panel” link 668. Users can also change the sites to do business with by clicking on “My Control Panel” link 668 and also change graphic 669 and text 670 which will be displayed on Web site screen 666. Users can buy and sell by clicking the “View Cart” link 671, and also click on “Bestsellers” link 672 to display the top ten best sellers. Users can also click on “What's New” link 673 to find out what's new in the marketplace, and find out which clearance items are available by clicking on “Clearance” link 674. Clicking on thumbnail graphic 675, which represents a product in the marketplace, will display an enlarged picture 676 of the selected product. Picture 676 can be further enlarged by clicking on clicking on the “Click to Zoom” link 677, which will generate an optional 400×400 pixel picture. Link box 678 has links to “All Bestsellers”, “All What's New”, and “All Clearance” and links to the “store” page.

Web site screen 679, FIG. 6L shows a user beginning to shop at a seller's private wholesale site. In this example, a user selects a category or brand by selecting from drop down/select box 680. Web site screen 681, FIG. 6M shows the product the user selected in Web site screen 679, FIG. 6L and all matches in the category. The user than can expand the search by using the standard search criteria or narrow the search, as shown by the collection of drop down/select boxes 683. Thumbnail graphics for all the searched products are displayed in block 684 and a user can find more information about the product by using a scroll tab. For example, a user can use scroll tab 685 for thumbnail graphic 686 to see more information about the product displayed by thumbnail graphic. The user can also click on the thumbnail icon, such as thumbnail icon 686 and a larger graphics 687 will appear along with a longer description 688. A user can then easily purchase the item by enter the desired quantity and clicking on the “Go” shopping cart link 689.

Web site screen 690, FIG. 6N is a view of another seller's private wholesale Web site for a different industry, in this example optics. Web site screen 691, FIG. 6O shows an example of a retail industry marketplace, in this example optics. Web site screen 692, FIG. 6P shows a group retail marketplace within the Christmas decoration marketplace. Web site screen 693, FIG. 6Q is a view of one seller's private retail site.

The software in accordance with this invention, such as software engine 20 and seller's interface 12, FIGS. 1, 2, and 4, manager's interface 64, FIG. 2, or buyer's interface 352, FIG. 4, may be written in HTML (markup language) and with Cold Fusion™ by Macromedia™, with Java Script™ and other languages. However, other software can be used, as well as other programming languages. The software in accordance with this invention generates what the user sees through the browser. For example, the inventors' hereof Viking™ home page Web site in accordance with this invention contains all the information for marketing, the selling sites and marketplaces, as well as the shopping and the control features. The software interacts extensively with a database through questions or queries of different tables in it (often multiple tables). Depending upon the answers (what is in the database), different results are shown through the browser. For example, sample store page for a wholesale Web site screen 700, FIG. 7 is shown for a group wholesale marketplace (such as Cigar Growers of the Dominican Republic). In this example, the buyer has chosen the wood industry site ID 10006, as indicated by arrow 702 in the group called wood products direct marketplace, as indicated by banner 704. The group has been formed and is being managed by the company with vendor ID 100051, as indicated by arrow 706. When the buyer selects that group marketplace within the wood industry, it is taken to the home page or start of the sub-marketplace at the location: index_{—}4.cfm?Site ID=10006&VendorID=100051&SiteType=b2bGroupVendor. This “URL” instructs a browser to find page index_{—}4.cfm (the home page for a wholesale group marketplace). The software on index—4.cfm indicates to include the header from the page header_{—}4.cfm. This indicates to locate the SiteID, Vendor ID, and SiteType from the URL. The software then checks that this company has formed a wholesale group marketplace. The software then finds the name, logo, banner, and welcome picture and text for the marketplace and displays it in the header, as shown by banner 704. The software then queries database table TblVendor this company (vendor 100051) and locates the column containing the eleven digit number, with the five digit site ID (in this example 10006 for wood) and six digit member ID for all members of the group, separated by commas. These are all companies in the group. The software then finds all companies in the group that have checked “yes” to keep its participation in the group active. The home page typically has a customized welcome, but otherwise currently looks similar to store_{—}4.cfm, as shown in FIG. 7. Here, the buyer has selected the product category bench as indicated by arrow 710. The page store_{—}4.cfm, indicated by arrow 708 shows all types of benches, as indicated by thumbnail icons 712, 714, 716, and 718. In this example, the buyer has clicked thumbnail 714 and medium size picture 720 is displayed along with expanded description 722. Collection of drop down/select boxes 724 shows standard search criteria for the bench category. The seller's of benches have entered data in these fields (e.g., prices) for all benches in their product tables. A copy of the computer code required for this example and a store page for a wholesale group marketplace is attached hereto as an Appendix.

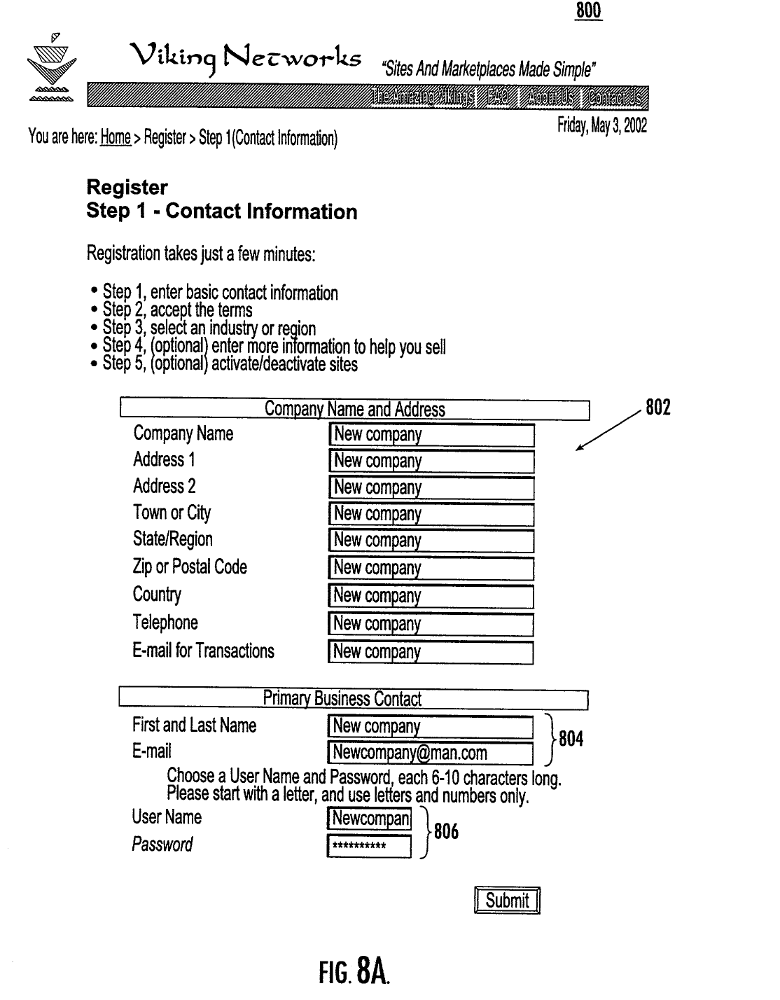

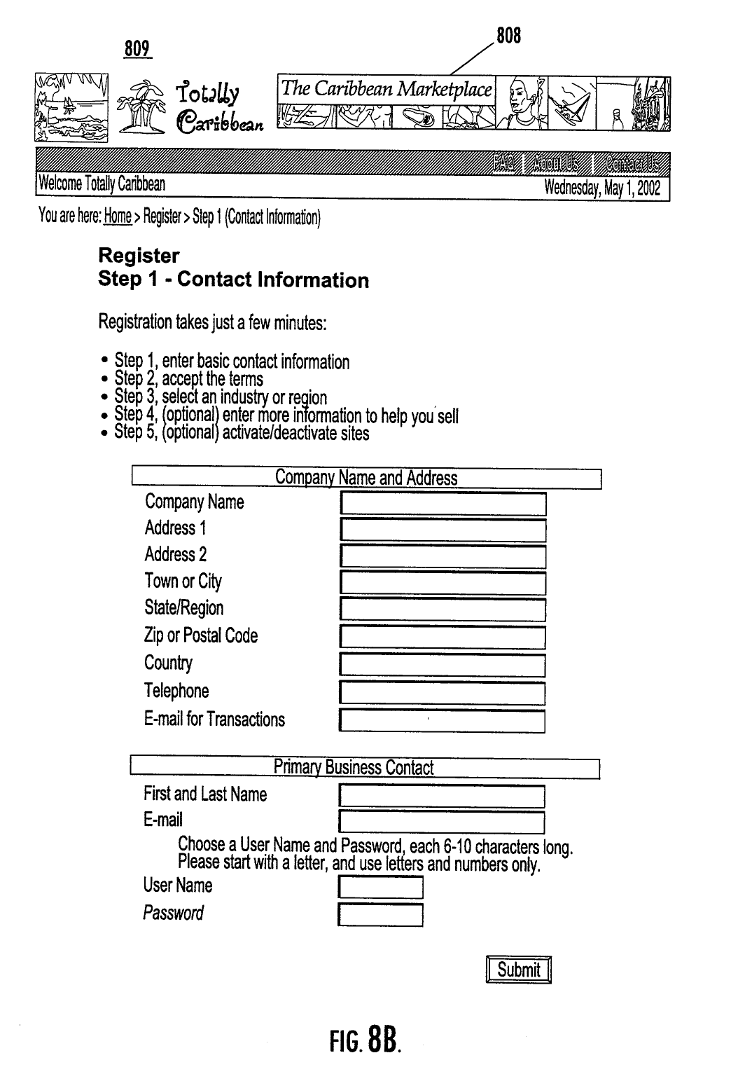

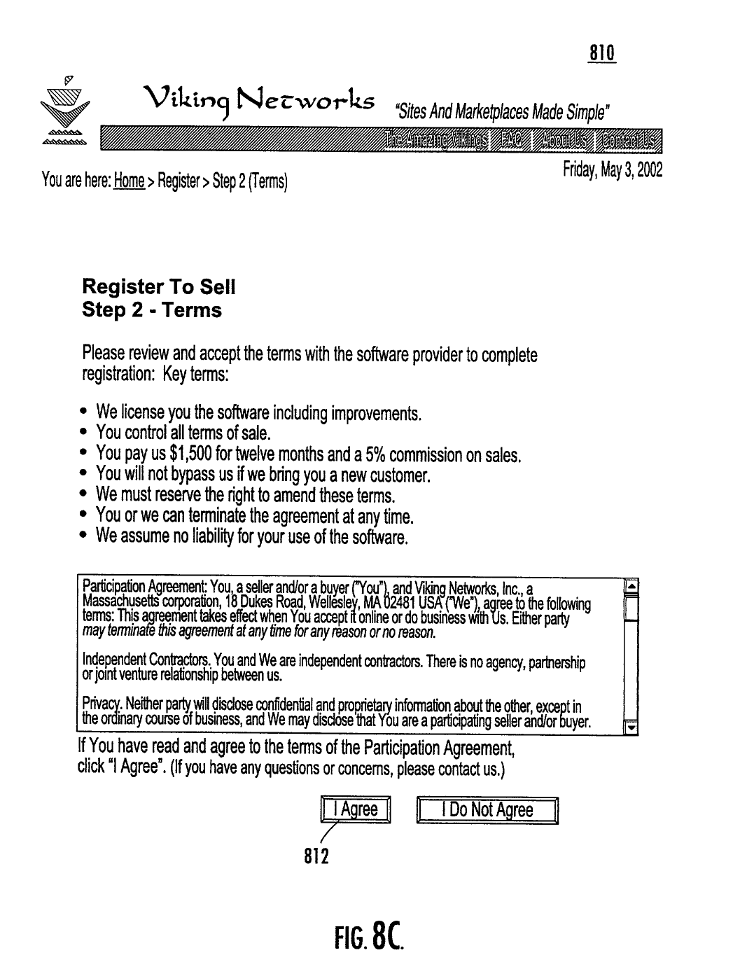

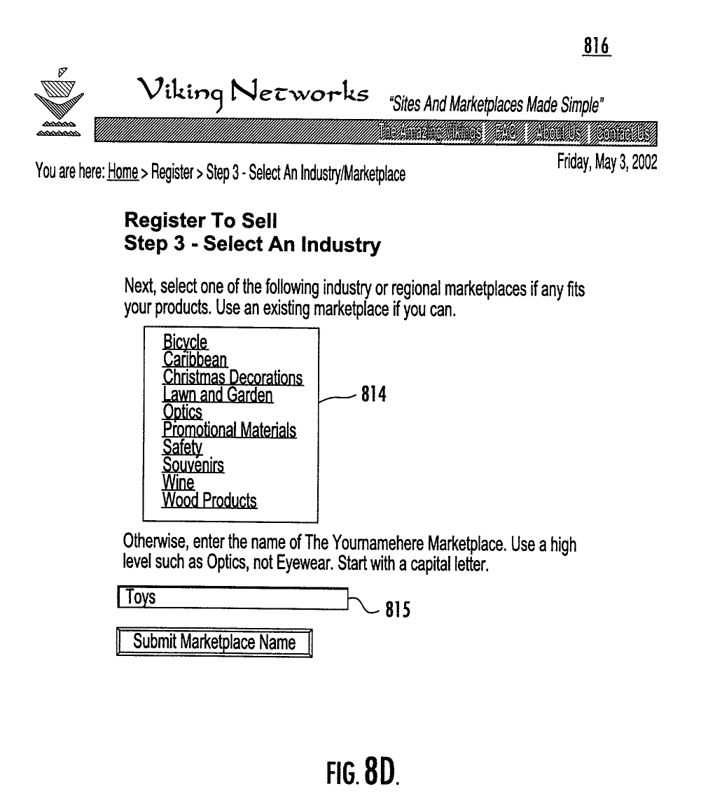

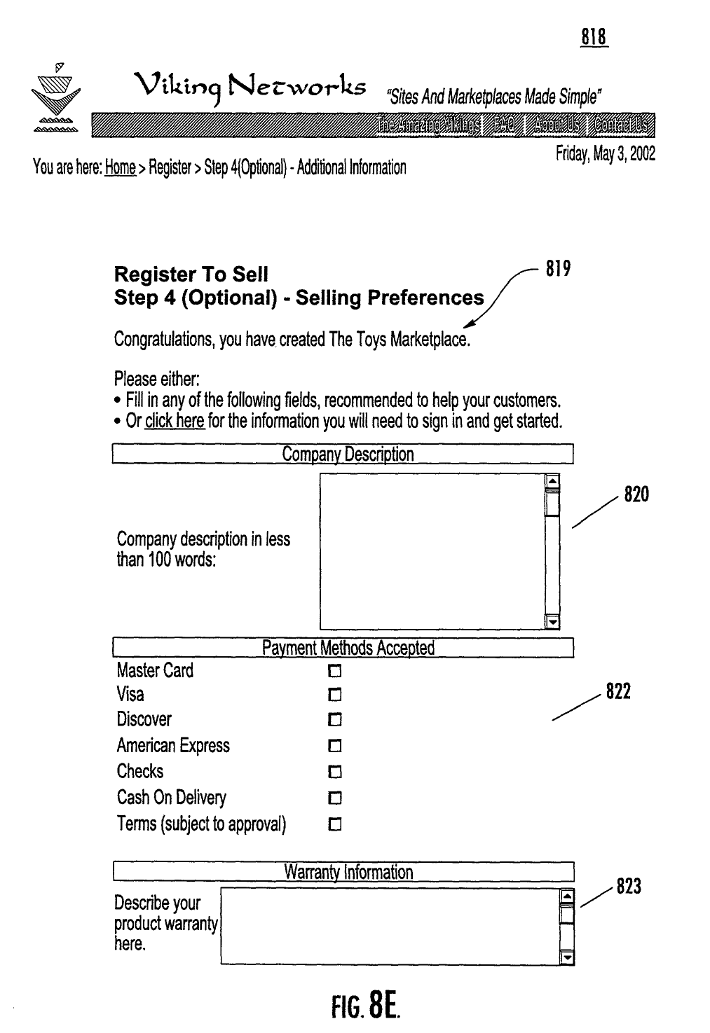

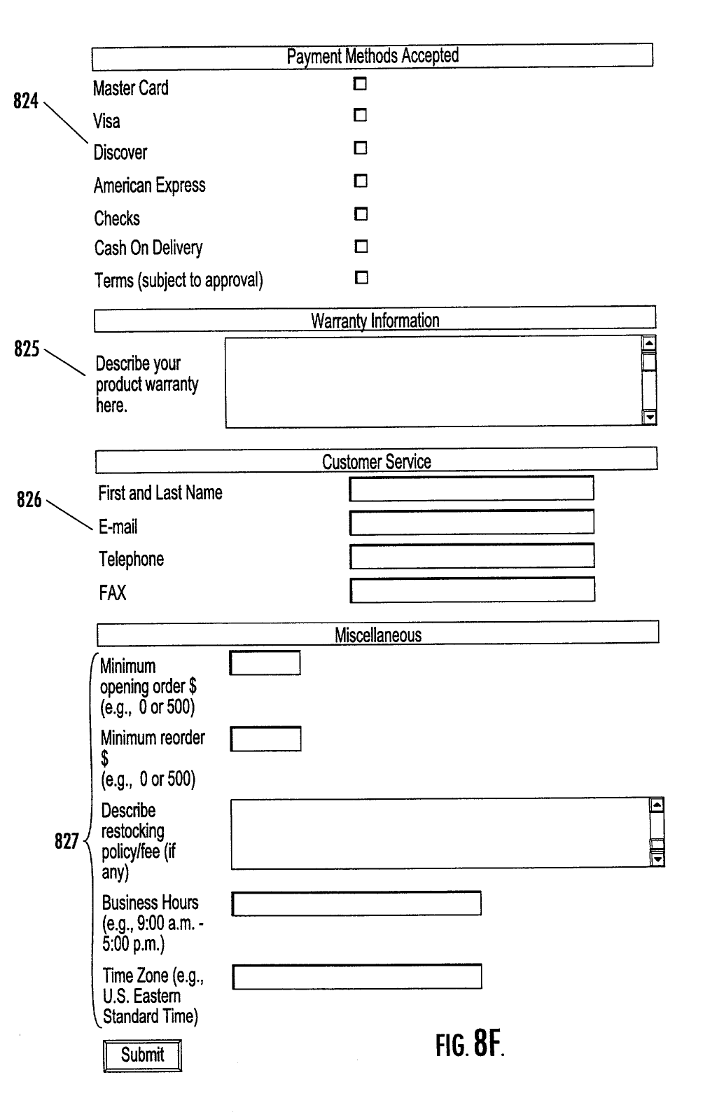

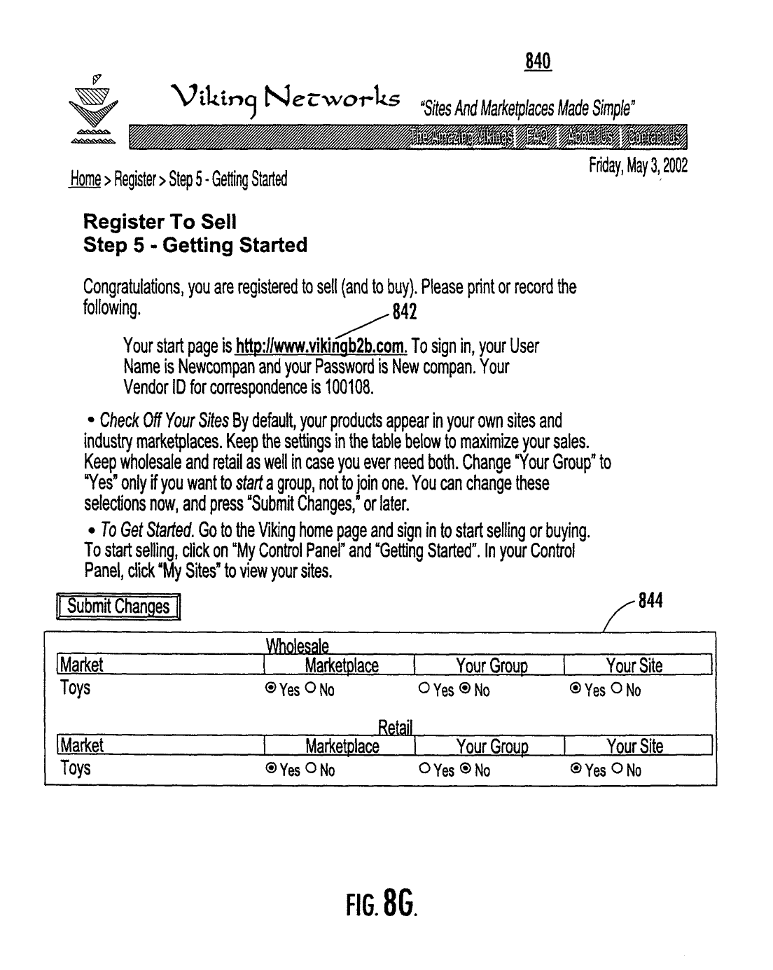

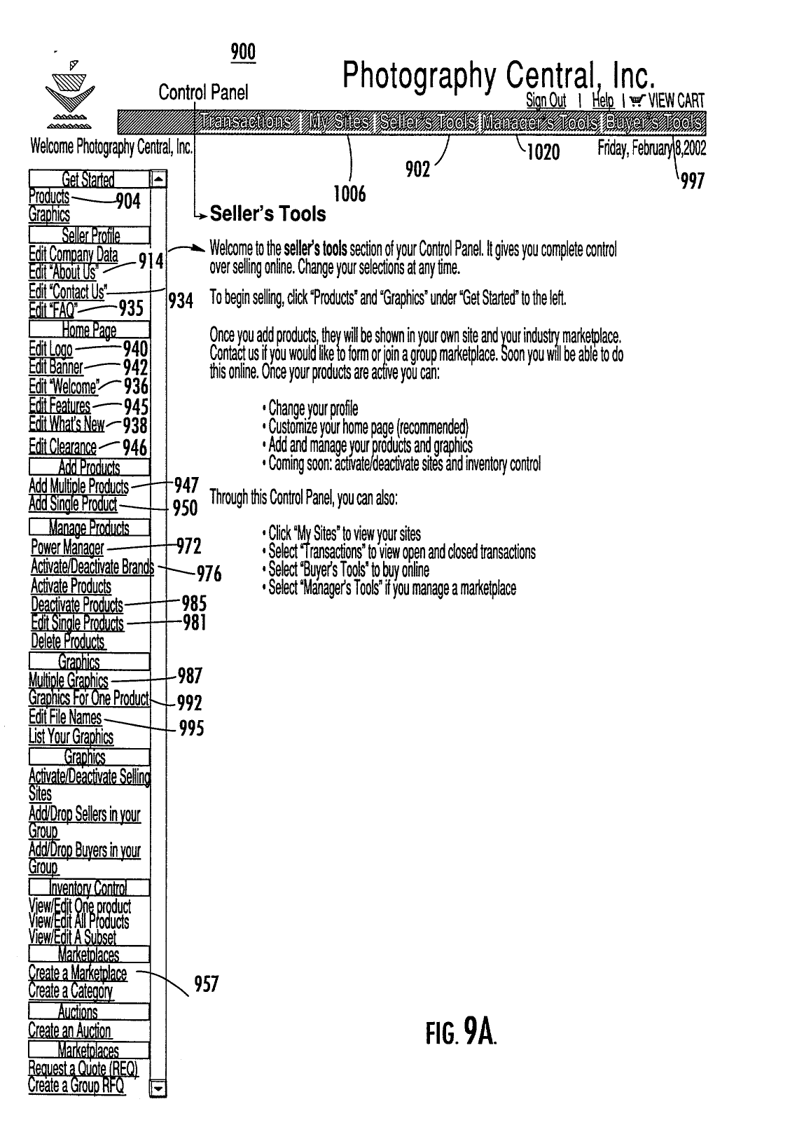

Web site screen 800, FIG. 8A is a view of the Viking™ start page for a seller registering to sell, or a buyer registering to buy at wholesale. Companies enter basic contact information in the text blocks in block 802, primary business contact in the text blocks in block 804, and a user name and password in the text blocks in block 806. If a buyer is in a marketplace (industry, region or group within it) or the Viking™ home page, the buyer can register to sell. The marketplace the buyer has selected is indicated by banner 808, FIG. 8B on Web site screen 809. Users registering to sell must review and accept the terms with the software provider to complete the registration, as indicated by screen 810, FIG. 8C. If a user accepts the terms, the user clicks on “I Agree” button 812. Sellers can choose an existing industry or region, as indicated by the links shown in box 814, FIG. 8D, or create a new marketplace. If a user desires to create a new marketplace, various actions ensure automatically that a new site ID is generated, and a new products table for this marketplace is created. A new directory for the graphics is created and a new marketplace will appear in the links shown in box 804 and a new marketplace ready to view stating a new community will automatically exist. For example if the user has created a new marketplace, such as the “Toys” marketplace, as shown by in textbox 815, a new marketplaces for “Toys” is automatically created, as shown by Web site screen 818, FIG. 8E at arrow 819. Optional additional data regarding selling preferences can be entered in textbox 820, by clicking on any of the checkboxes in block 822, or by entering text in textbox 823. Even more information about selling preferences may be added by clicking on any of the checkboxes in block 824, FIG. 8F, or entering text in any of the textboxes in blocks 825, 826 or 827. Web site screen 840, FIG. 8G is a view showing that the registration process has been successfully completed and the user is now registered to sell and/or buy. Link 842 provides a link to the start page created for the new registered company. A user can check off the Web sites and marketplaces they desire to be a member of by clicking a combination of the radio buttons in block 844.

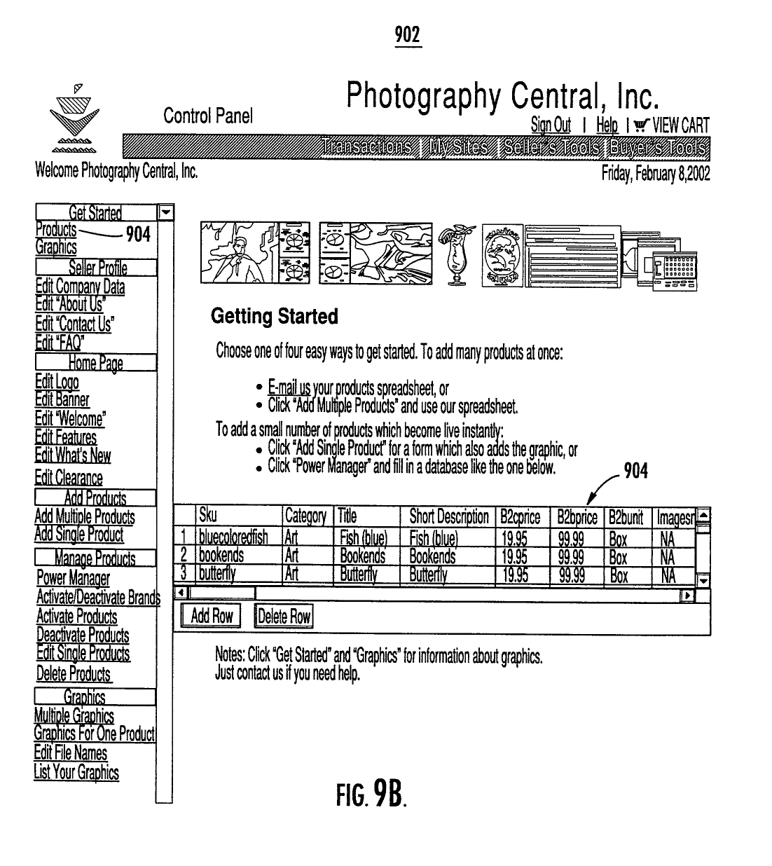

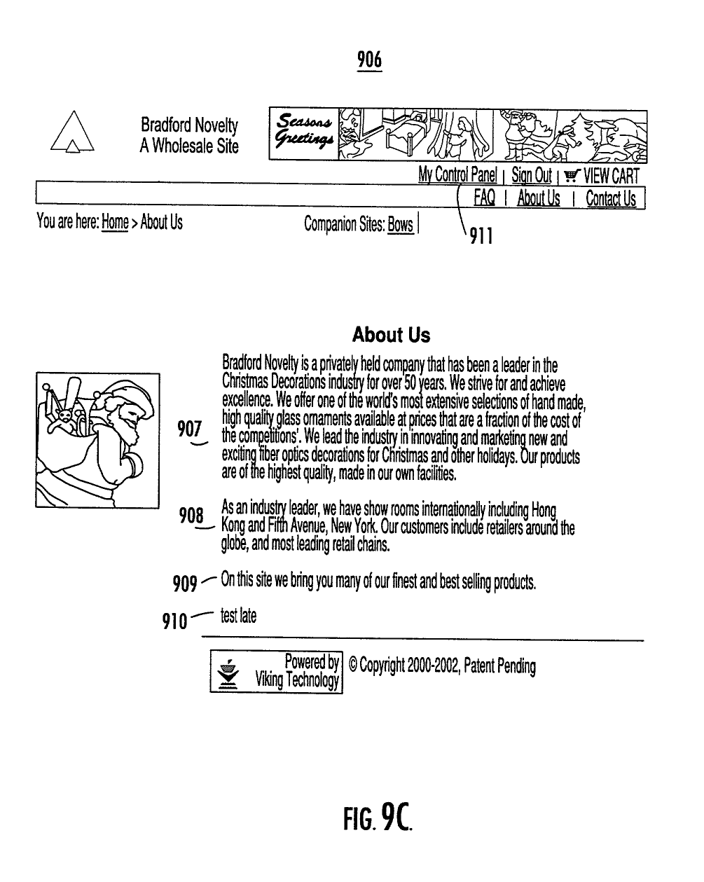

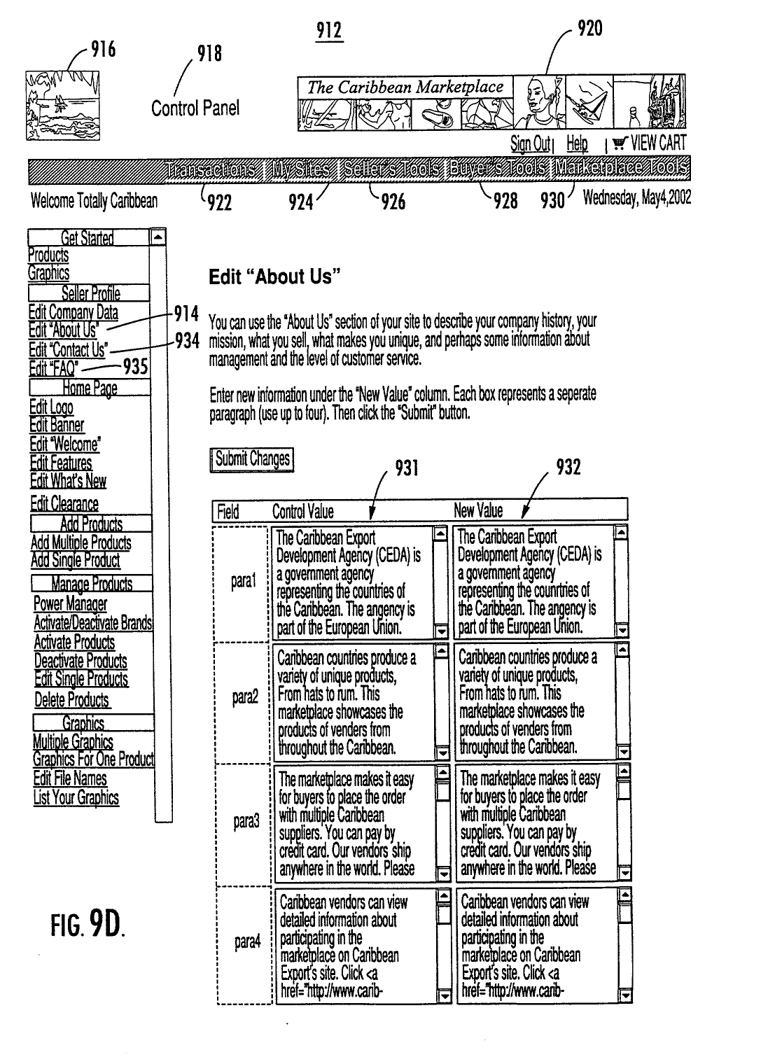

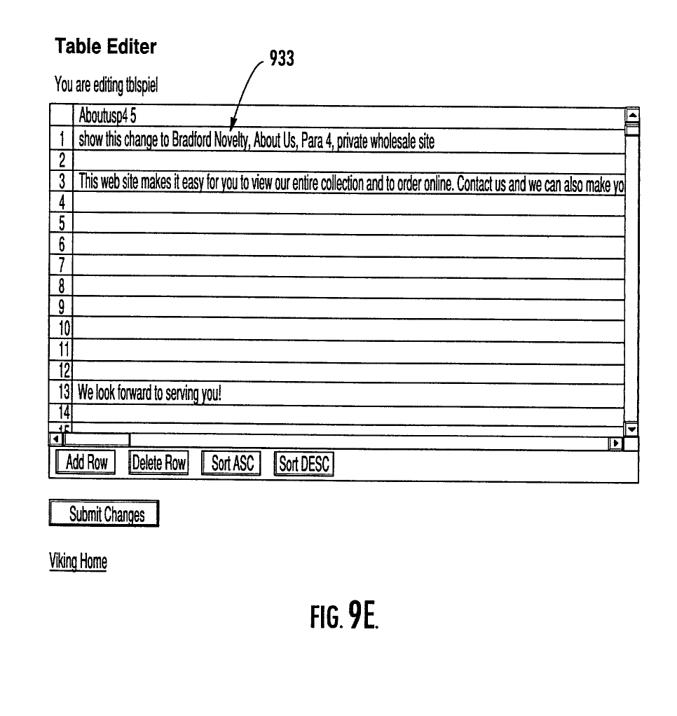

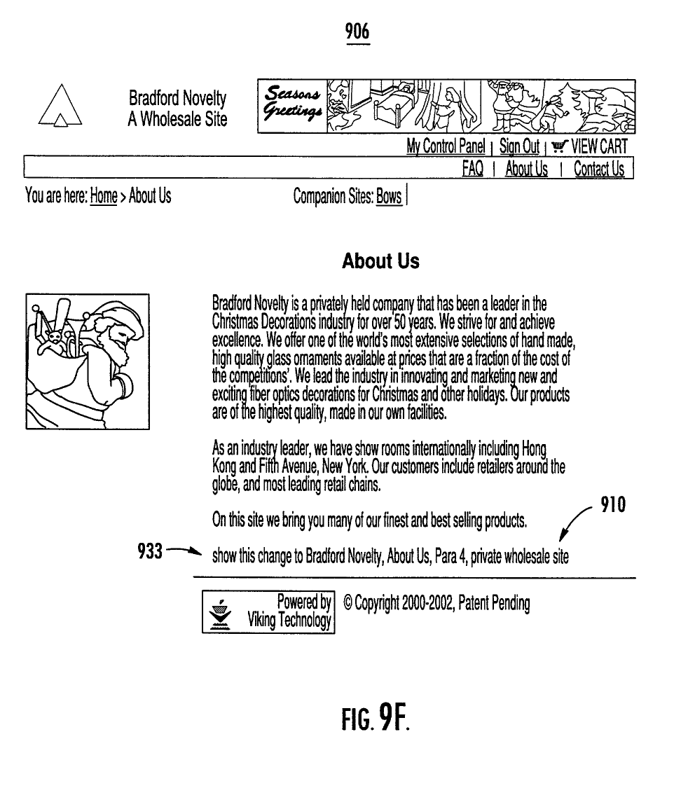

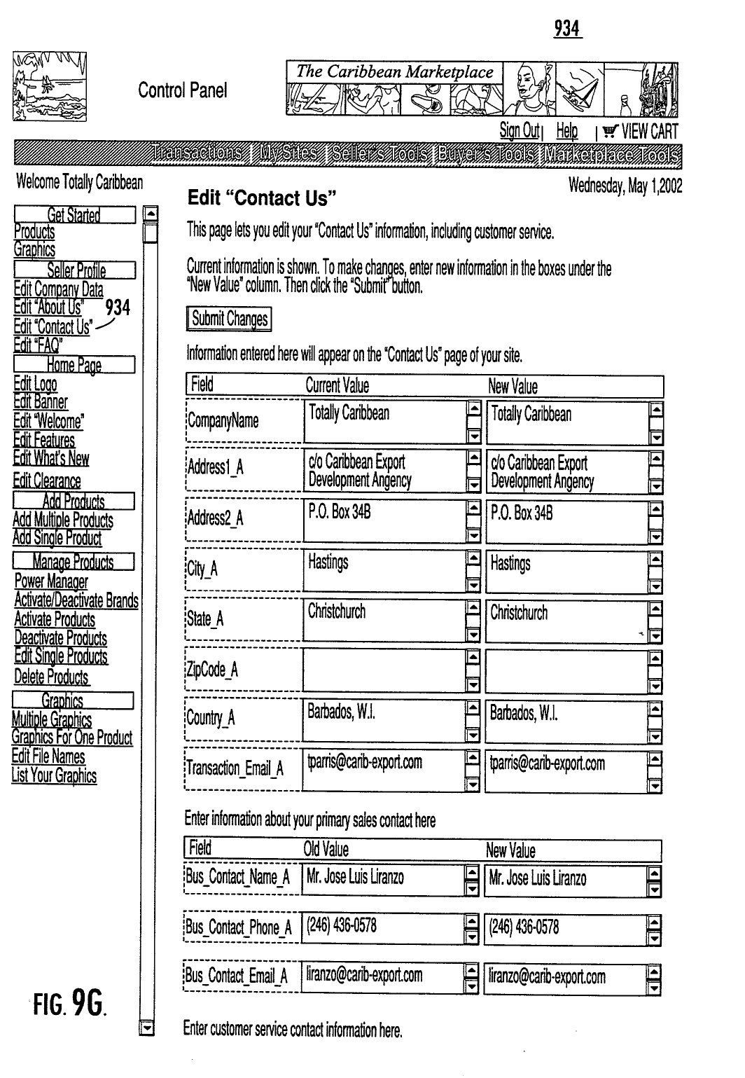

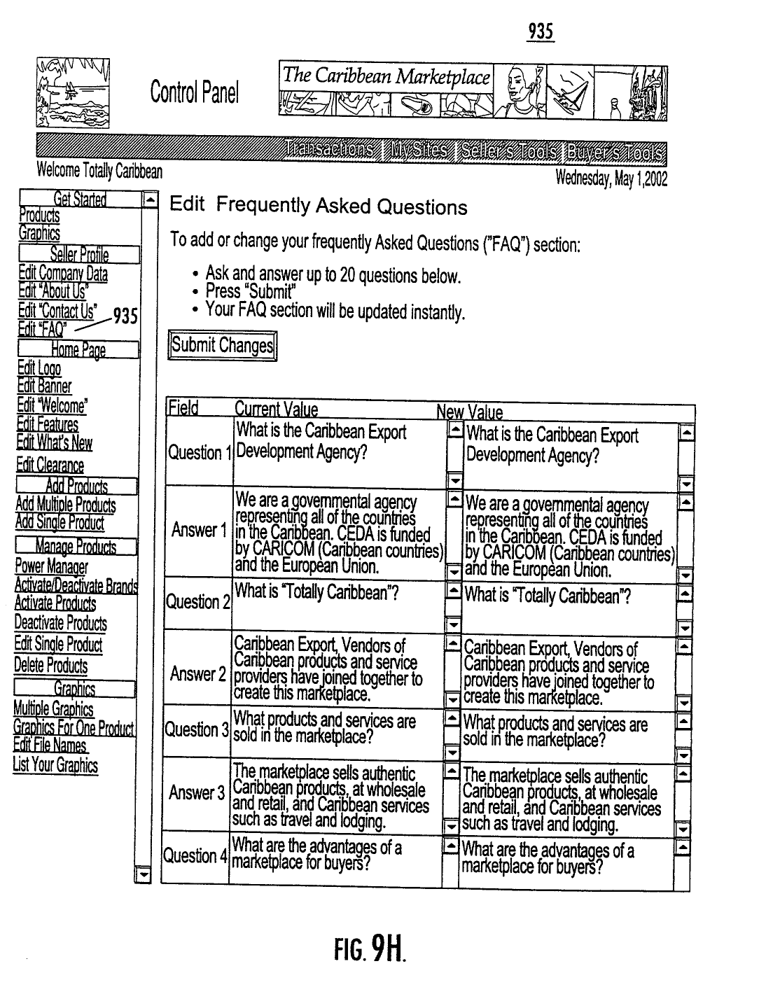

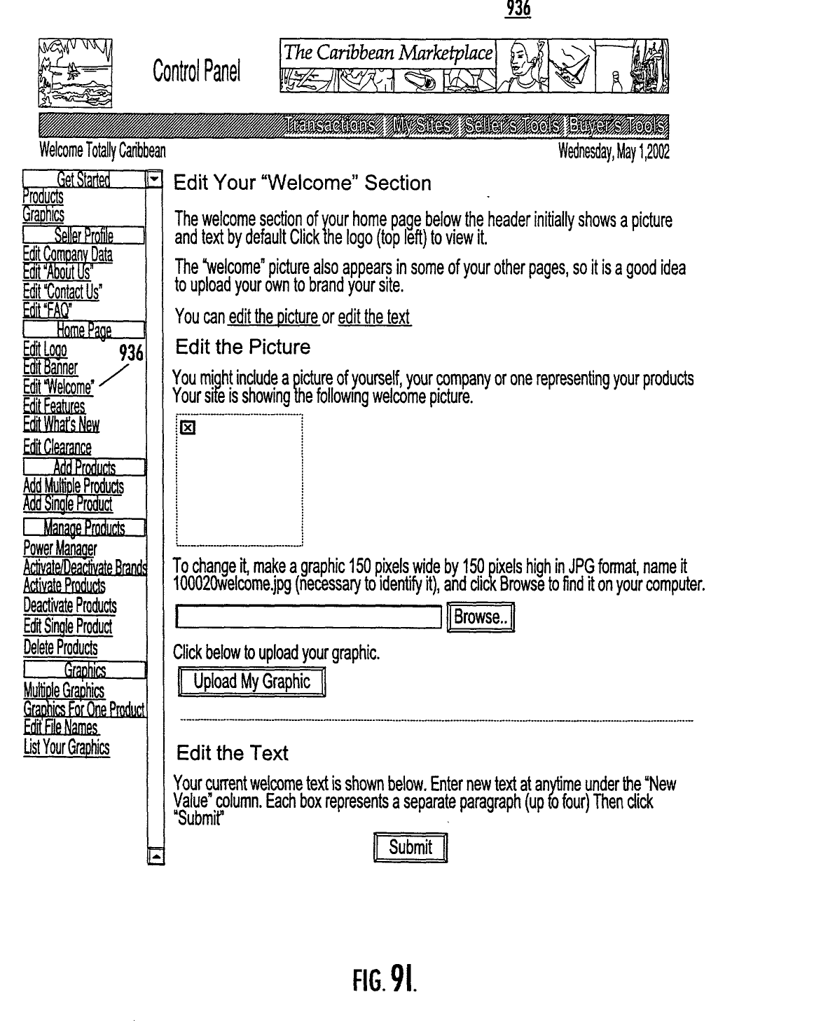

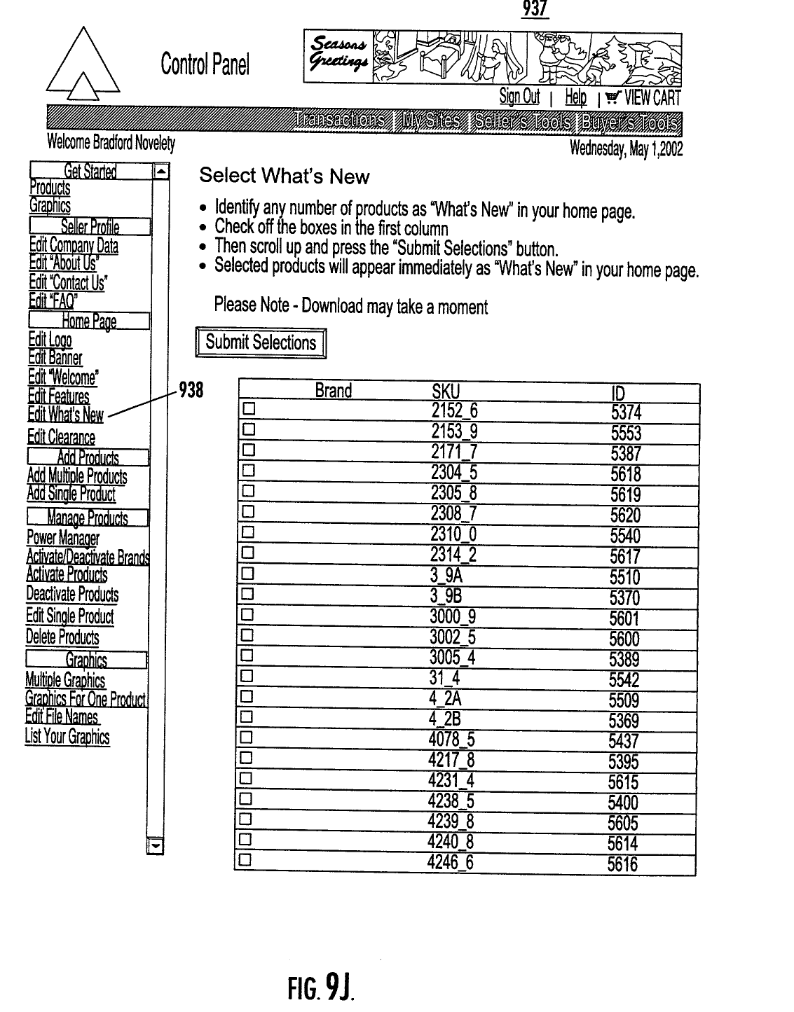

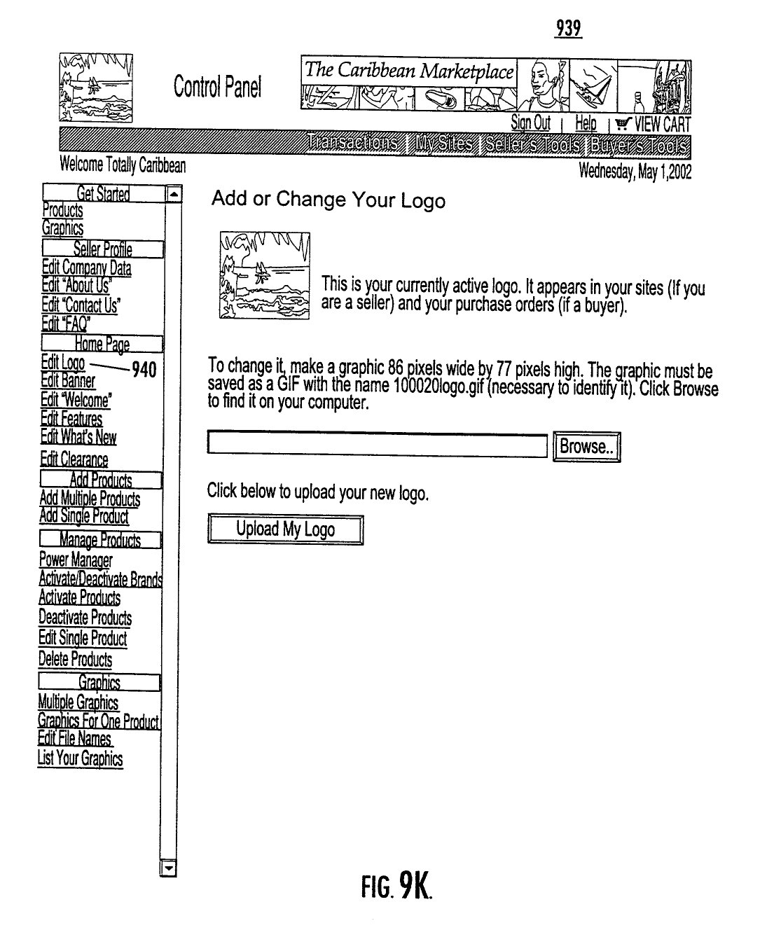

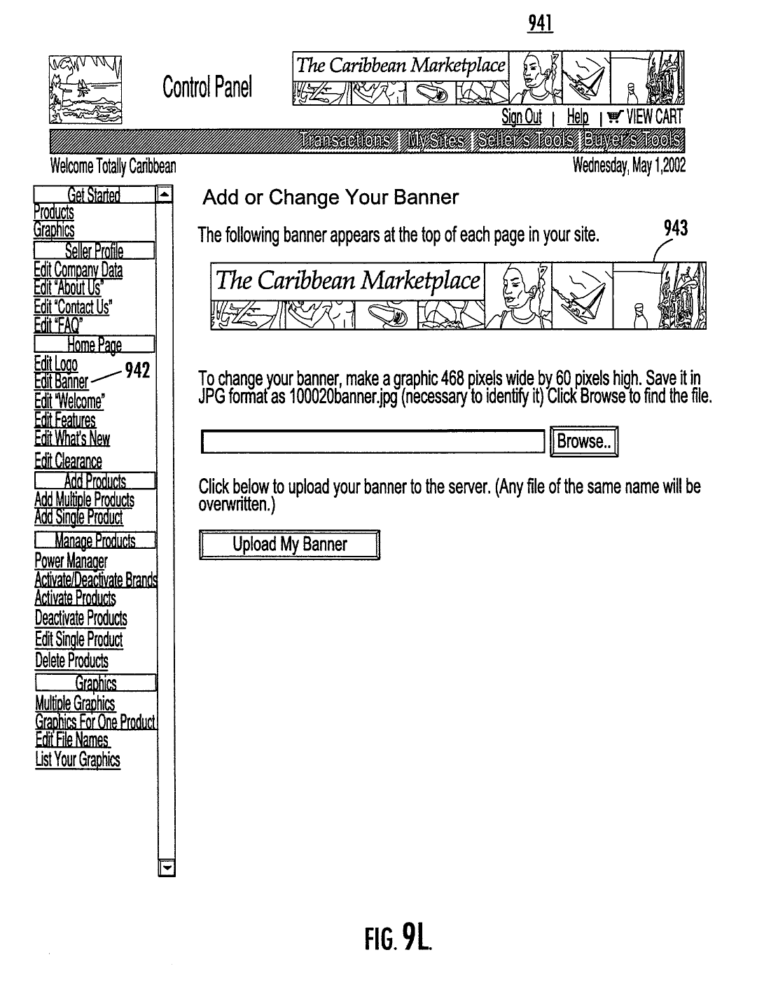

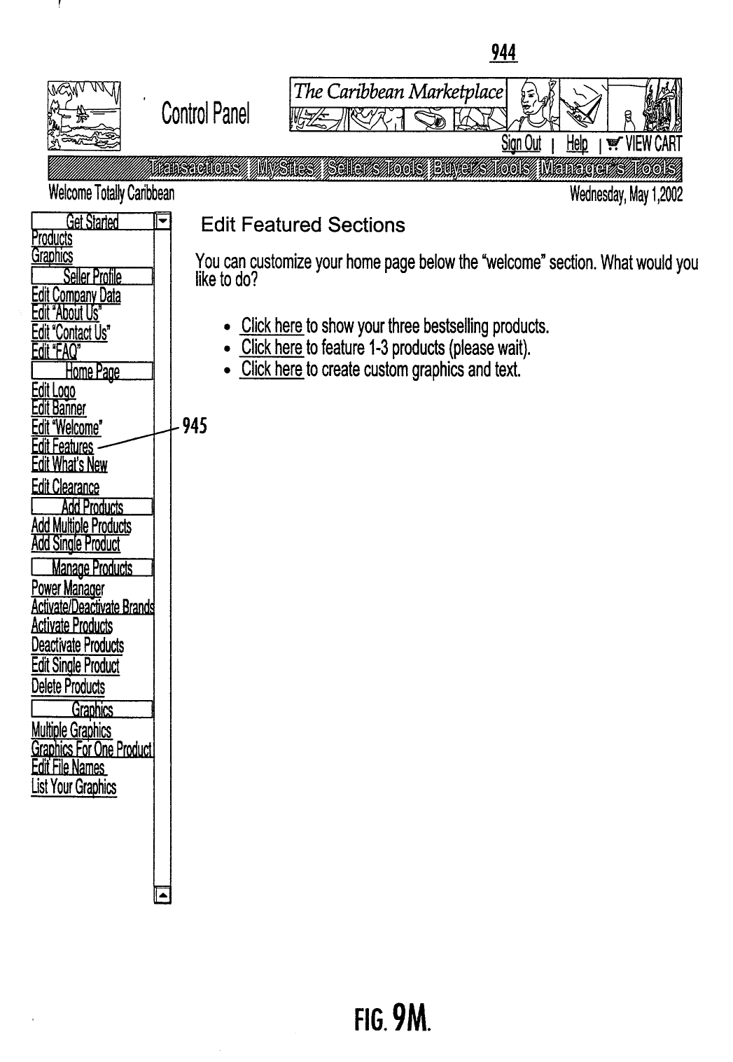

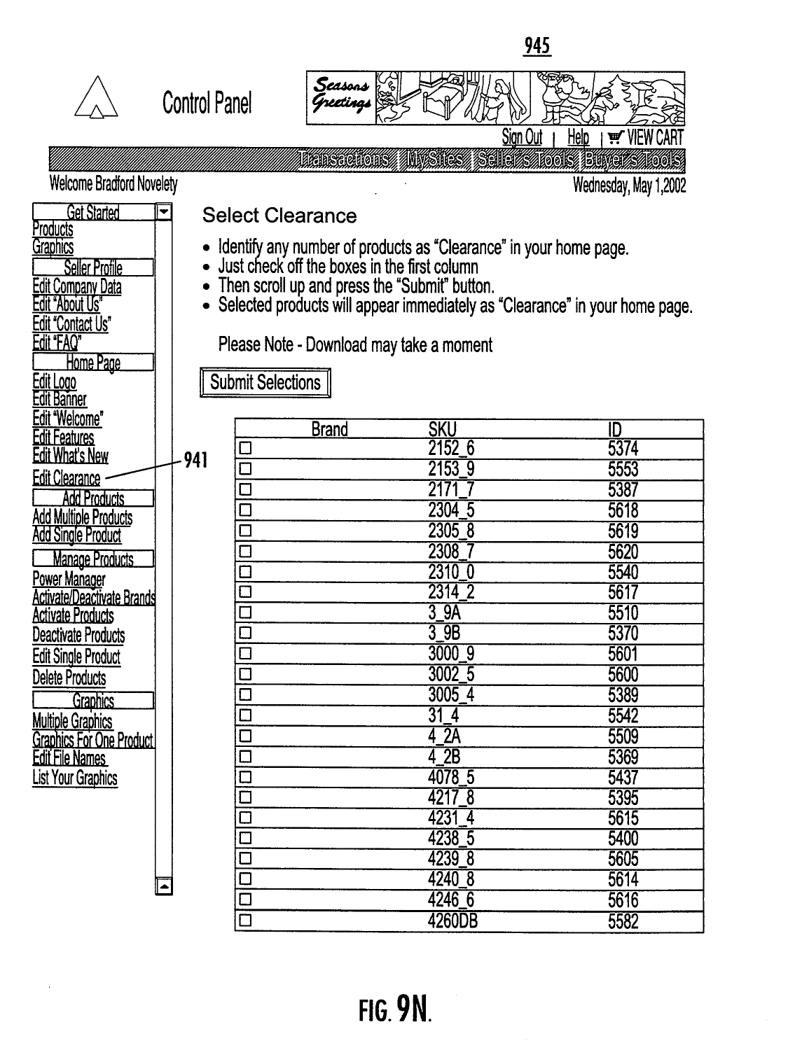

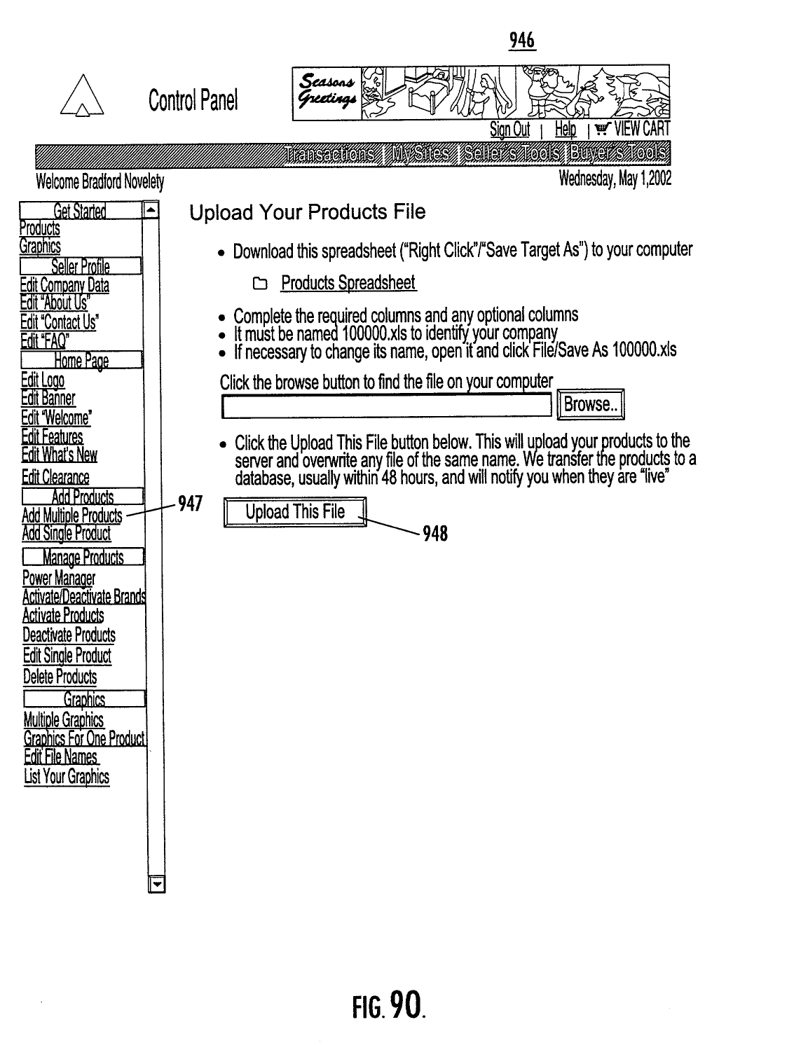

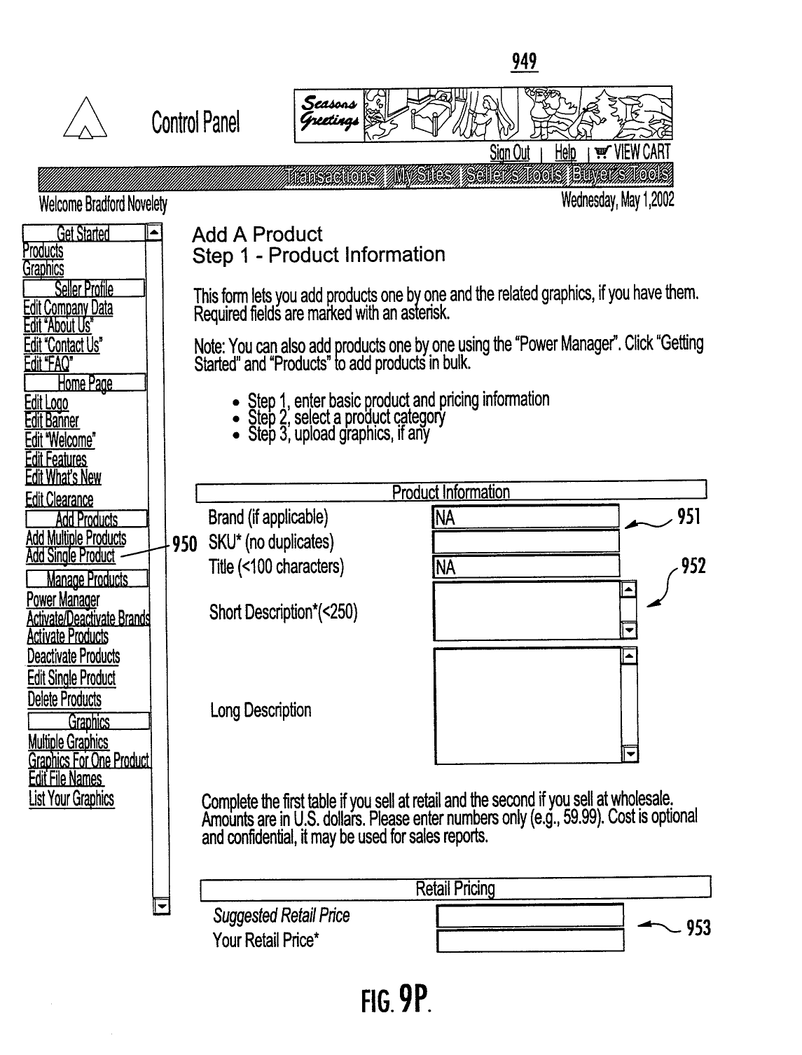

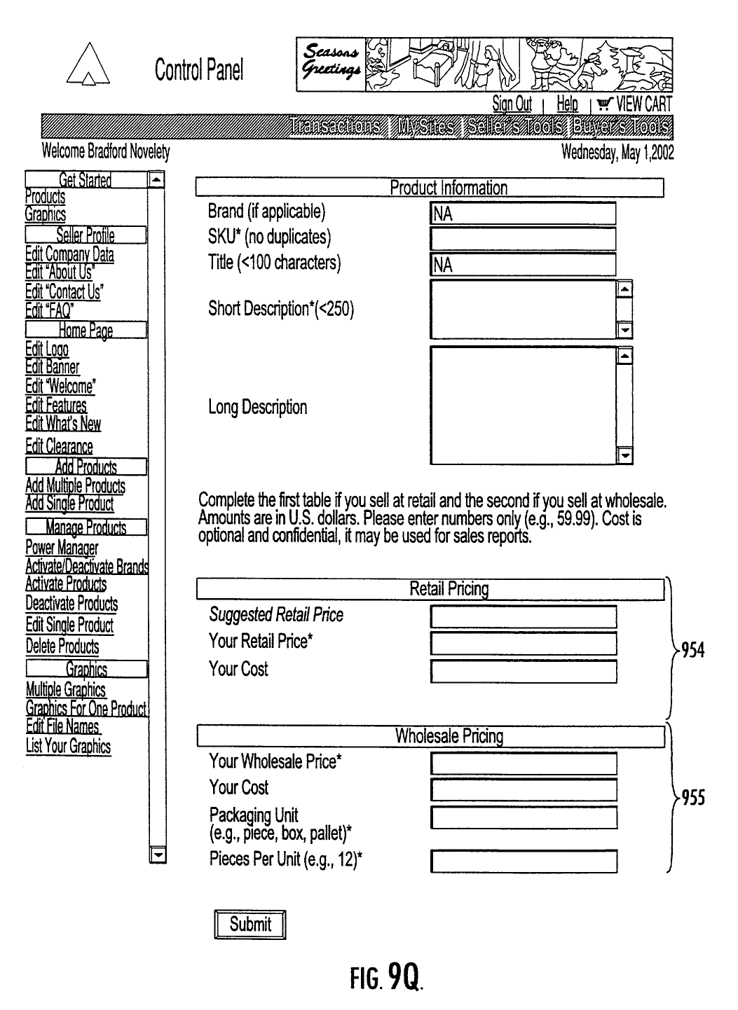

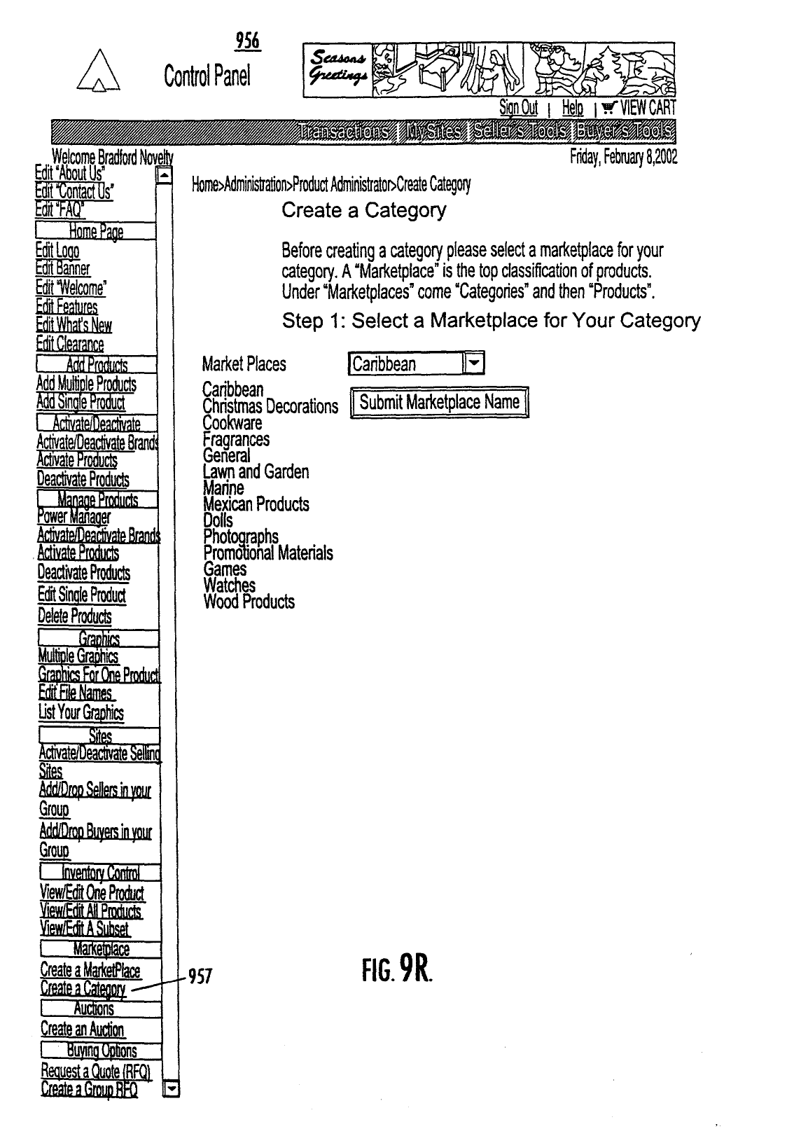

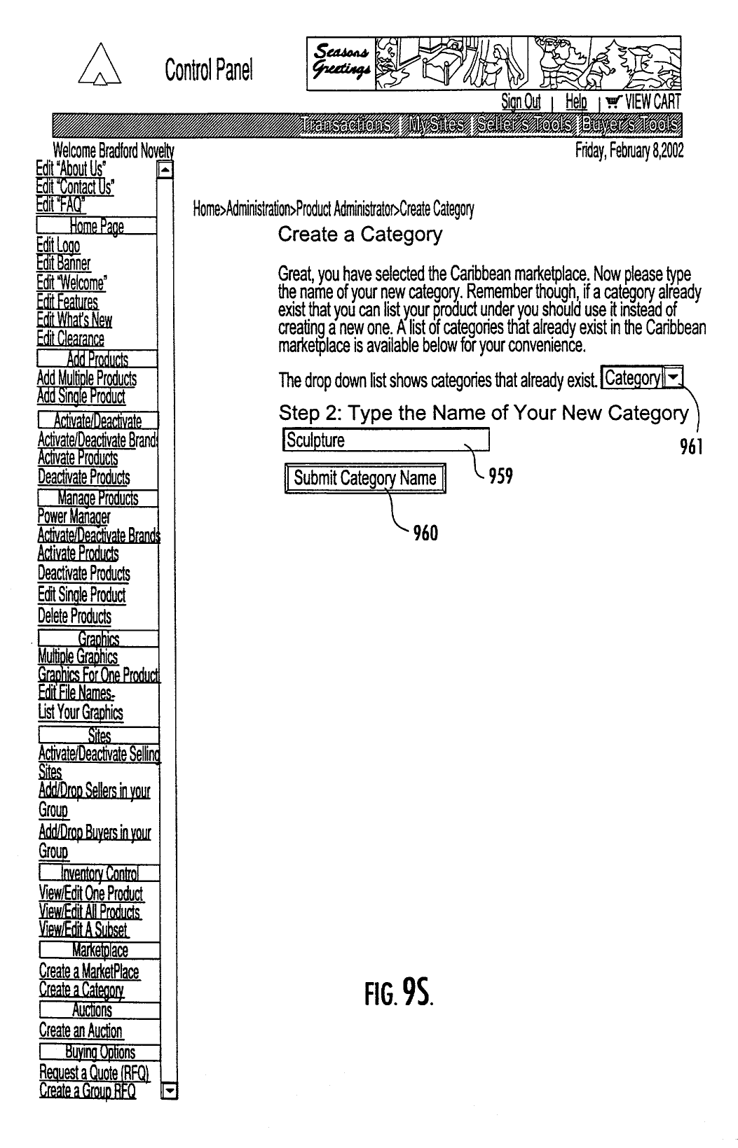

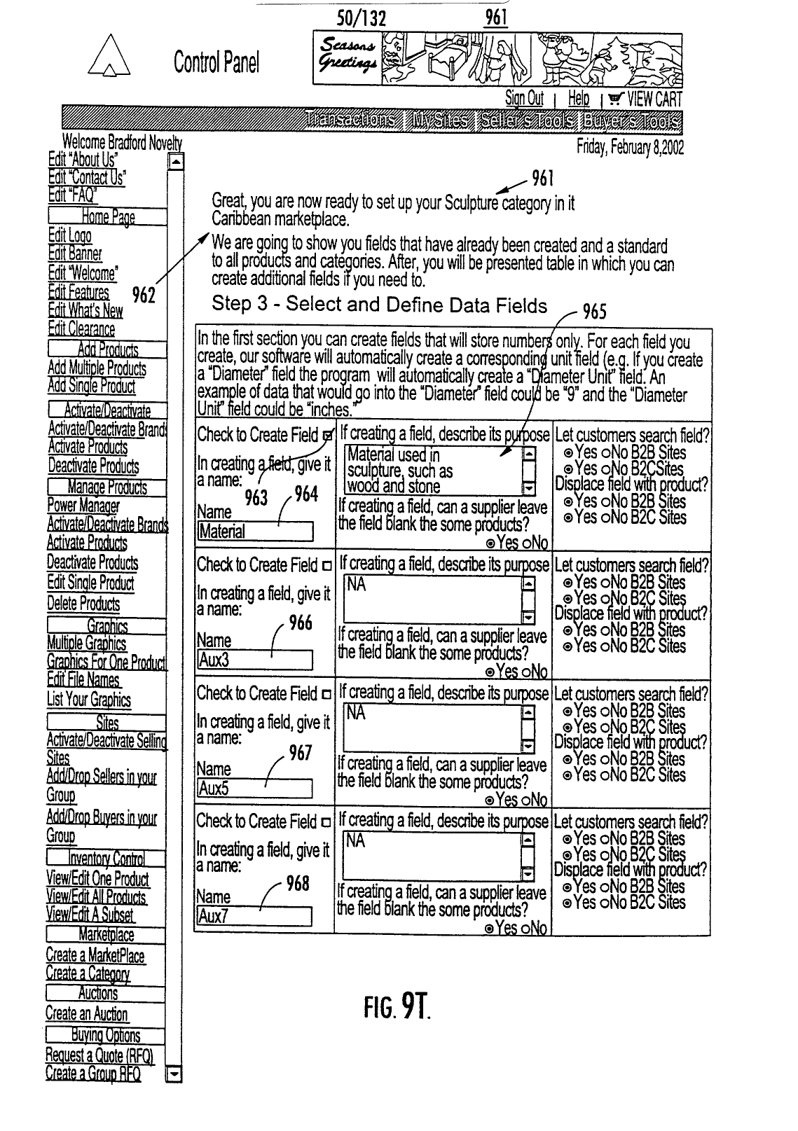

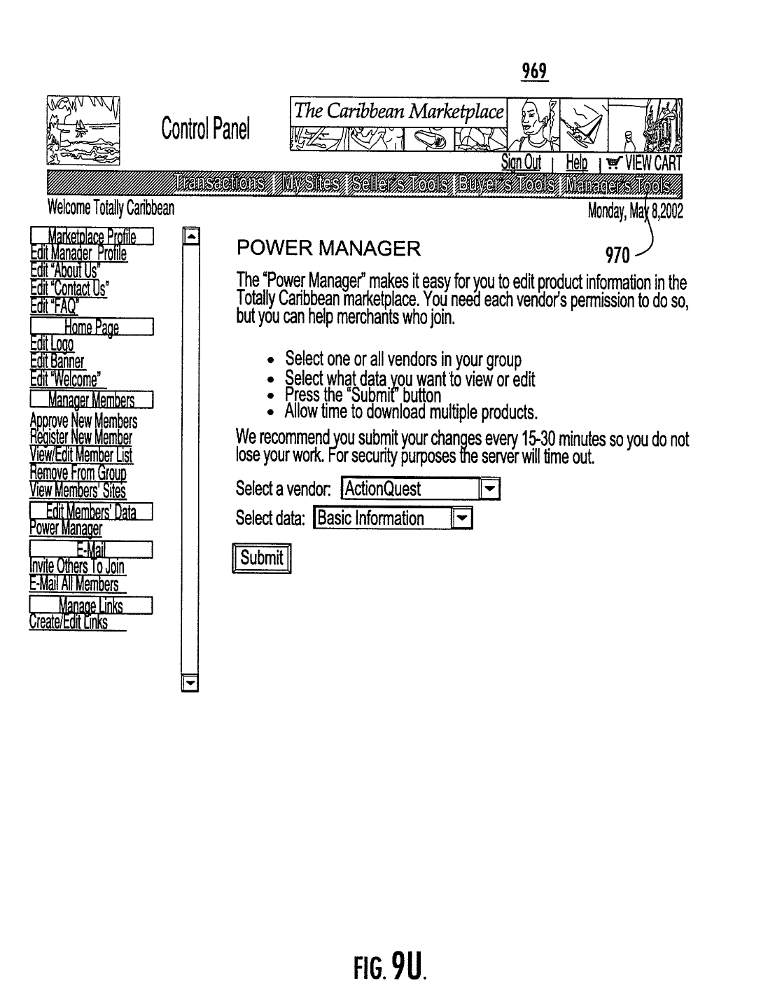

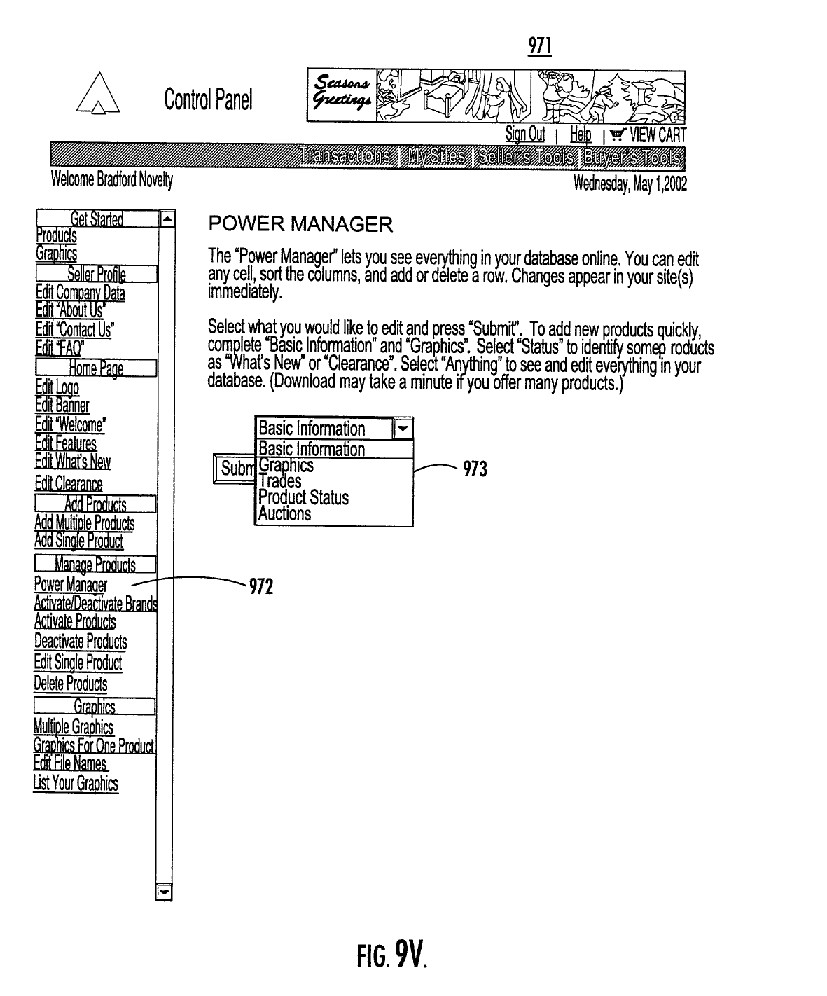

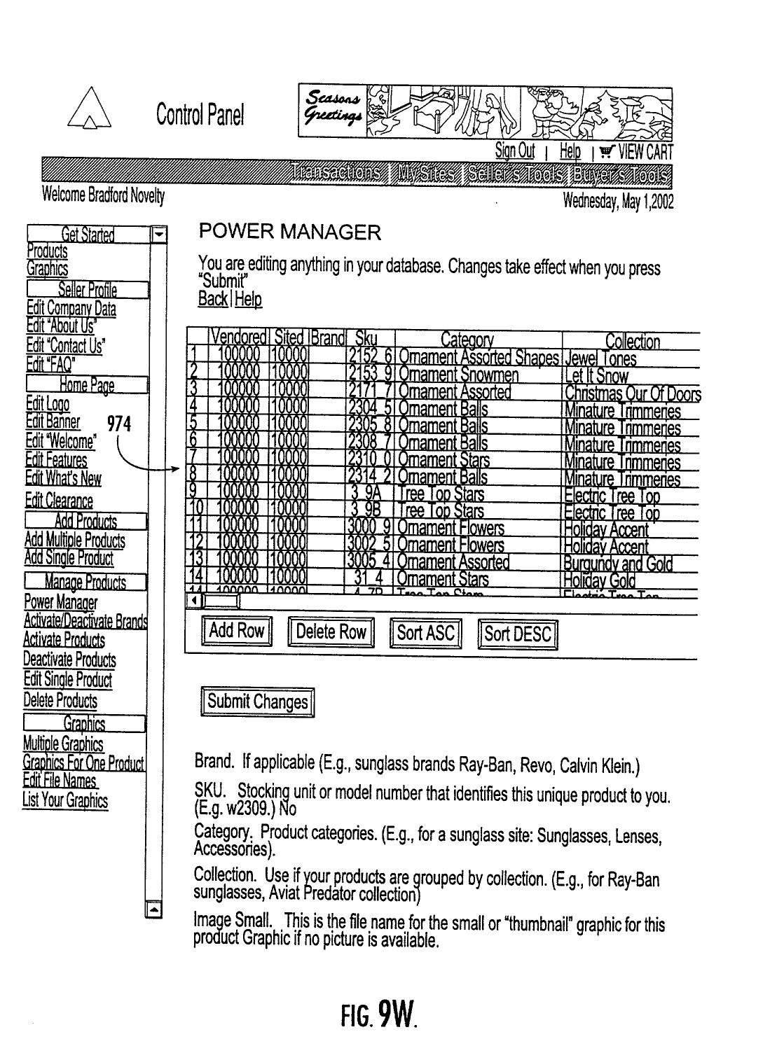

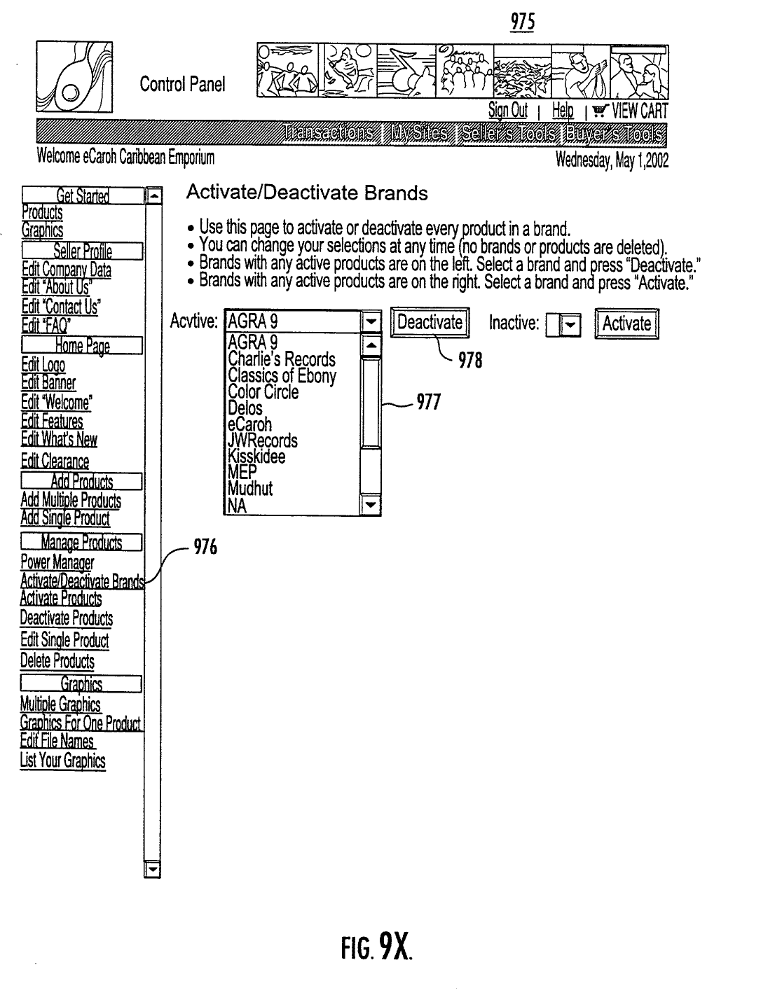

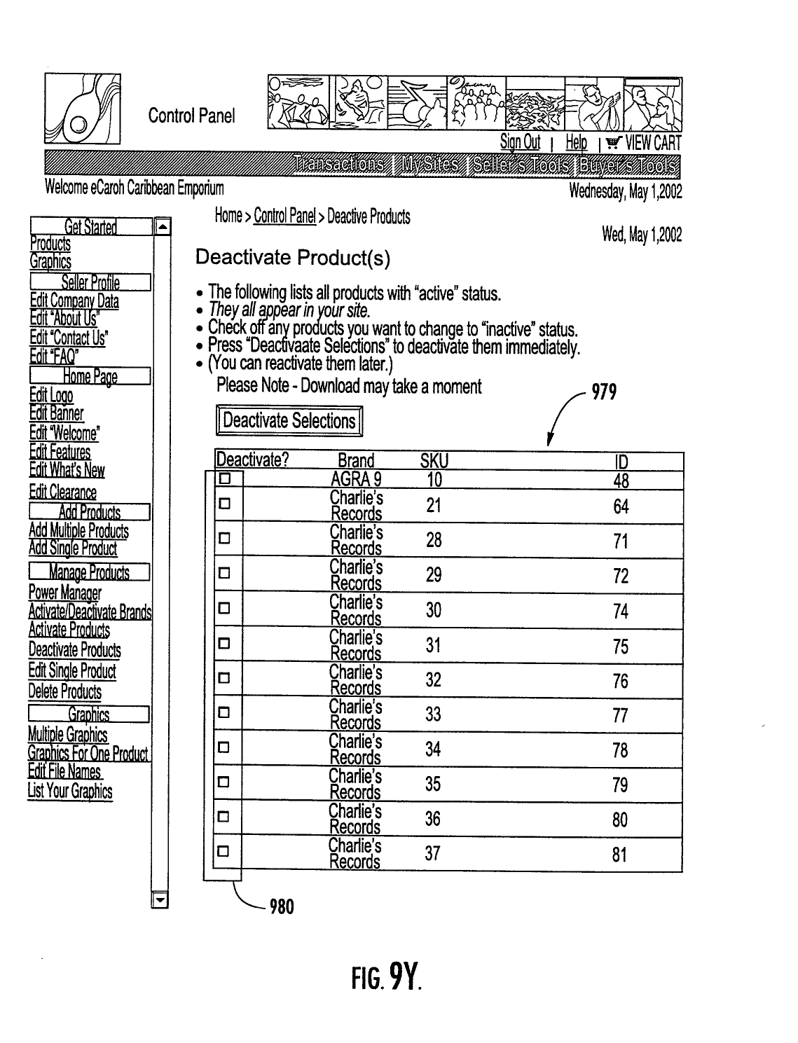

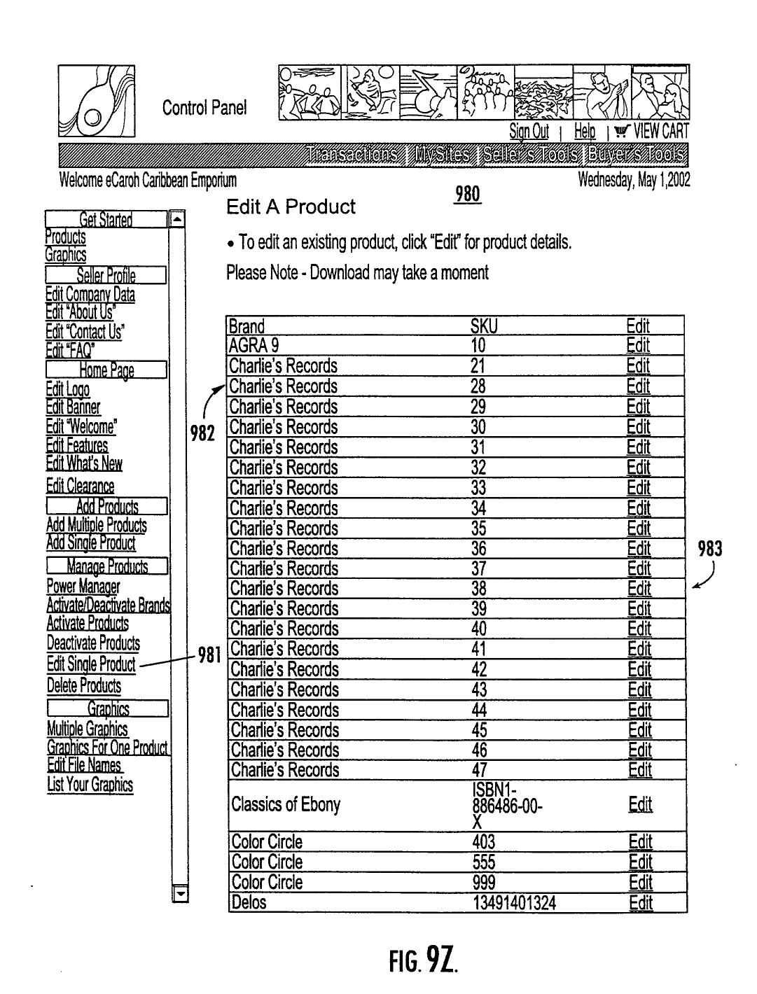

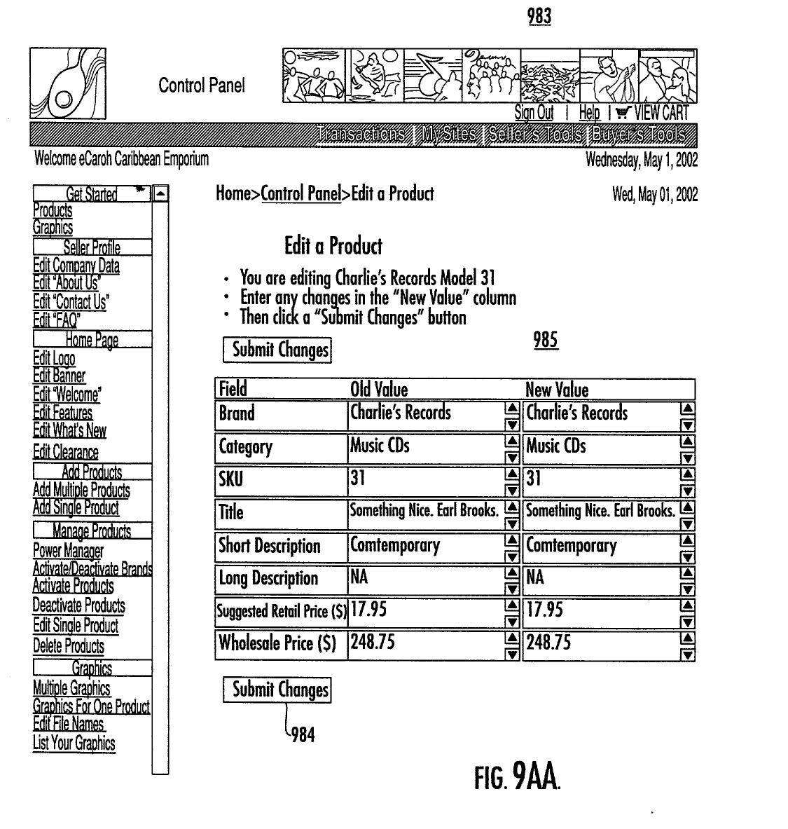

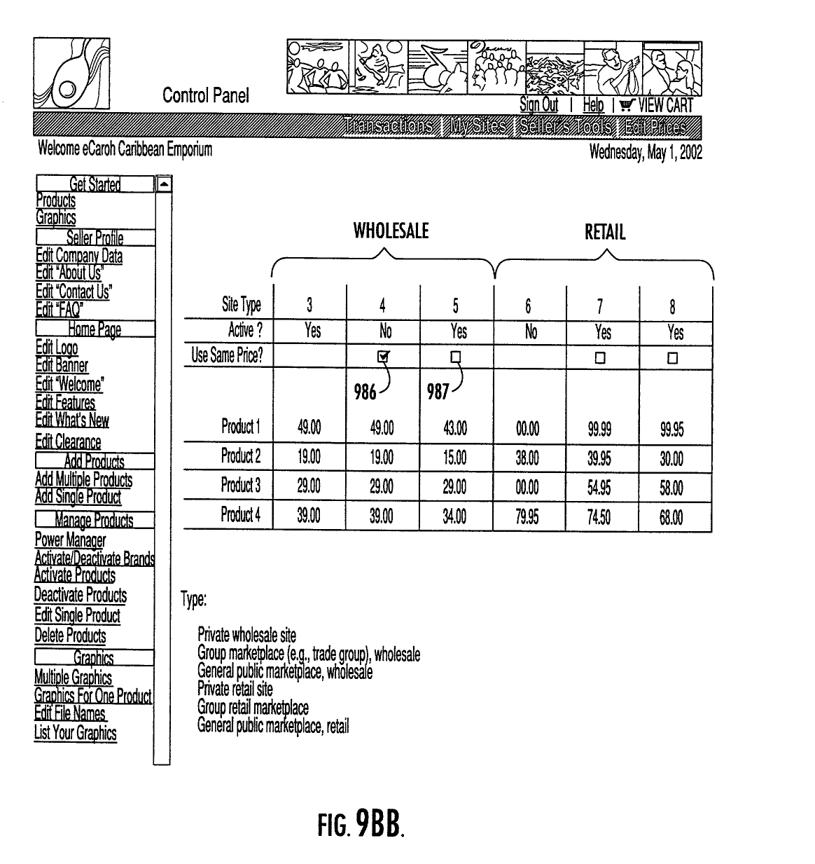

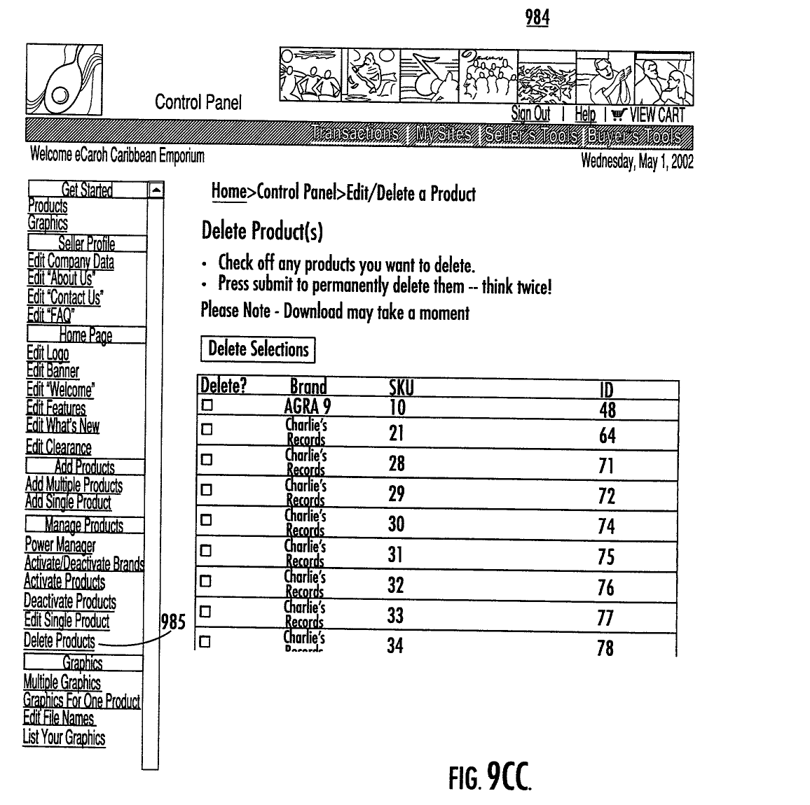

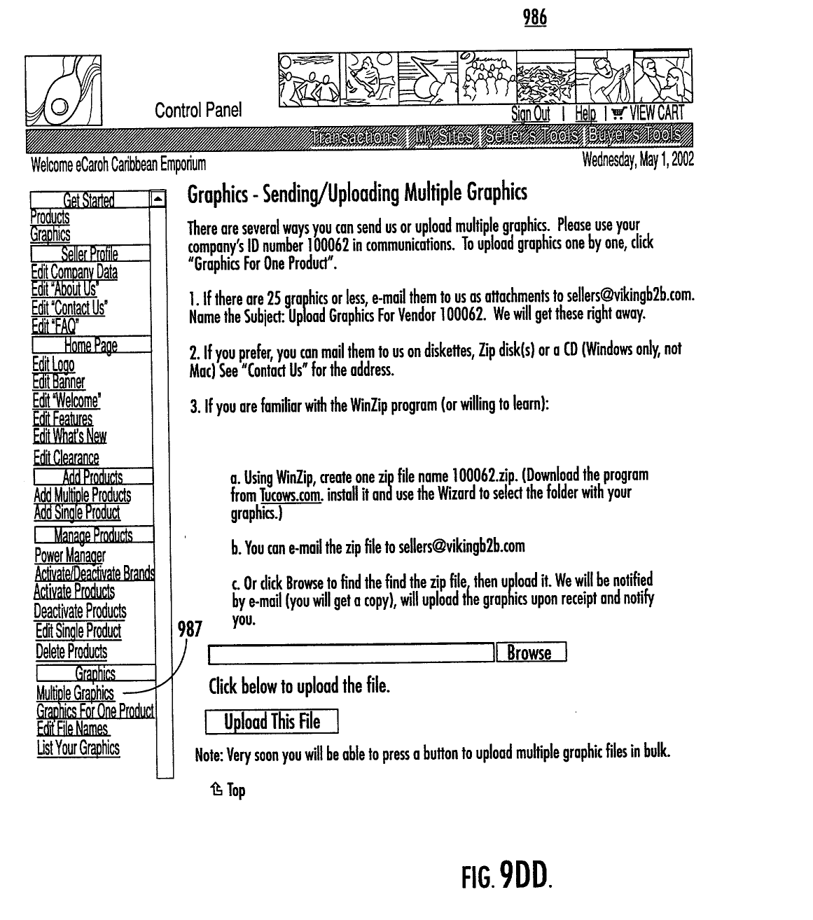

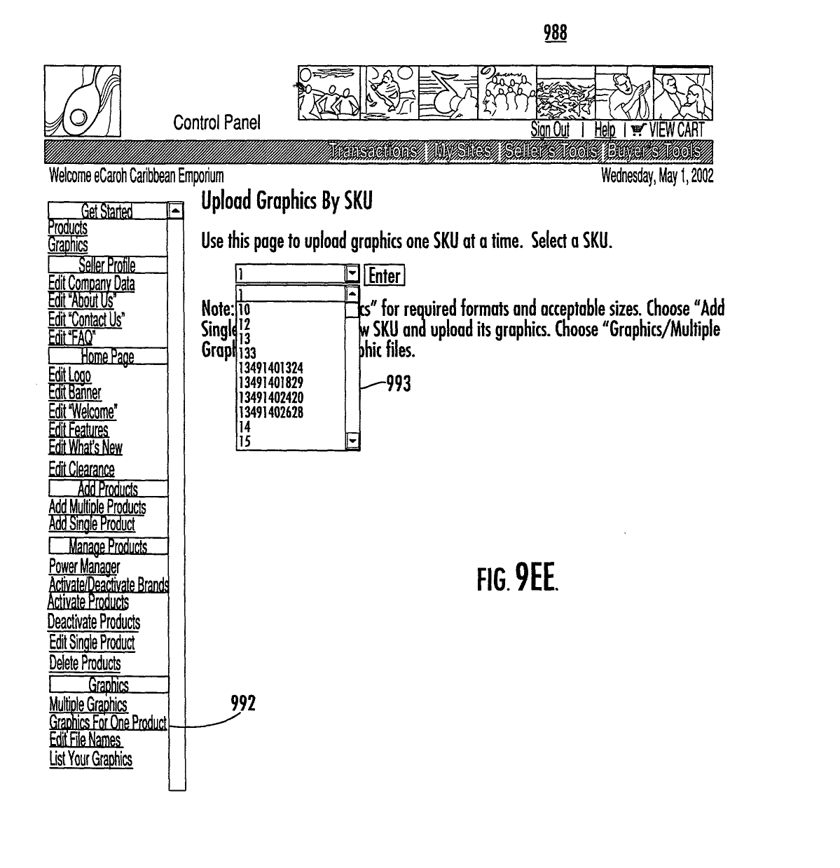

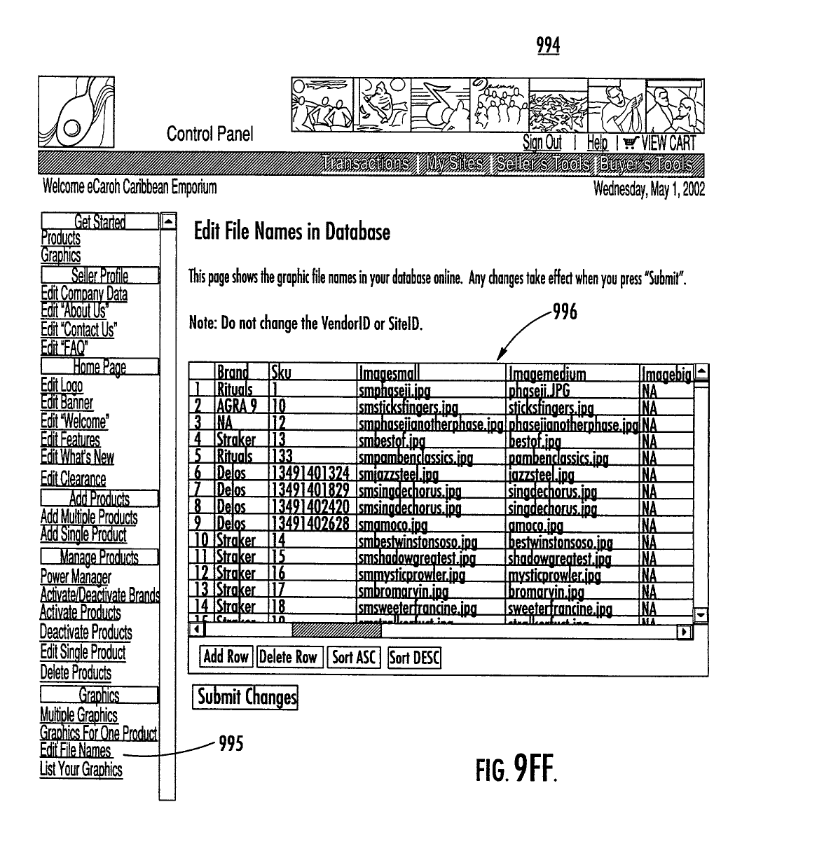

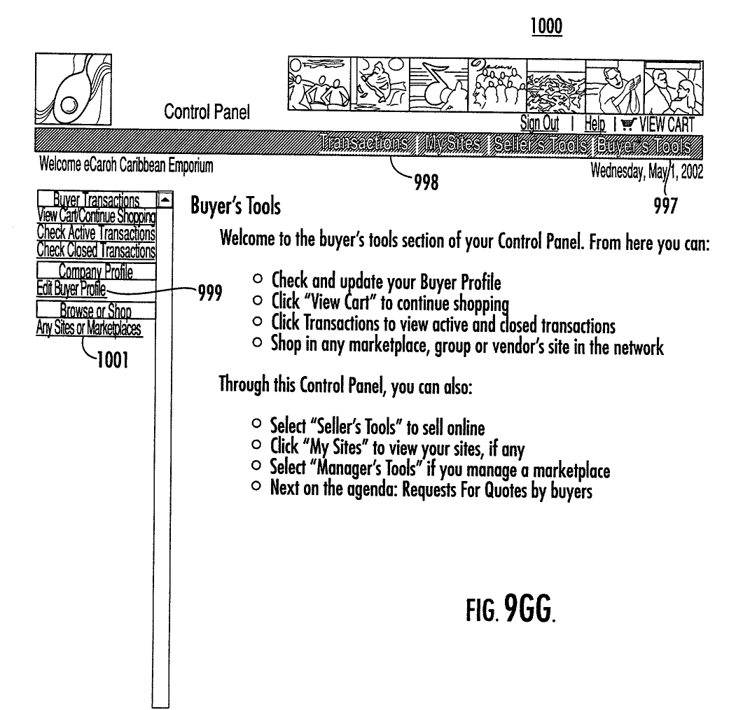

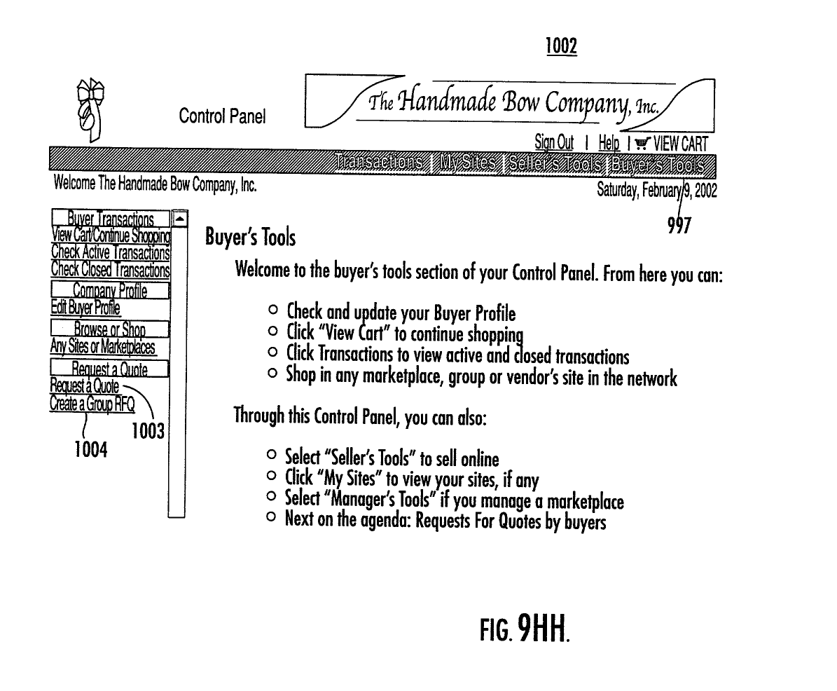

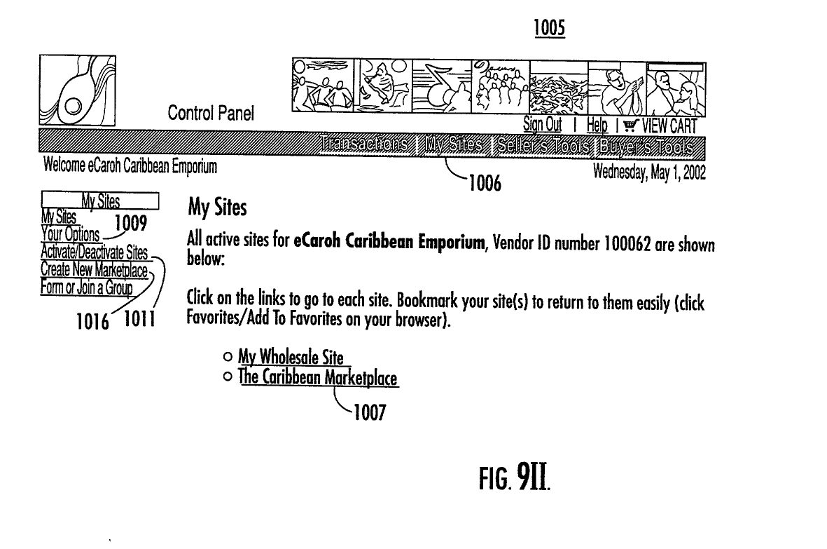

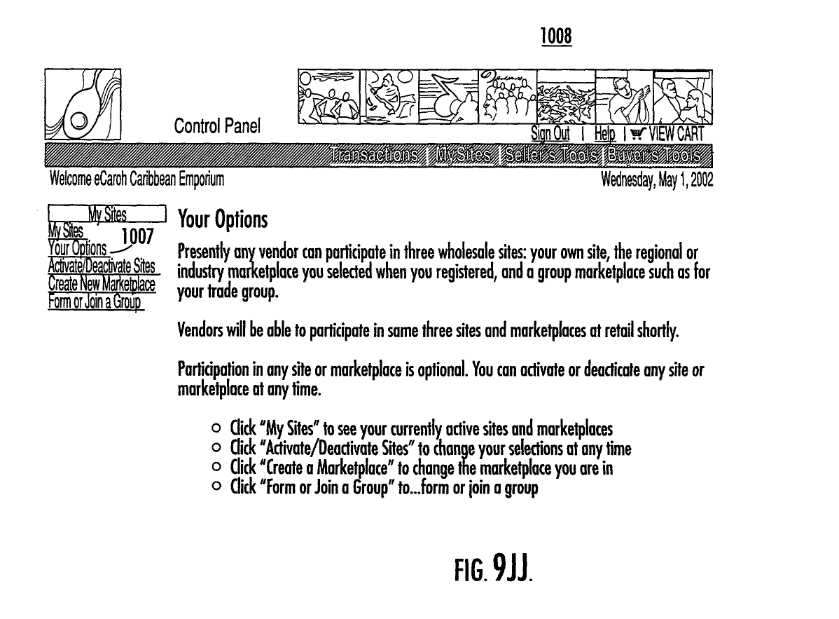

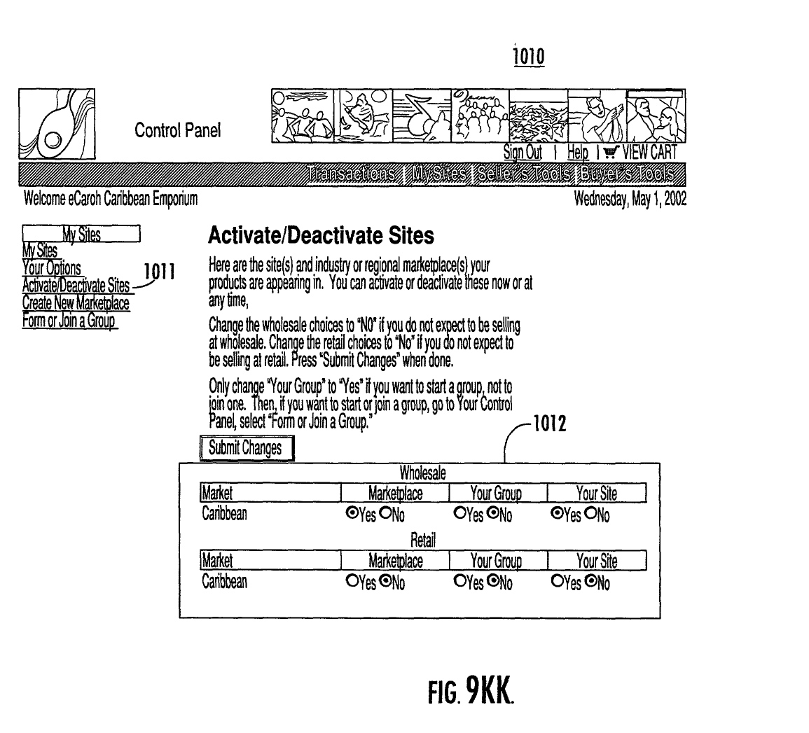

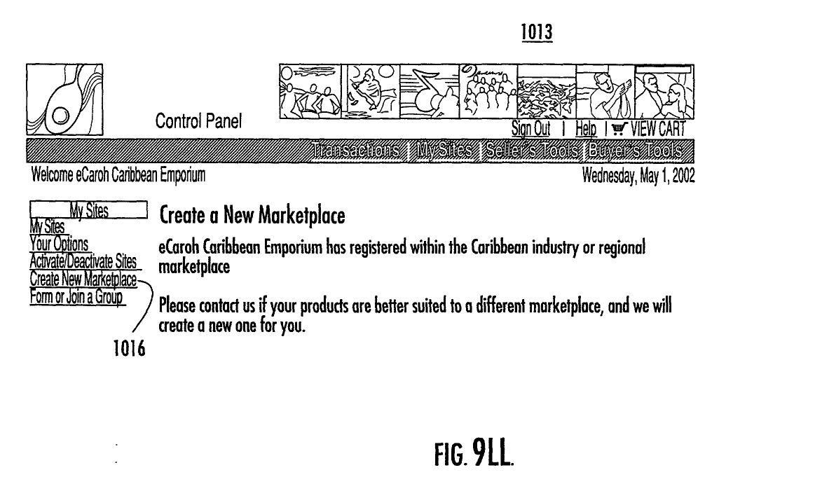

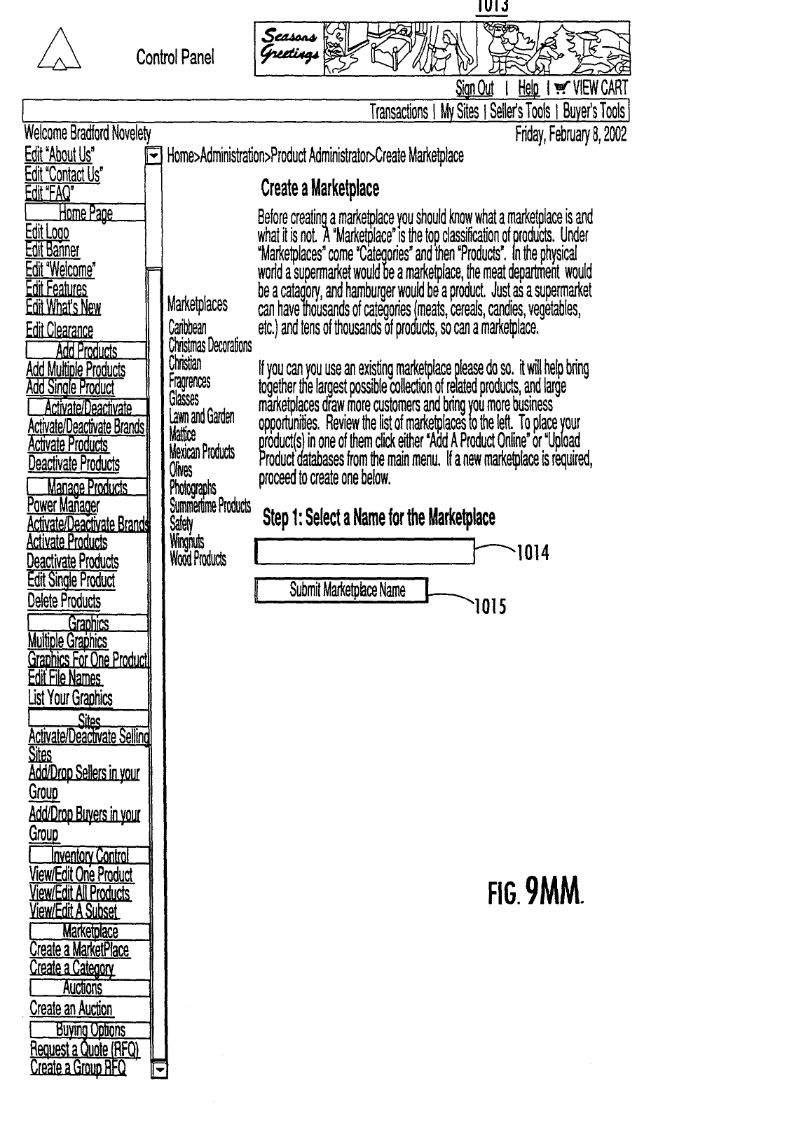

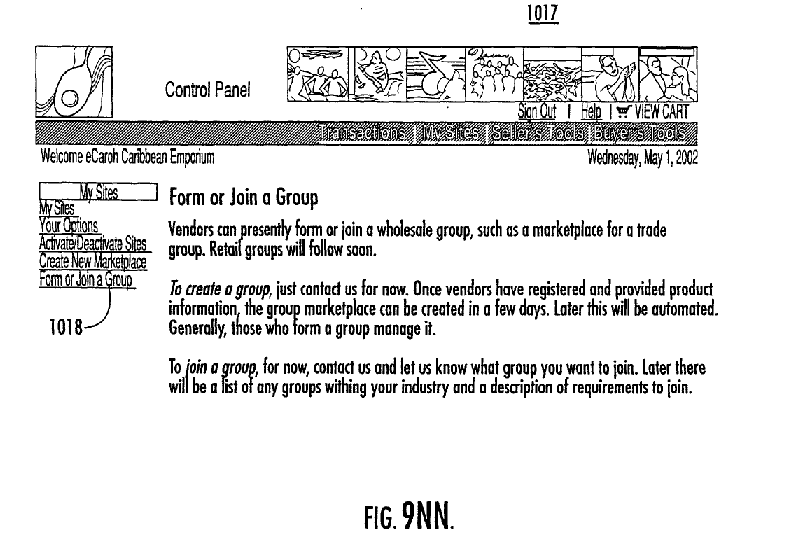

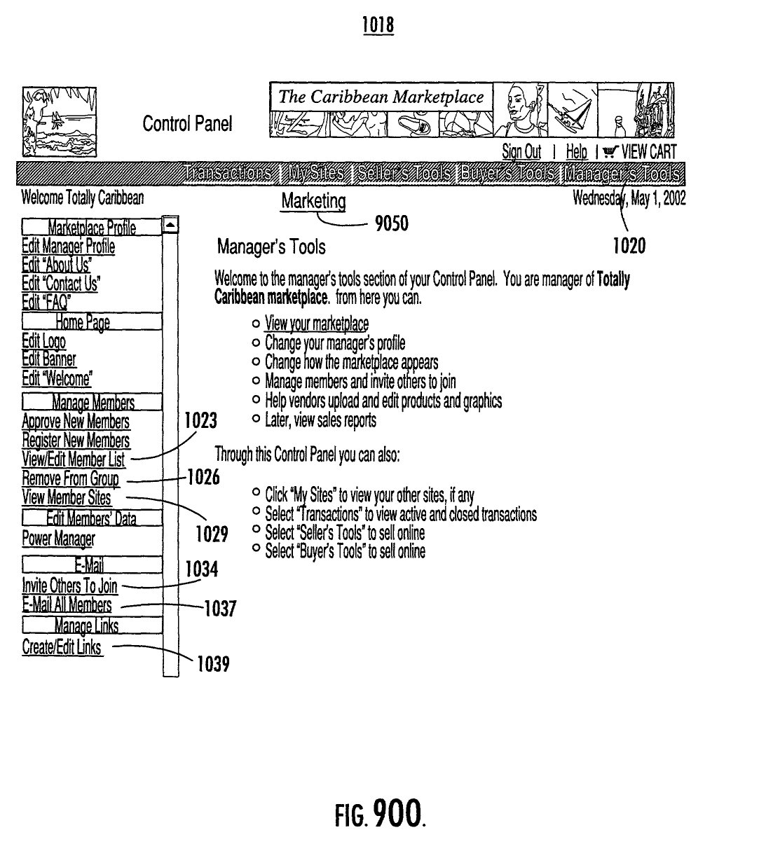

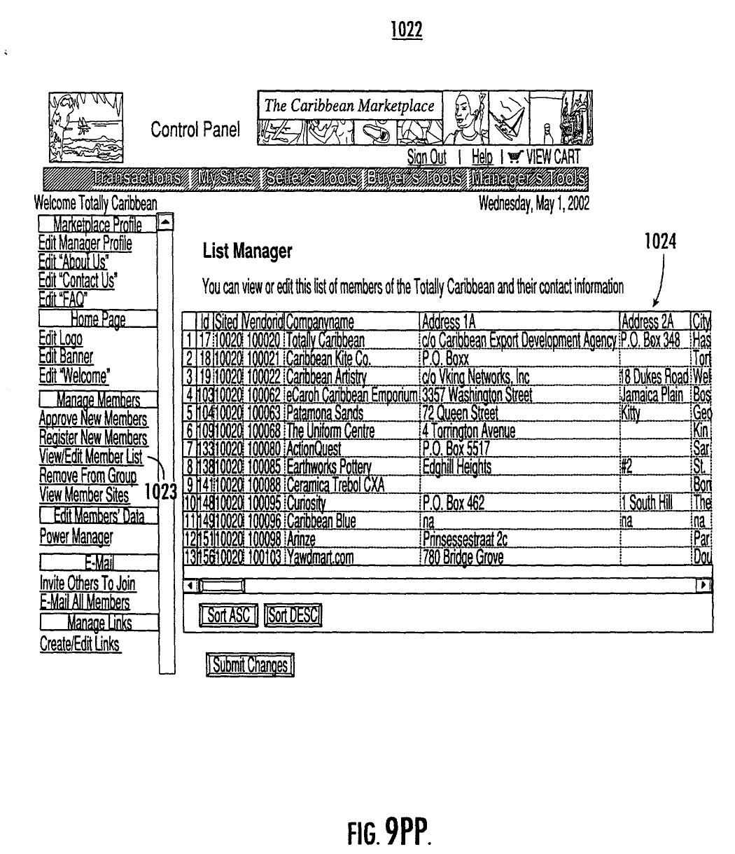

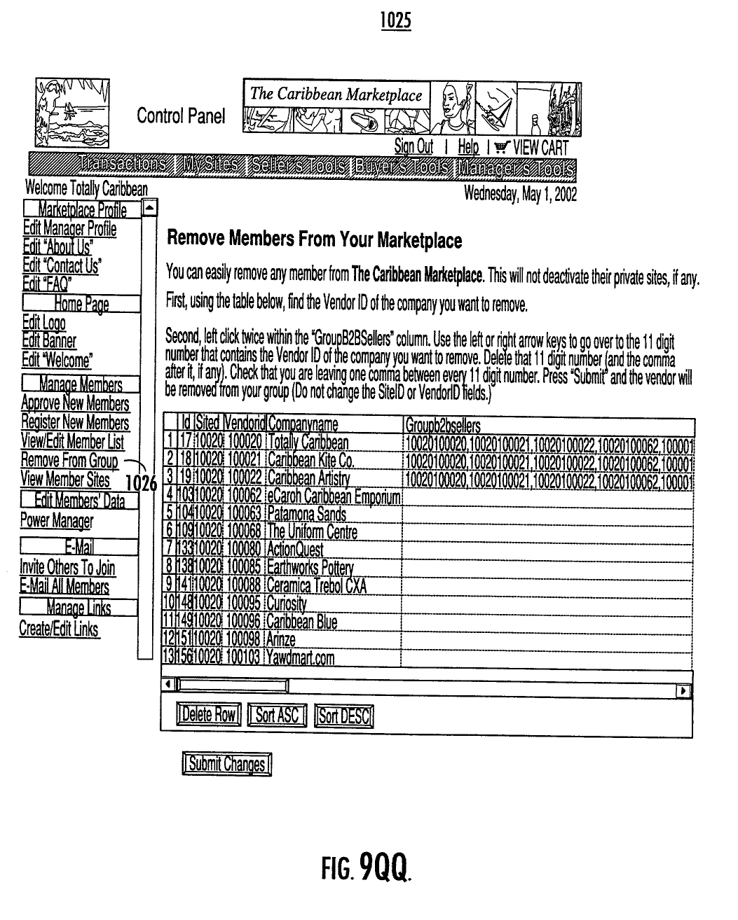

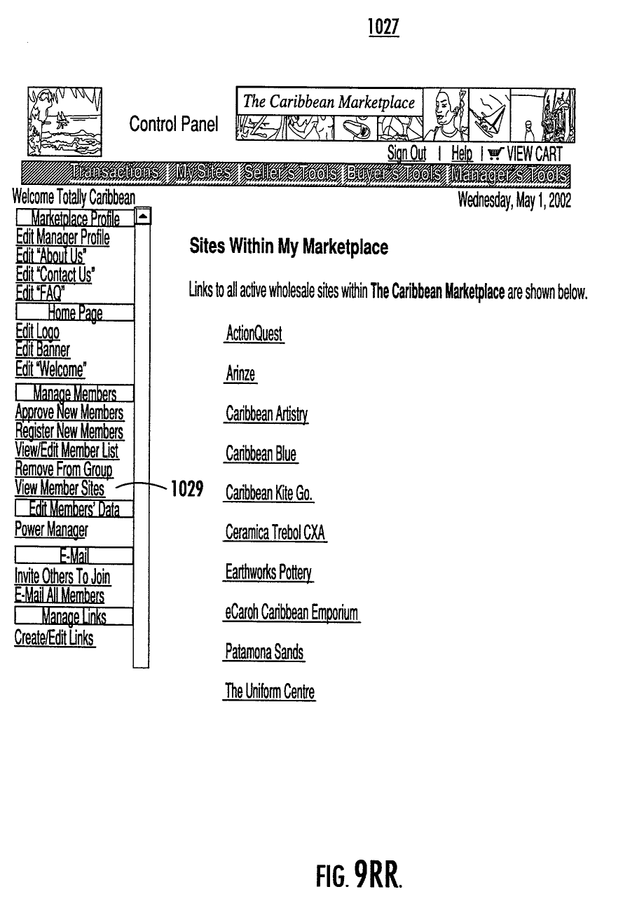

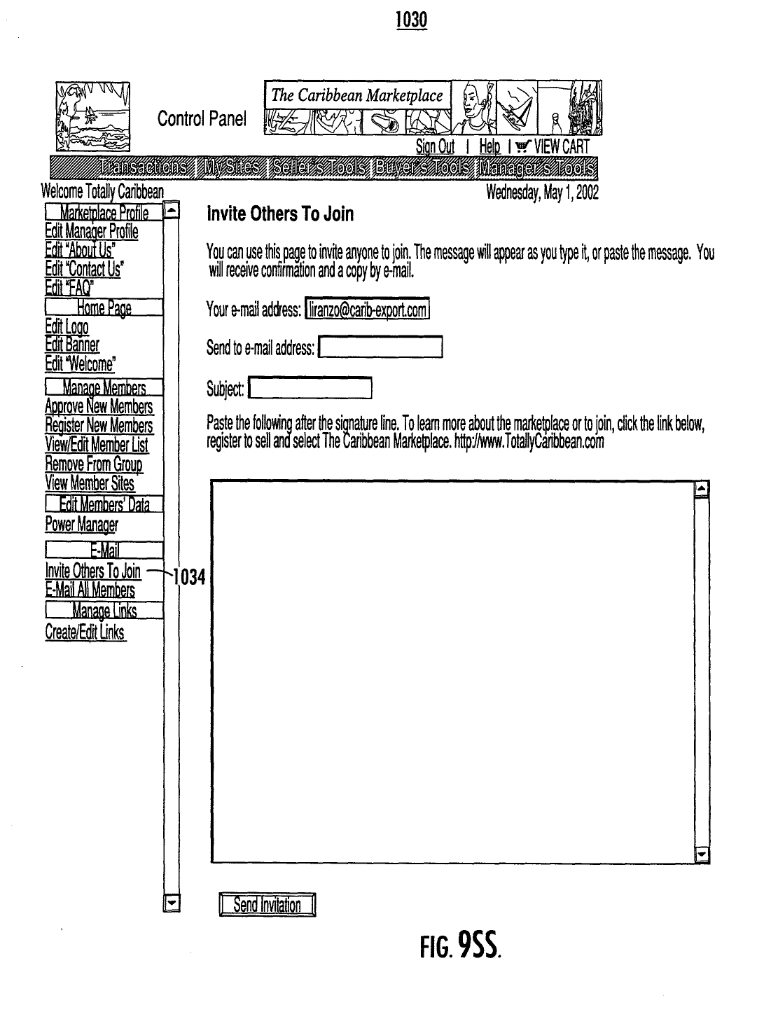

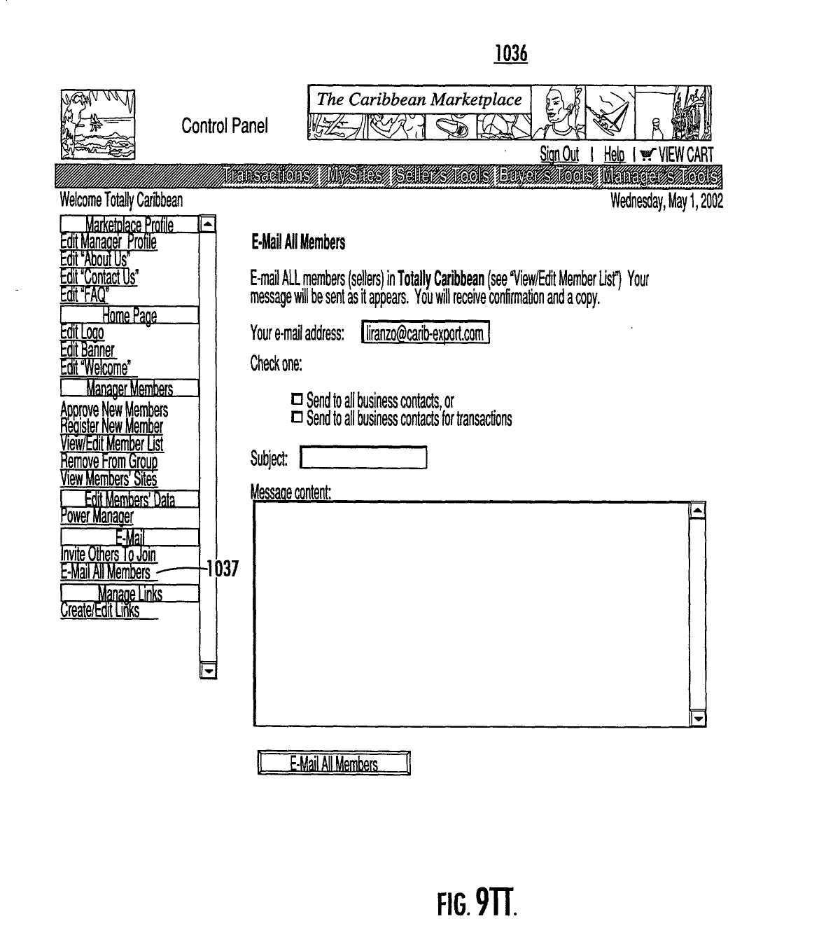

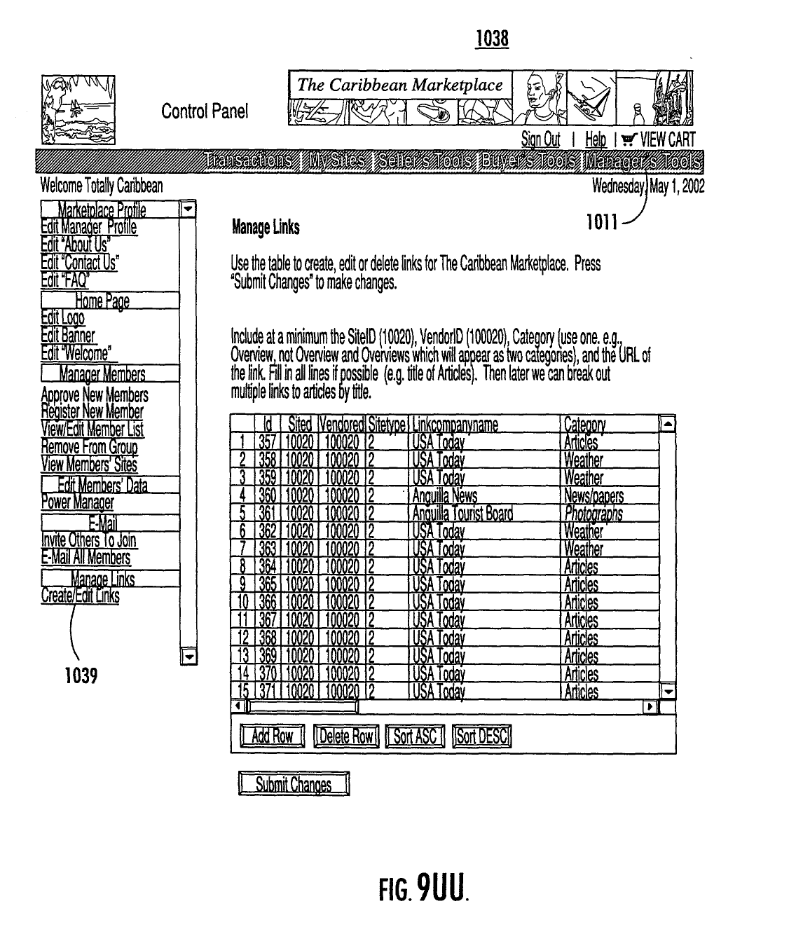

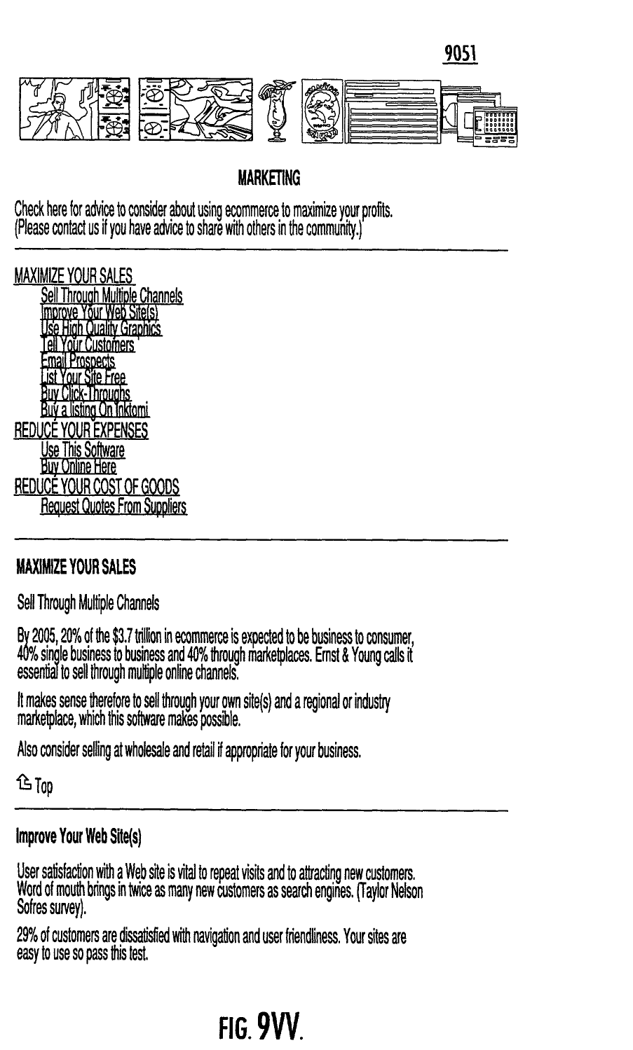

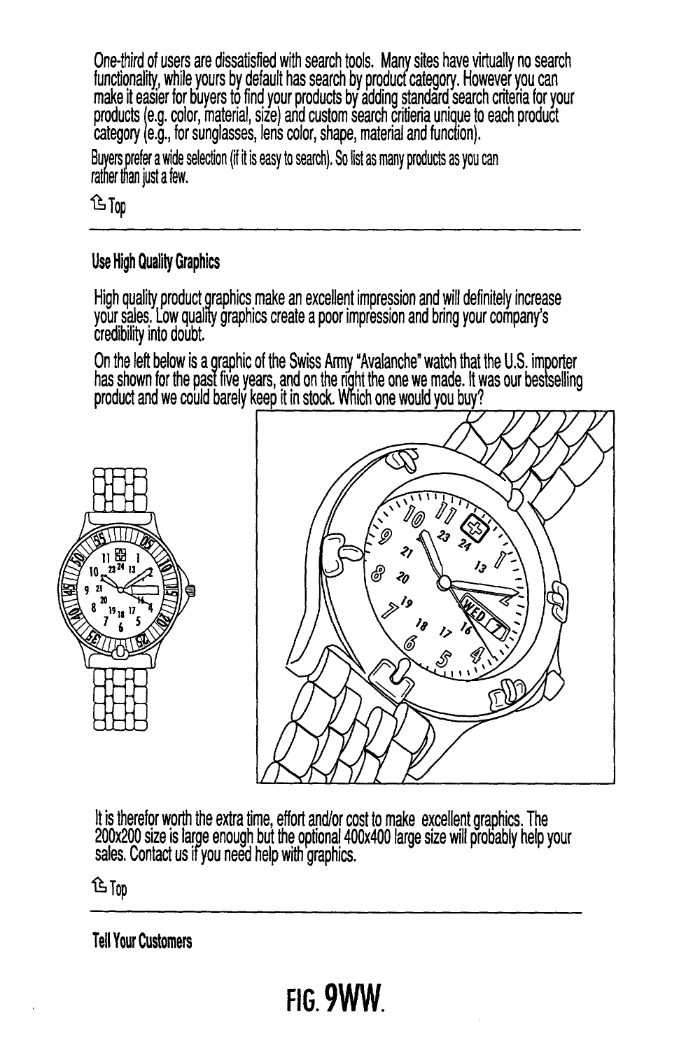

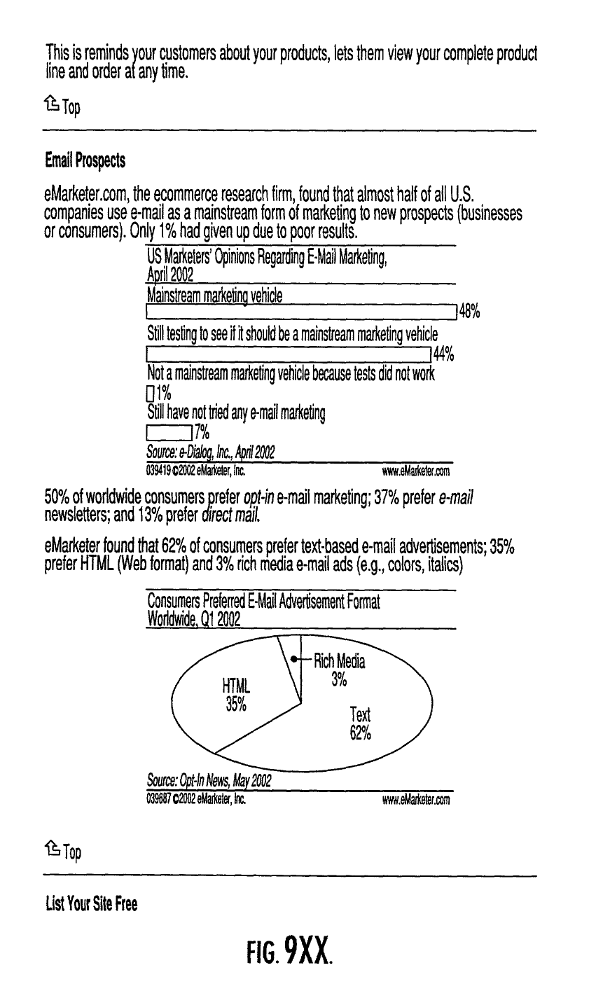

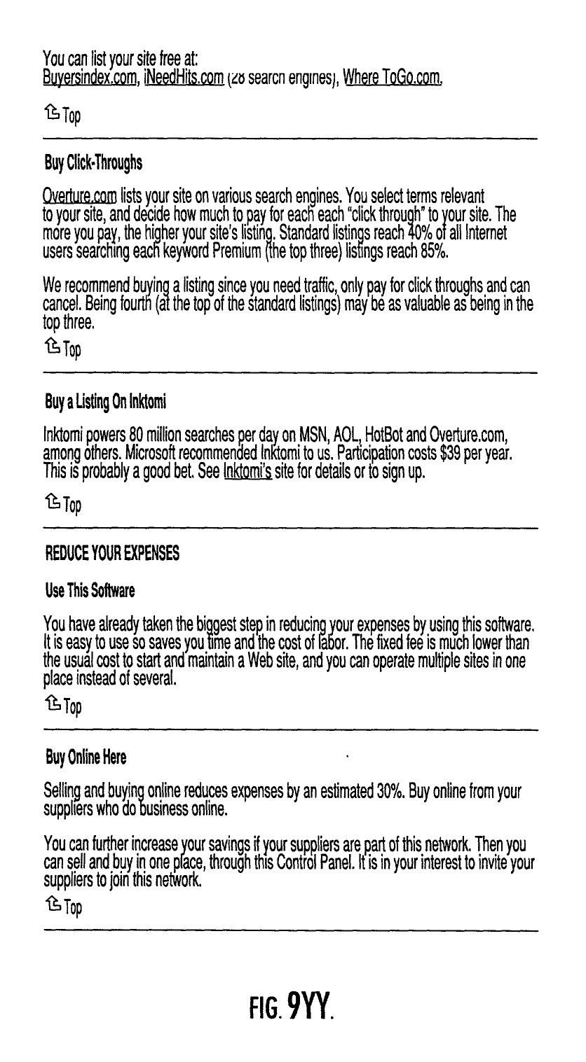

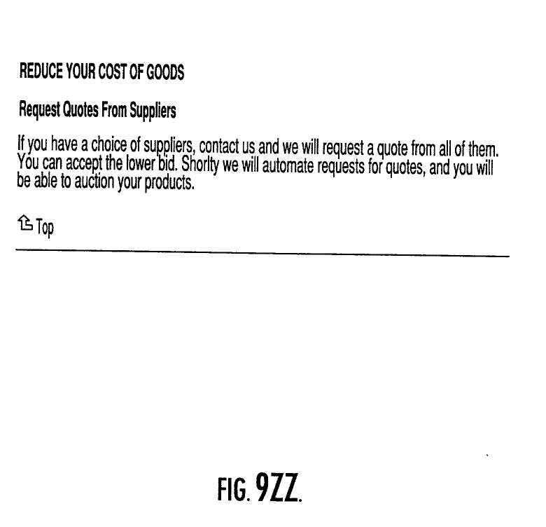

FIG. 9A is a view of Control Panel Web site screen 900 after seller's tools link 902 has been selected. The Control Panel gives sellers an easy way to add, change, or delete their company and product information. The Control Panel gives complete control over selling products and how the products appear in the seller's own Web sites and marketplaces. Web site screen 902, FIG. 9B is a view of Control Panel Web site screen 900 after the “Products” link in FIG. 9A has been selected showing four ways to add products. Companies can e-mail a product spreadsheet, click on add multiple products, or use the online spreadsheet which provides the ability for the user to enter all of the product information in less than hour, even with thousands of products to be entered. The user can add a single product which is automated, or click on the “Power Manager” link (as discussed below) and fill in the database shown by arrow 904.

FIG. 9C is a view of Control Panel Web site screen 906 for the “About Us” private wholesale site. Web site screen 906 includes paragraphs 907, 908, 909, and 910 which indicate various information about the private wholesale site company. Web site screen 906 links to a table called TblSpiel which has one row per vendor and contains a column for each paragraph. This Web site is reached by a vendor clicking on “My Control Panel” link 911 then the “Sell” link (not shown). The user can make changes which go into the database and the Web site changes are seen immediately.

Web site screen 912, FIG. 9D is a view of the Control Panel Web site screen 900 after the “Edit About Us” link 914 in FIG. 9A has been selected. Web site screen 912 shows seller's graphic logo 916, its Control Panel 918, its banner graphic 920, “Transaction” link 922, “My Sites” link 924, “Seller's Tools” link 926, “Buyer's Tools” link 928, and “Manager's Tools” link 930. The current value displayed in the “About Us” is indicated by arrow 931 and a new value for the “About Us” is indicated by arrow 932. The company can enter a new value and press the submit changes button (not shown) and the database instantly changes the seller's site.

FIG. 9E is a view showing a user editing the text of paragraph 910 of the “About Us” in FIG. 9C, as indicated by arrow 933. As shown in FIG. 9F, at arrow 934, the change in the text of paragraph 910 is reflected. Web site screen 934, FIG. 9G is a view of Control Panel Web site screen 900 after the “Contact Us” link 934 in FIG. 9A has been selected showing how seller's can edit contact information and the changes will be immediate. Web site screen 935, FIG. 9H is a view of Control Panel Web site screen 900 after the “Edit FAQ” link 934 in FIG. 9A has been selected. Sellers can easily change the frequently asked questions section of their private sites. Web site screen 936, FIG. 9I is a view of Control Panel Web site screen 900 after the “Edit Welcome” link 936 in FIG. 9A has been selected. Sellers can edit the welcome pictures and welcome text on their private sites. Web site screen 937, FIG. 9J is a view of Control Panel Web site screen 900 after the “Edit What's New” link 938 in FIG. 9A has been selected. Web site screen 939, FIG. 9K is a view of Control Panel Web site screen 900 after the “Edit Logo” link 940 in FIG. 9A has been selected showing how sellers can easily add or change logos.

Web site screen 941, FIG. 9L is a view of Control Panel Web site screen 900 after the “Edit Banner” link 942 has been selected. Any seller can add or change its banner, such as banner 943, at any time. The seller creates a graphic and uploads the file to the host computer. The file then goes into the vendor's directory or folder on the server. The name of the file goes into the database for this vendor (table TblHome page). Web site screen 944, FIG. 9M is a view of Control Panel Web site screen 900 after the “Edit Features” link 945 in FIG. 9A has been selected. Seller's can change the features of the home page of their own sites, both wholesale and retail. Seller's can show the three best selling products and select one to three products to feature and create custom graphics and text. Web site screen 945, FIG. 9N is a view of Control Panel Web site screen 900 after the “Edit Clearance” link 946 in FIG. 9A has been selected. This shows how sellers can select which products can appear under the “Clearance” link. Web site screen 947, FIG. 90 is a view of Control Panel Web site screen 900 after the “Add Multiple Products” link 947 in FIG. 9A has been selected. Users can upload product files through the host server which is the easiest way to add many products. Once the spreadsheet is complete, sellers can add thousands of products in minutes. The file must be named with a specific name to identify the company, such as 100000.xls. User can then upload the file clicking on the upload this file button 948. Companies can download a product spreadsheet, complete the spreadsheet, name the file with the vendor ID, and then upload it to the server.

FIG. 9P is a view of Web site screen 949 after the “Add Single Product” link 950 in FIG. 9A has been selected. This allows sellers to add a product and graphics one by one. The changes are immediately activated to the Web site. The only required fields are SKU, as indicated by arrow 951, description, as indicated by arrow 952, and selling price, as indicated by arrow 953. FIG. 9Q is a continued view of FIG. 9P. Sellers complete the textboxes in block 954 if selling by retail and the textboxes in block 955 if selling by wholesale. The seller can enter the pieces per unit (e.g., a box of twelve) and show the wholesale prices, unit, prices per unit, and price per item. FIG. 9R is a view of Web site screen 956 after the “Create a Category” link 957 in FIG. 9A has been selected. This feature allows a seller to automatically create a new product category when need. FIG. 9S is a continued view of screen 956 after the “Create a Category” link 957 has been selected showing textbox 959 where the user types in the name of the new category. Drop down/select box 961 displays the seller's current categories. A user then click the submit category button 960 which activates Web site screen 961, FIG. 9T. This shows that the user has created a new category “Sculpture”, as indicated by arrow 961 in the Caribbean marketplace, as indicated by arrow 962. Screen 961 shows the standard search fields available and an option for the user to automatically create new custom search fields for this product category. For example, a user can click on checkbox 963 and create a search field “Material” in textbox 964. In this example the user has entered that the “material is used in sculpture such as wood and stone”, as indicated by arrow 965. Similarly, other customized fields can be used, as shown by arrows 966, 967, and 968 can be added.

Web site screen 969, FIG. 9U is a view of Control Panel Web site screen 900 after the “Managers Tools” link 970 has been selected. Managers can select a vendor in their marketplace and the data they want to edit, with permission. For example, basic information needed to sell, product status, pictures, prices or all data can be selected. The managers can edit, add, or delete sellers, sellers information, and product information in their marketplace.

Web site screen 971, FIG. 9V is a view of Control Panel Web site screen 900 after the “Power Manager!” link in FIG. 9A has been selected. Web site screen 971 screen shows drop down/select box 973 which provides basic information, graphics, prices, or product status. The power manager lets sellers select what they want to see or change in a data base format. After the user selects basic information from drop down/select box 973, additional information is displayed where the seller can see everything in the form of table 974, FIG. 9W. This table holds the vendor's products, vendor ID, site ID, SKU number for each product, the category for the product, and the collection.

Web site screen 975, FIG. 9X is a view of Control Panel Web site screen 900 after the “Activate/Deactivate Brands” link 976 in FIG. 9A has been selected. In this example, drop down/select box 977 provides the ability for sellers to activate or deactivate every product in a brand. In this example, a music company sells various brands of products and the seller can select and activate any brand, which takes effect immediately. The brand is not deleted, it just simply becomes inactive. The seller can reactivate the brand at any time. The seller simply deactivates the product by selecting the product from drop down/select box 977 and presses the deactivate button 978. After pressing deactivate button 978, a list of products for the user is displayed, as indicated by arrow 979, FIG. 9Y and the user simply deactivates the desired product by clicking on any of the checkboxes within block 980.

Web site screen 980, FIG. 9Z is a view of Control Panel Web site screen 900 after the “Edit Single Product ” link 981 in FIG. 9A has been selected. Sellers simply click on any of the products listed to edit the product. For example, clicking on “Charlie's Records” link, as shown by arrow 982, activates Web site screen 983, FIG. 9AA. Once the product is selected, the user can change the product information through the browser and click the “Submit Changes” button 984, which immediately reflects the changes in the database and the Web site. The old values and new values are shown, as indicated in block 985. Sellers can also set different prices in different sites and in different marketplaces, as shown in FIG. 9BB. For example, a seller might set lower prices in one marketplace due to competition. If the site type is inactive, there is no need to set the price. Check off boxes 986 and 987 allow the seller to set, or not set the price for its own site. In this example, site type 3 indicates a wholesale general marketplace, site type 4 indicates a wholesale group marketplace, site type 5 indicates a private wholesale site, site type 6 indicates a retail general marketplace, site type 7 indicates a group retail marketplace, and site type 8 indicates a private retail site.

Web site screen 984, FIG. 9CC is a view of Control Panel Web site screen 900 after the “Delete Products” link 985 in FIG. 9A has been selected. In this example sellers can delete any product at any time. Web site screen 985, FIG. 9DD is a view of Control Panel Web site screen 900 after the “Multiple Graphics” link 987 in FIG. 9A has been selected. Sellers can send graphics to the host provider, upload them one by one, or combine them as a zip file.

Web site screen 988, FIG. 9EE is a view of Control Panel Web site screen 900 after the “Graphics For One Products” link 992 in FIG. 9A has been selected. Seller can select model number from drop down/select box 993 and indicate which size graphic they desire to upload (small, medium, or large). These graphics are located on the seller's computer and uploaded to the host computer. The file then goes into an appropriate file on the server and the file name goes into the vendor's database in the products table.

Web site screen 994, FIG. 9FF is a view of Control Panel Web site screen 900 after the “Edit File Names” link 995 in FIG. 9A has been selected. This feature provides the seller with the ability to see what files are their database. If a small or medium product picture is missing, “NA” will appear. Sellers can then upload the missing graphic and also correct any misspellings. The name of the graphic files in the seller's folder on the server are shown, as indicated by arrow 996.

FIG. 9GG is a view of Web site screen 1000 after the “Buyer's Tools” link 997 has been selected. When a company registers as a wholesale buyer, a “2” goes in the vendor table as its vendor type. When the buyer signs in, the buyer goes to the buyer's section of “Control Panel” to start. Buyer's can also sell and conduct transactions by clicking on the “Transactions” link 998, and can edit its company profile by clicking on “Edit Buyer Profile” link 999, or select any industry or region to shop by clicking on the “Any Sites or Marketplace” link 1001. Optionally, the system in accordance with this invention can be programmed so that sellers restrict buyers/customers from seeing and shopping in other sites and marketplaces.

Web site screen 1002, FIG. 9HH is a view of Control Panel Web site screen 900 after the “Buyer's Tools” link 997 in FIG. 9A has been selected showing the various buyer's tools. For example, a buyer can select the “Request a Quote” link 1003 where the buyer can request a quote from multiple sellers and accept the lowest price. Buyers can specify sellers, or the software can automatically match the buyers of various sellers. Buyers can send a Request for Quote (RFQ) at selected intervals. Buyers can also select to form a buying group by selecting the “Create a Group RFQ” link 1004. For example, a seller may give a 25% discount for one thousand unit orders or higher. For example, buyer A forms a buying group and indicates it will buy 250 units until a specified date. All buyers of the same product are notified. Then, for example, buyer B may agree to buy 500 units or more. If buyer C agrees to buy the balance before the deadline, the combined order is processed and buyers A, B, and C get the lower price.

Web site screen 1005, FIG. 9II is a view of Control Panel Web site screen 900 after the “My Sites” link 1006 in FIG. 9A has been selected. Sellers can than click, for example, on the Caribbean Marketplace link 1007, and view the places where their products are being sold. FIG. 9JJ shows a Web site screen 1008 after the “My Sites” link 1009 in FIG. 9II been selected. Vendors can participate in two sites and numerous marketplaces both wholesale and retail and can activate or deactivate any of the marketplaces. FIG. 9KK is a view of Web site screen 1010 after the “Activate/Deactivate” link 1011 in FIG. 9II has been selected. Users simply click the sites and marketplaces they desire to be a member of, as shown in box 1012. Web site screen 1013, FIG. 9LL is a view of Web site screen 1005 after the “Create New Marketplace” link 1016 in FIG. 9A has been selected. Sellers can also create a new industry or regional marketplace if there is none found that suits their needs by entering the new marketplace name in textbox 1014, FIG. 9MM. After the name is entered, the seller clicks Submit Marketplace Name button 1015. Web site screen 1017, FIG. 9NN shows how sellers can also form or join a group by selecting the “Form or Join a Group” link 1018 from Web site screen 1005, FIG. 9II. With this feature, a seller can quickly create a group when sellers in the group have registered.

Web site screen 1018, FIG. 9OO, is a view of Control Panel Web site screen 900 after the “Manager's Tools” link 1020 in FIG. 9A has been selected. Managers can view the marketplace, change the manager's profile, change how the marketplace appears, manage members, invite others to join, help vendors upload and edit products, and view sales reports. Managers can view participants' sites, transactions, seller's tools, and buyer's tools. Only marketplace managers see Manager's Tool link 1020 and Web site page 1018. Managers can change the marketplace profile and home page, manage members, edit their data (with permission), and create or edit links unique for the industry or region.

Web site screen 1022, FIG. 9PP is a view of the manager's tool screen 1018 after the “View/Edit Member List ” link 1023 in FIG. 9OO has been selected. Managers can view contact information about each vendor in their group by viewing table 1024 and editing the table. Site ID 10020 in table 1024 identifies the industry or regional marketplace. Web site screen 1025, FIG. 9QQ is a view of the manager's tool screen 1018 after the “Remove From Group” link 1026 in FIG. 9OO has been selected. Marketplace managers can create the rules about who can join a group, and usually have the right to remove a member. Web site screen 1027, FIG. 9RR is a view of the manager's tool screen 1018 after the “View Member Sites” link 1029 in FIG. 9OO has been selected. This unique feature makes it easier for marketplace managers to view their members private sites. Web site screen 1030, FIG. 9SS is a view of the manager's tool screen 1018 after the “Invite Others to Join” link 1034 in FIG. 9OO has been selected. Managers can invite anyone to join their marketplaces or to join as a buyer. Web site screen 1036, FIG. 9TT is a view of the manager's tool screen 1018 after the “E-Mail All Members” link 1037 in FIG. 9OO has been selected. Managers can easily e-mail all members, such as business contacts or the contacts for transactions. Web site screen 1038, FIG. 9UU is a view of the manager's tool screen 1018 after the “Create/Edit” link 1039 in FIG. 9OO has been selected. Each marketplace manager can add, edit, or delete links relevant to the industry, region, or group. Web site screen 9051, FIG. 9VV is a view of the manager's tool screen 1018 after the “Marketing” link 9050 in FIG. 9OO has been selected. Marking information is available to all sellers, buyers and managers using the system. Sellers, buyers and managers can maximize sales by selling though multiple channels, improve their Web sites, and use high quality graphics, as shown in FIG. 9WW, or e-mail prospects, as shown in FIG. 9XX, Buy “click-throughs”, buy a listing on Inktomi™, or reduce their expenses, as shown in FIG. 9YY, and request a quote from suppliers, as shown in FIG. 9ZZ.

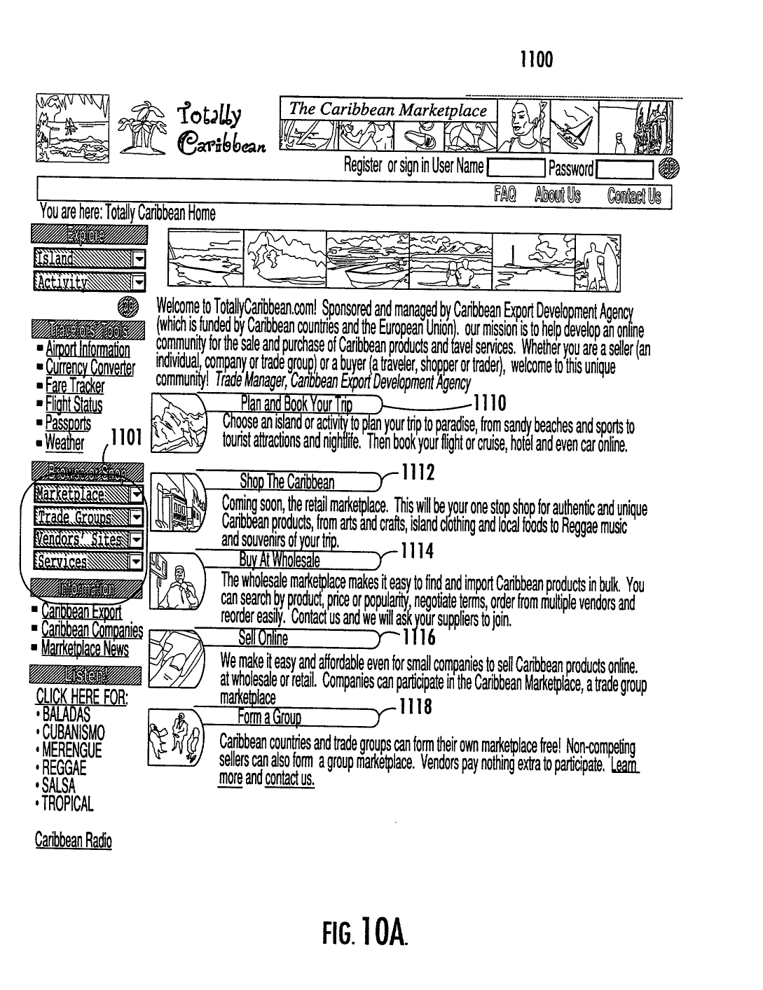

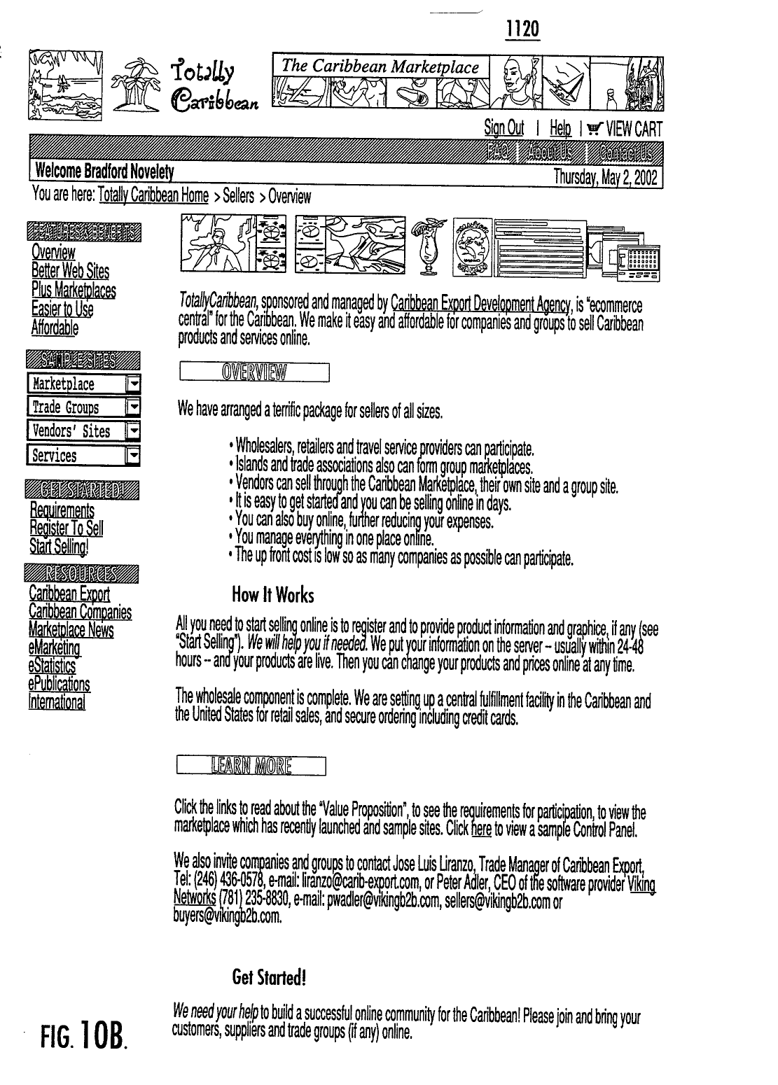

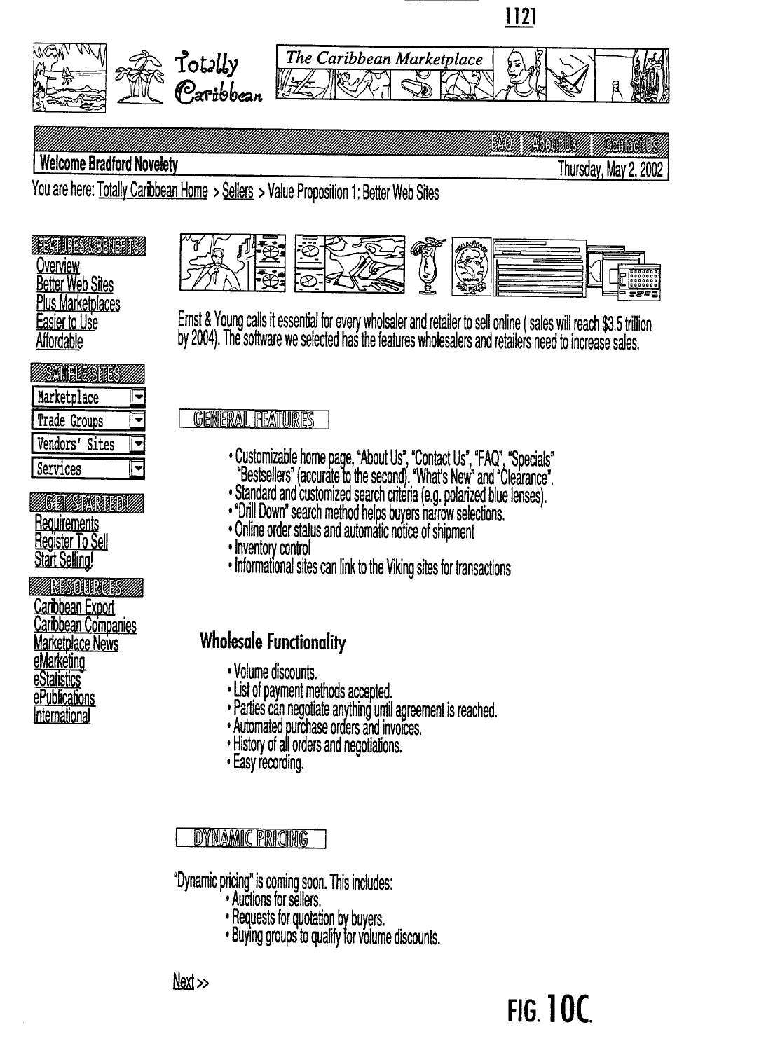

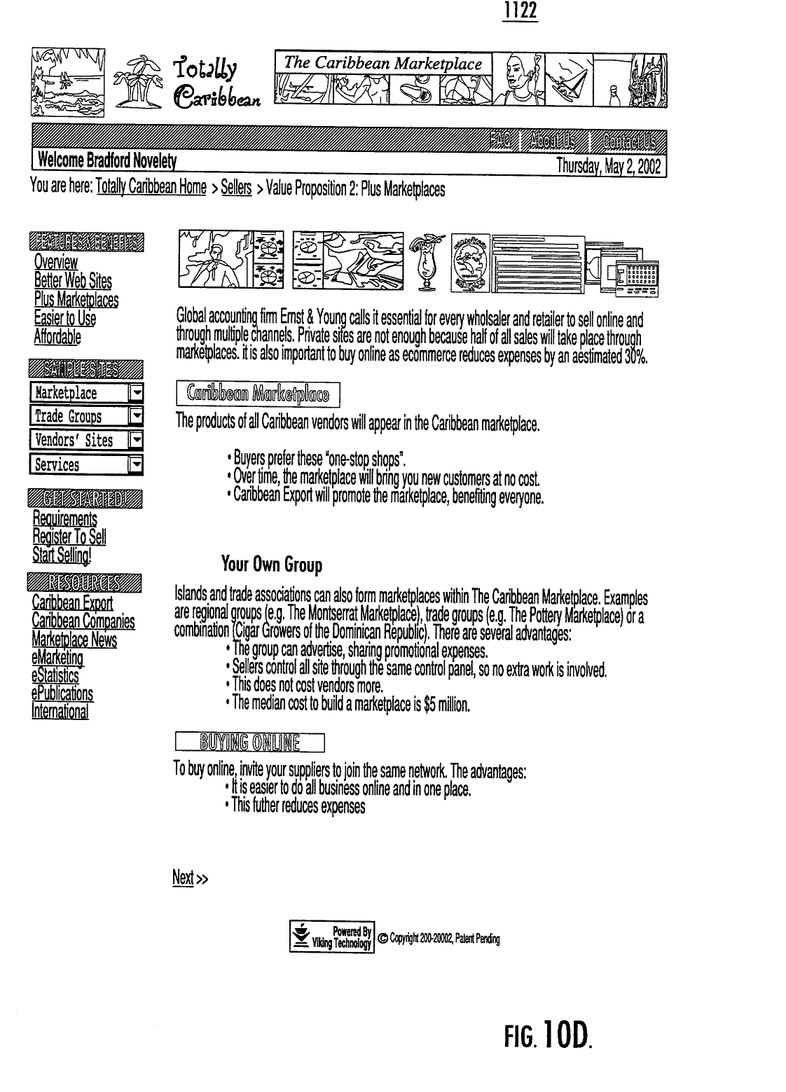

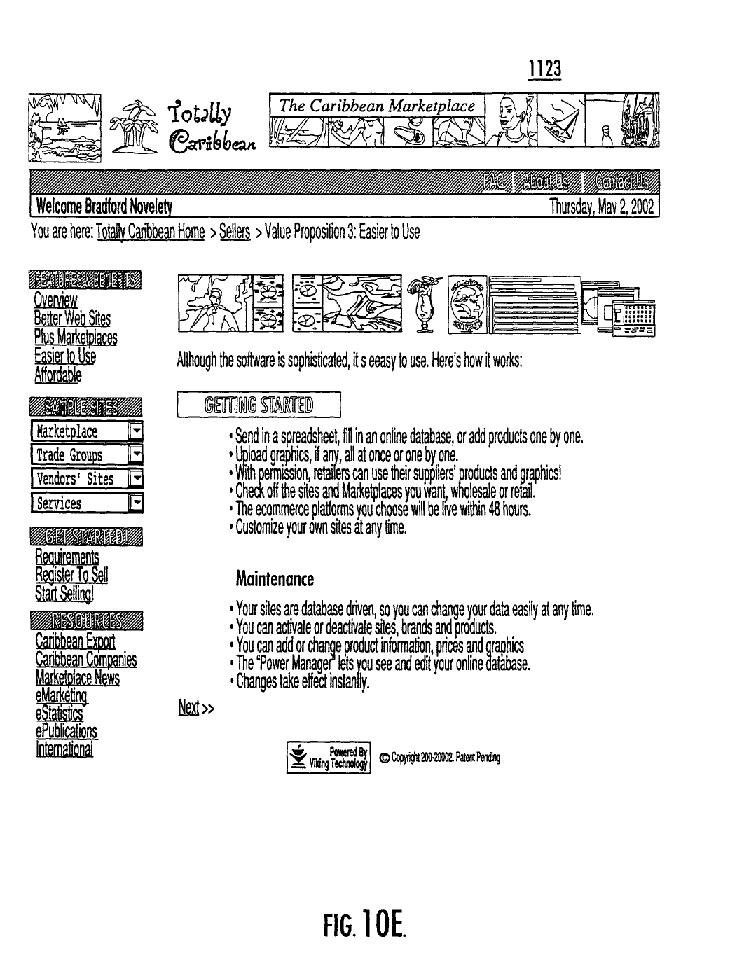

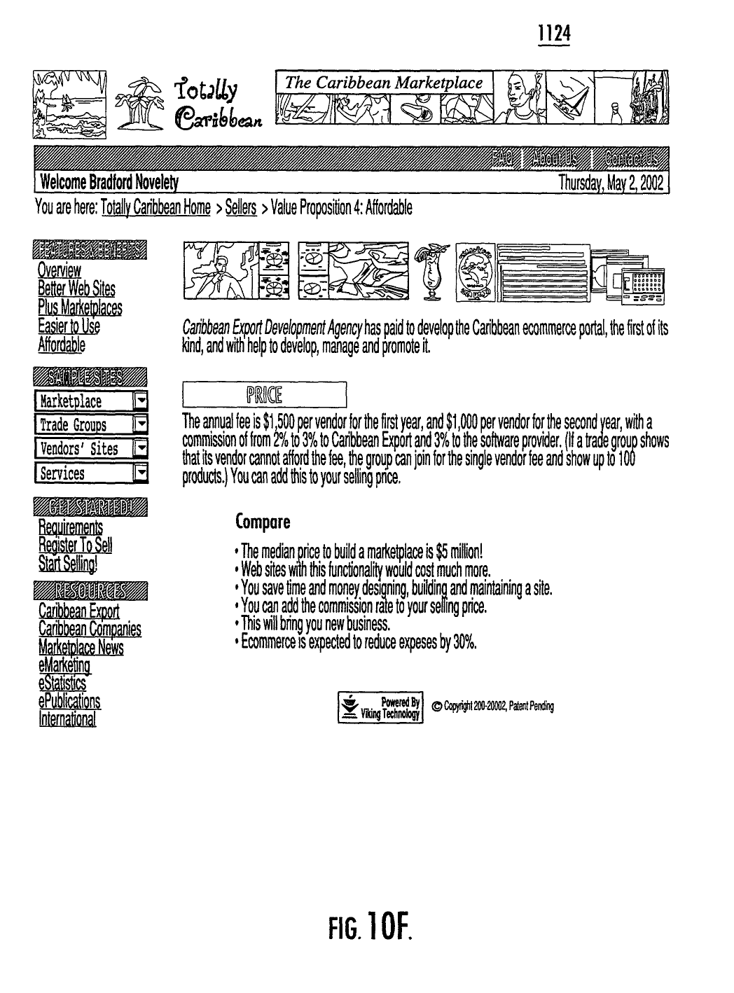

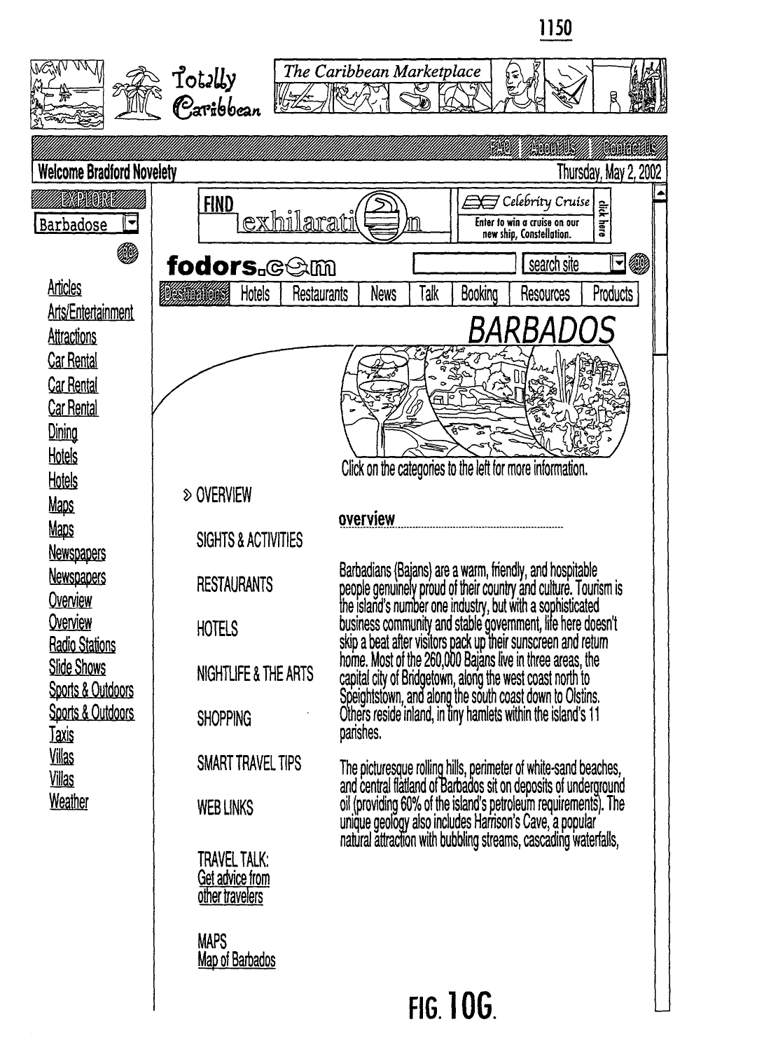

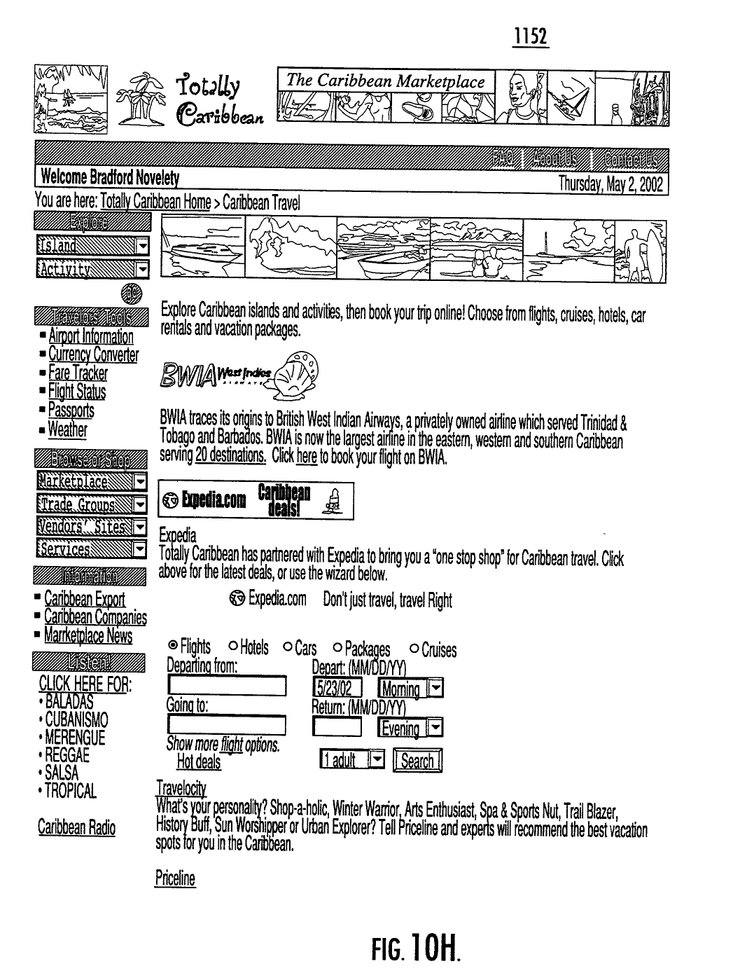

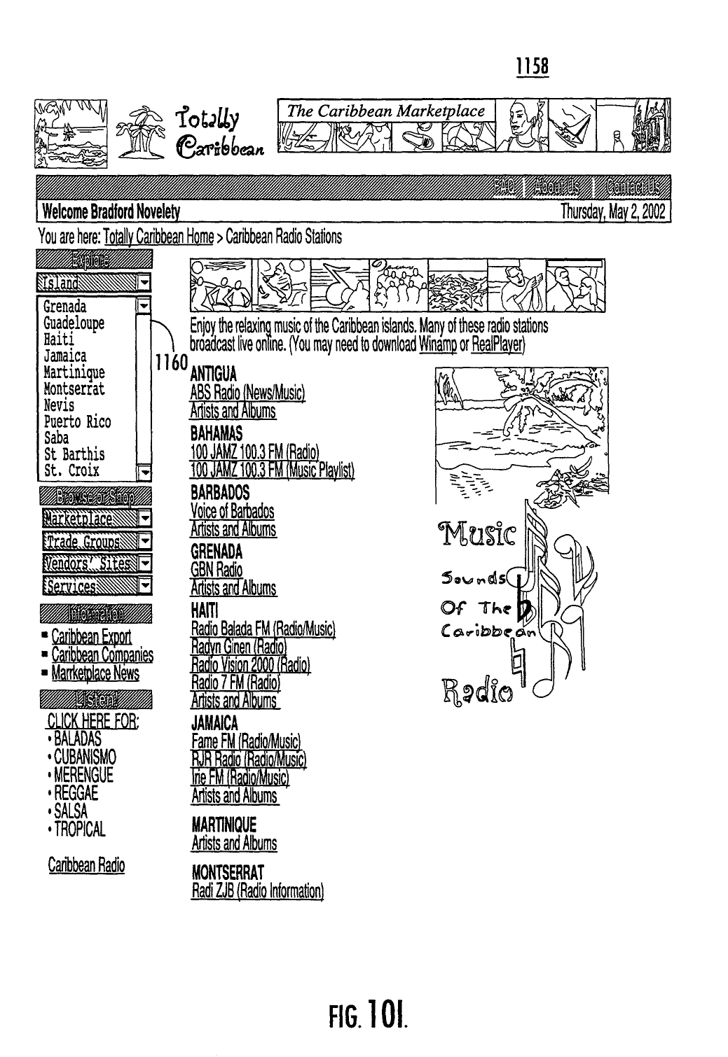

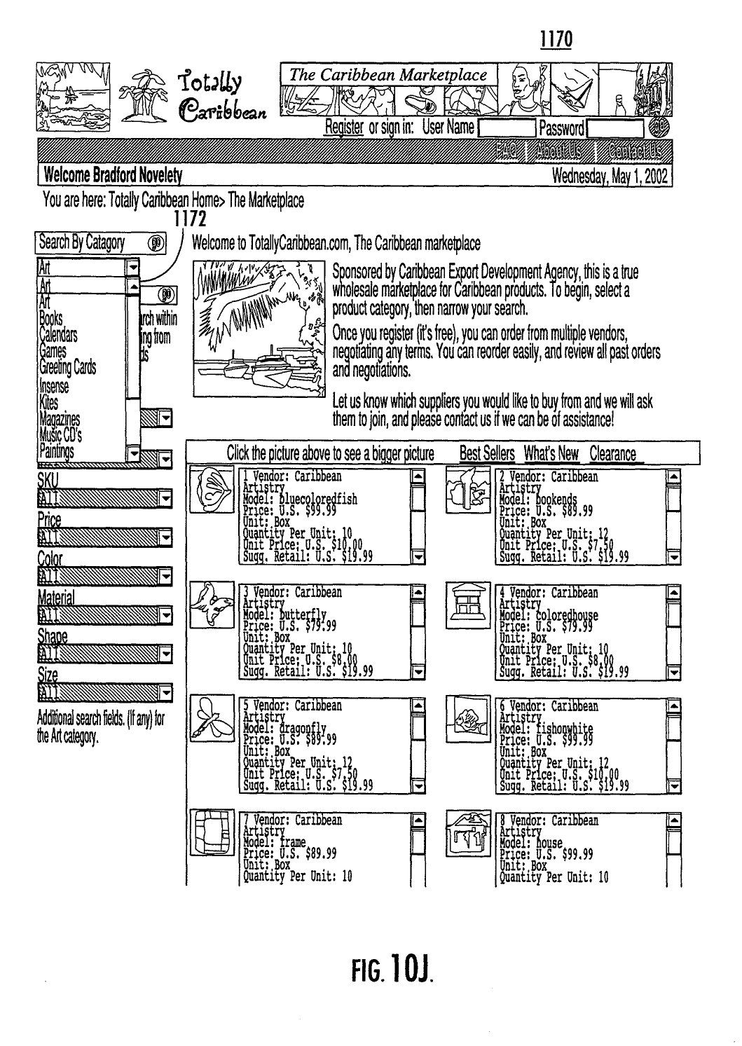

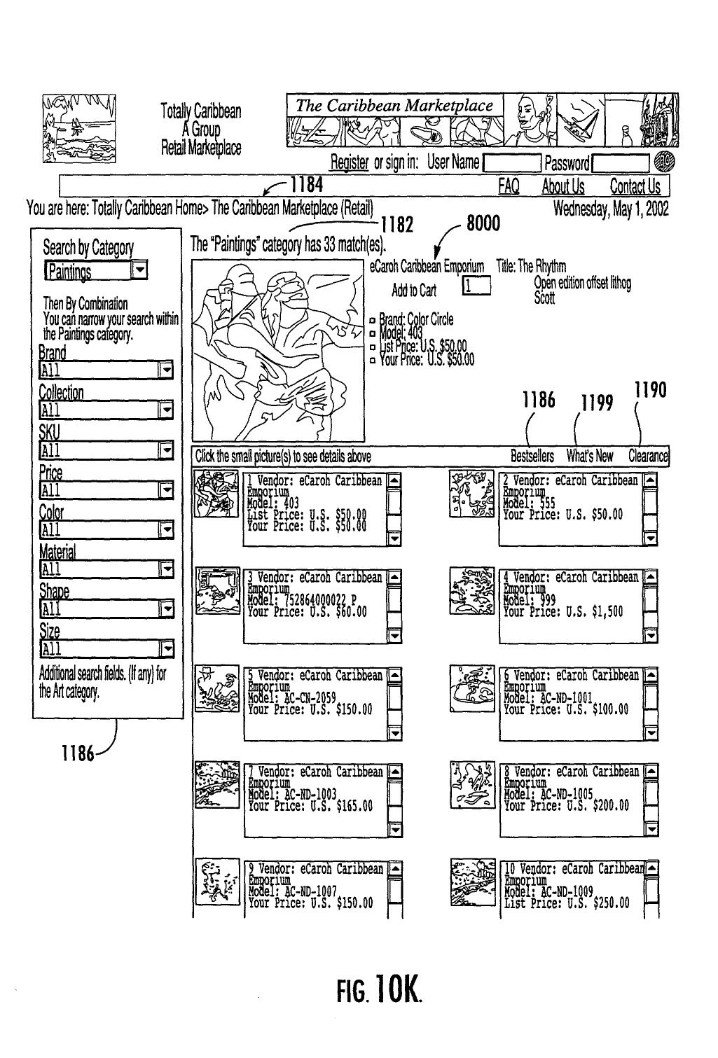

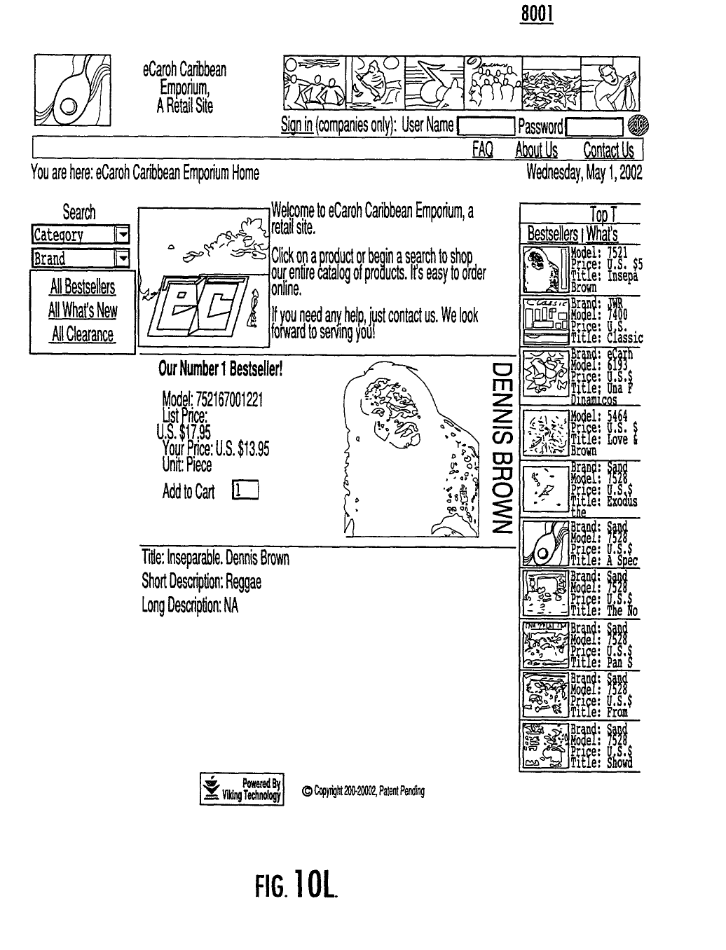

Web site screen 1100, FIG. 10A shows an example of a typical marketplace in accordance with this invention. This is the portal page or front of a regional marketplace. In this example, the marketplace is the regional Caribbean marketplace. Sellers, buyers, and sub-group managers branch off from this page. Buyers can shop the marketplace (all vendors who elect to participate in it), trade groups, or any marketplace, such as in export association, or sellers sites or services by selecting from any of the drop down select boxes from block 1101. Users can click on any of the various links, such as link 1110 to book travel, link 1112 to buy at retail, which will lead to the retail marketplace, link 1114 to buy at wholesale, which will lead the user to the wholesale marketplace, link 1116 to sell at wholesale or retail, link 1119 to form a group marketplaces.

Web site 1120, FIG. 10B is an overview of the benefits of selling through a particular marketplace in accordance with this invention. Web site screen 1121, FIG. 10C is a view of a marketplace showing the general features, wholesale functionality, and dynamic pricing of this invention. Web site Screen 1122, FIG. 10D is a view of the Caribbean marketplace screen. Wholesalers and retailers may sell online through multiple channels. The wholesalers and retailers have their own sites and marketplaces and may also buy online. The software in accordance with the subject invention makes it possible to perform all of these functions automatically and simultaneously. Multiple marketplaces may be driven off a single database and sellers have the ability to easily and inexpensively create their own Web sites. Instead of costing millions of dollars to produce one marketplace, the system in accordance with the subject invention easily creates marketplaces at minimal costs.

Web site screen 1123, FIG. 10E is a view of the automated “self serve” feature operations of the subject invention. Web site screen 1124, FIG. 10F is a view of a typical marketplace screen showing the minimal price of $1,500.00 for a vendor to become a member in the first year. The software in accordance with the subject invention is so unique and novel that companies can form their own Web sites and several marketplaces automatically.

Web site Screen 1150, FIG. 10G is a view of a typical marketplace showing an example of a link from a marketplace, in this example, the Caribbean showing an overview of the marketplace for the country of Barbados.

Web site Screen 1152, FIG. 10H is a view of a typical marketplace showing one example of a travel section of services where a customer can book a trip. Web site screen 1158, FIG. 10I is a view of a typical marketplace after a search category has been selected. Shoppers can select and browse links to any country in the region or the many activities from drop down/select box 1160. Marketplace managers can add, delete, or edit links through the Control Panel, as discussed in detail above.

Web site screen 1170, FIG. 10J is a view of a typical marketplace showing a search by category from drop down/select box 1172. This is an example of a home/welcome/front page inside a wholesale regional marketplace. Web site screen 1180, FIG. 10K shows an example of the category “Paintings”, as indicated by arrow 1182, which has been selected, inside the Caribbean marketplace, as indicated by arrow 1184. Users can narrow the search by selecting criteria from any of the drop down/select boxes in block 1186. There are also links to “Best Sellers”, “What's New” and “Clearance”, as indicated by arrows 1186, 1188, and 1190. User's can also click vendor name link 8000, in this example for the vendor eCaroh Caribbean Emporium, and proceed directly to the seller's private site, as shown in Web site screen 8001, FIG. 10L.

Web site screen 1192, FIG. 10M shows a different search for the “uniform” category, as indicated by arrow 1194, to locate an exact product. For example, the user has clicked thumbnail icon 1196 and the system displays large icon 1198, as shown in FIG. 10M. The software in accordance with this invention allows any number of sellers showing any number of categories of products to create search criteria as discussed above.

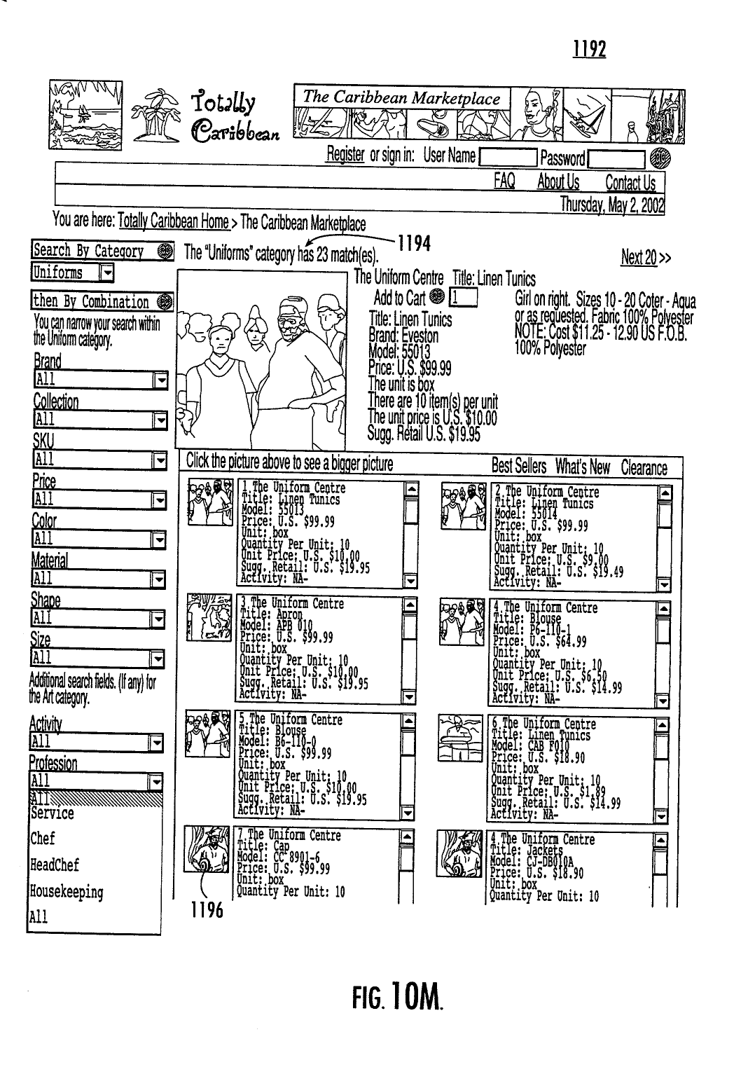

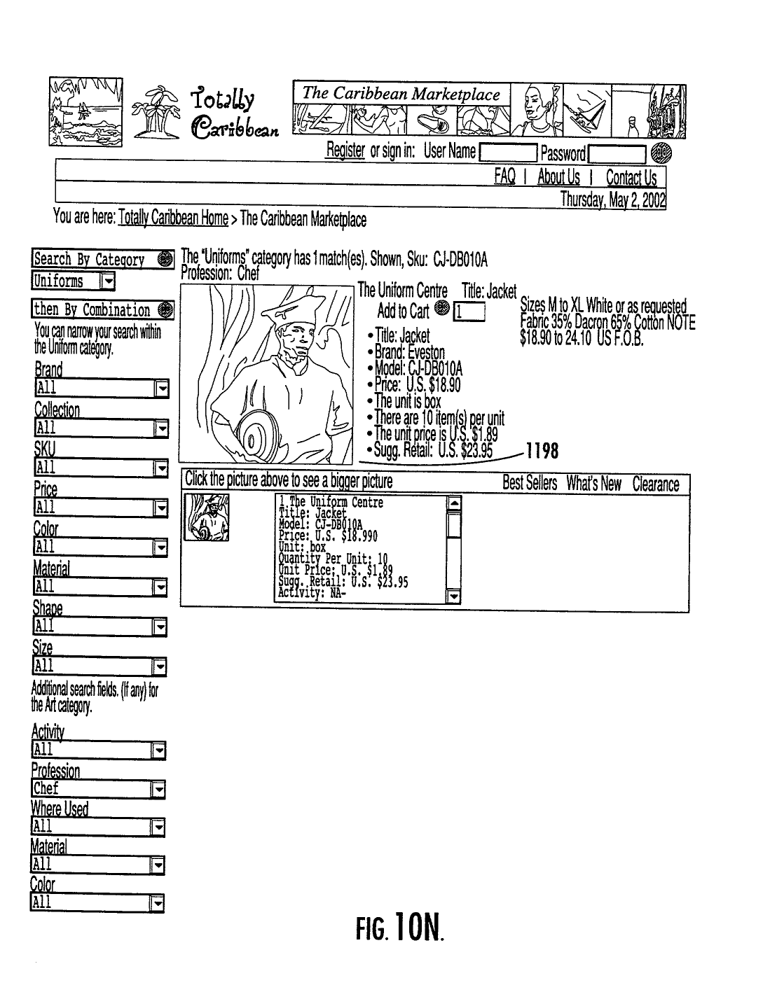

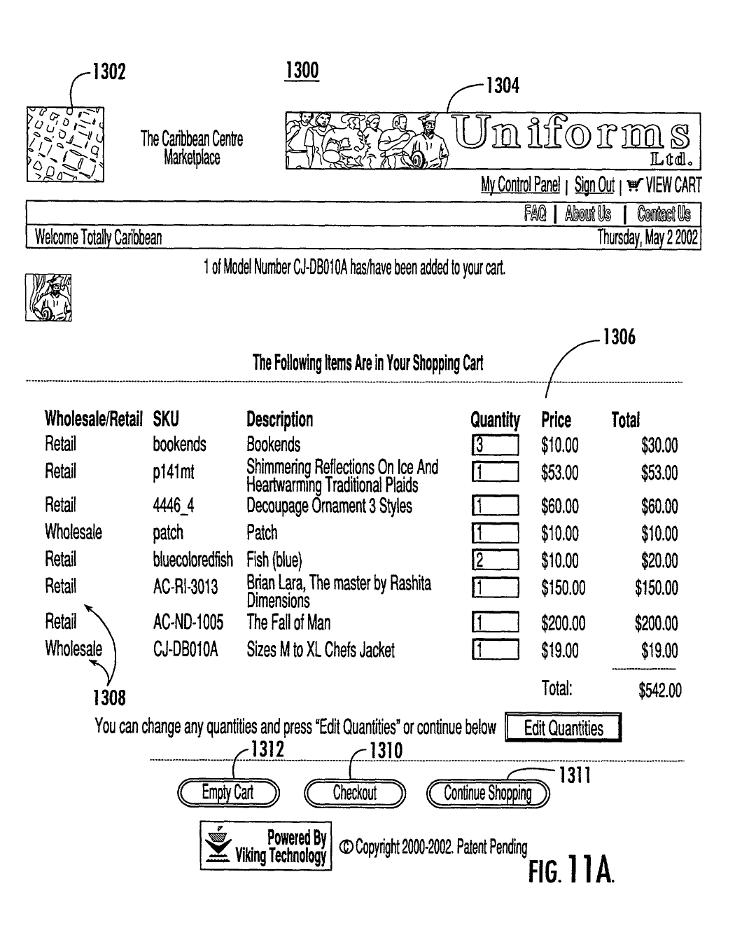

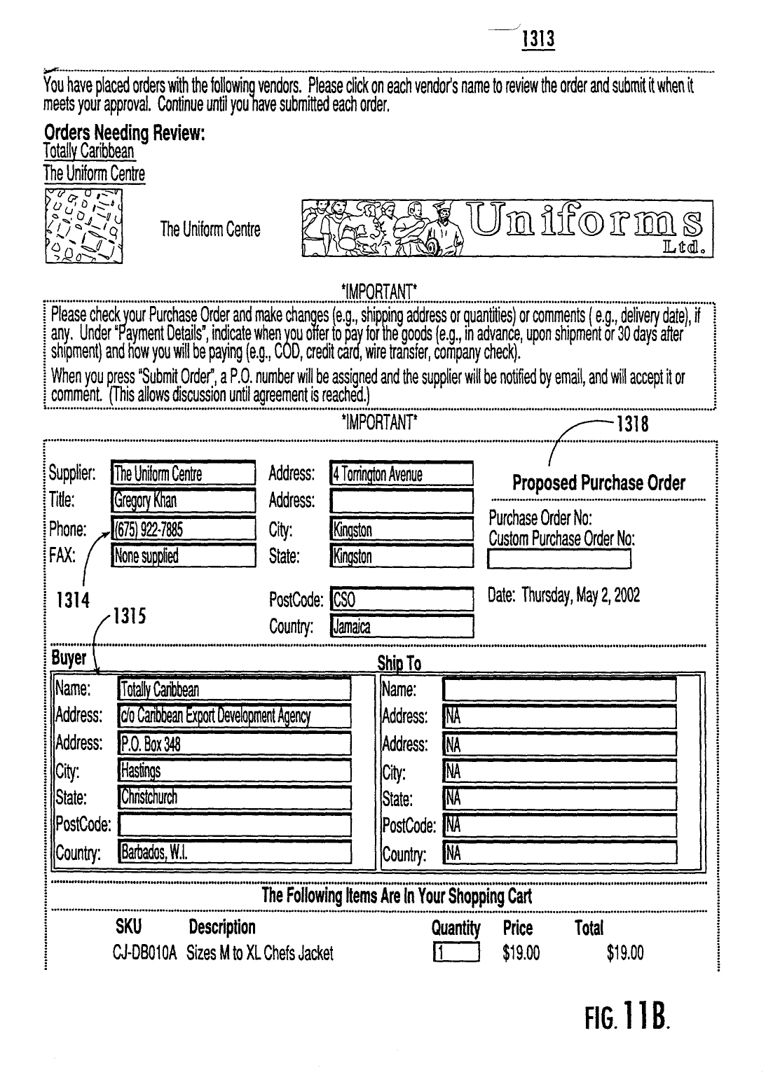

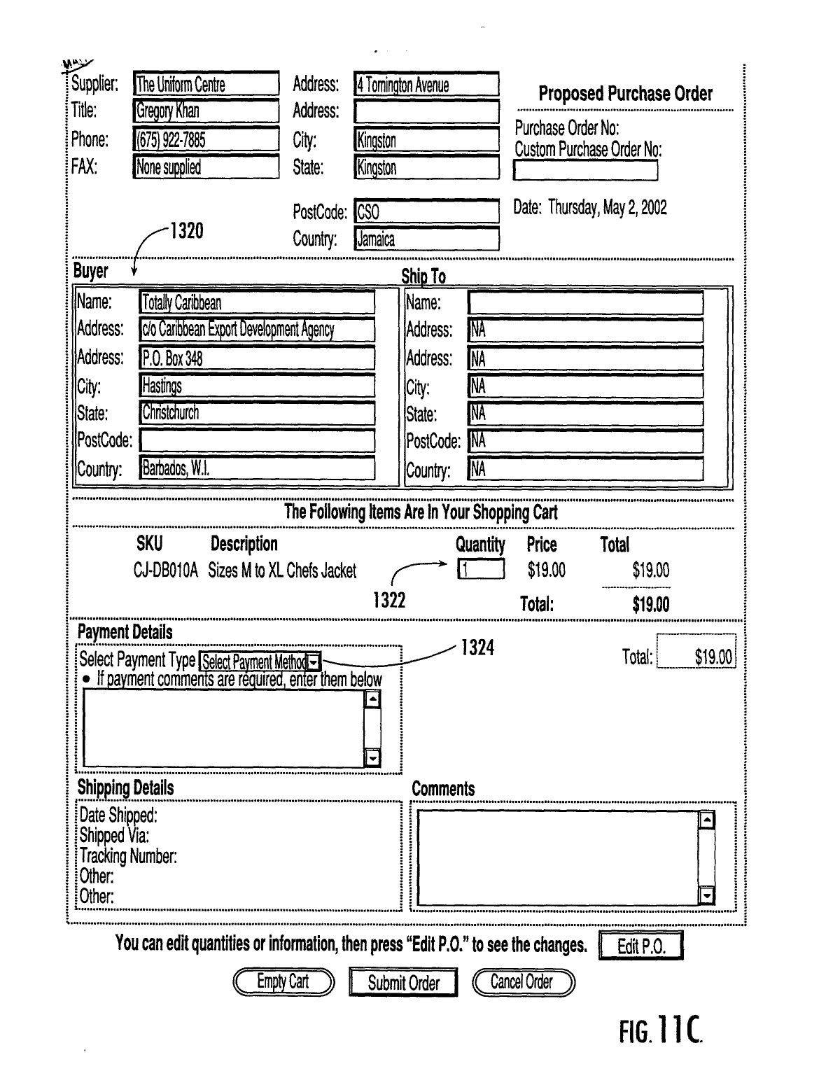

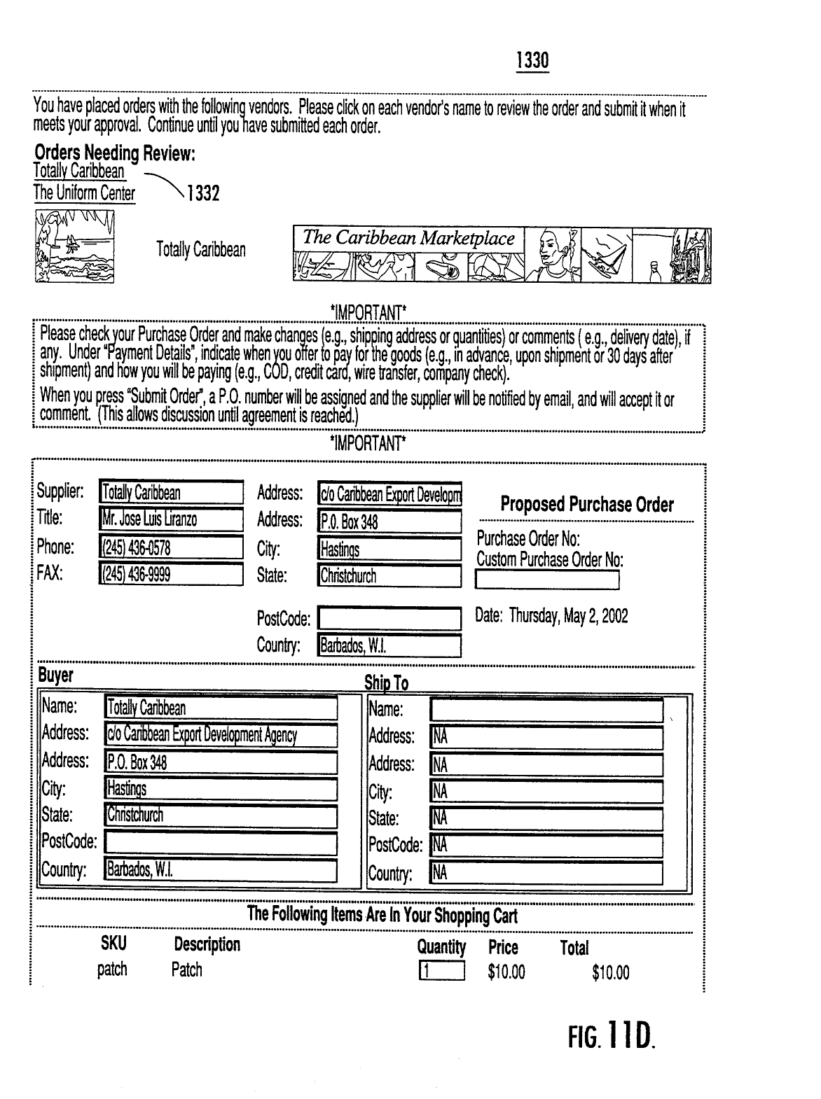

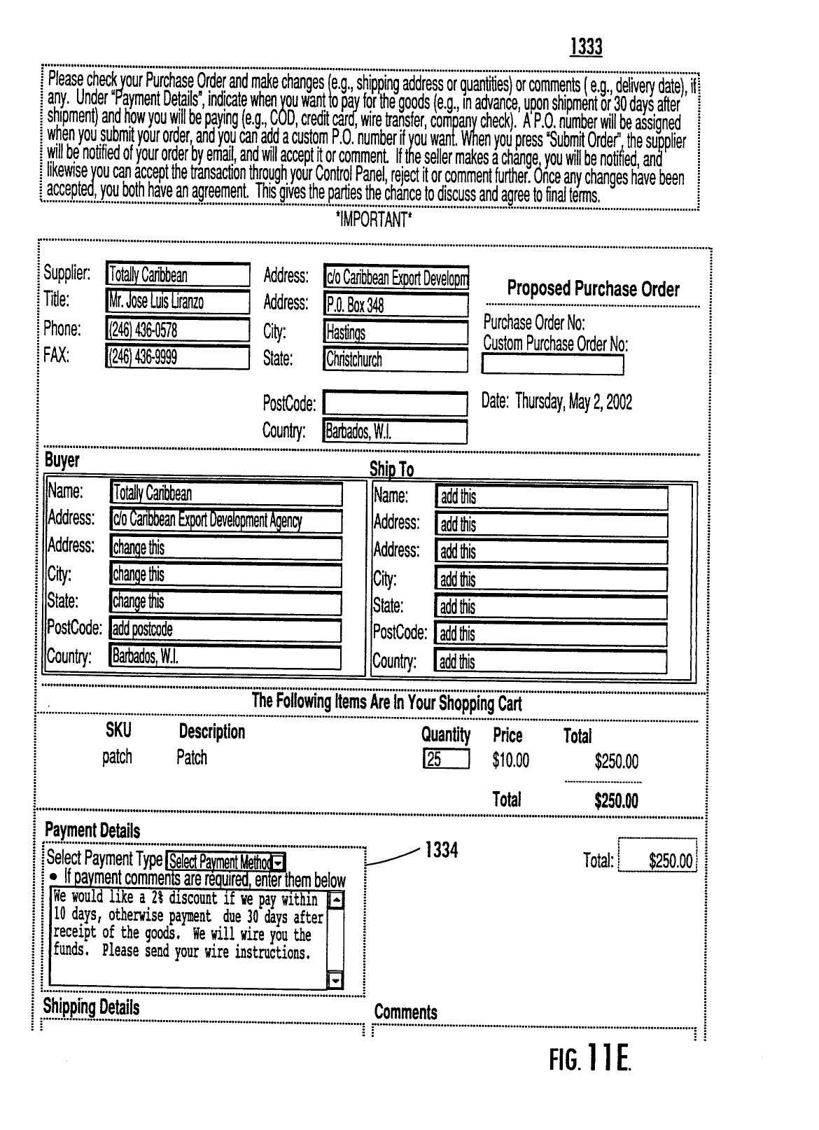

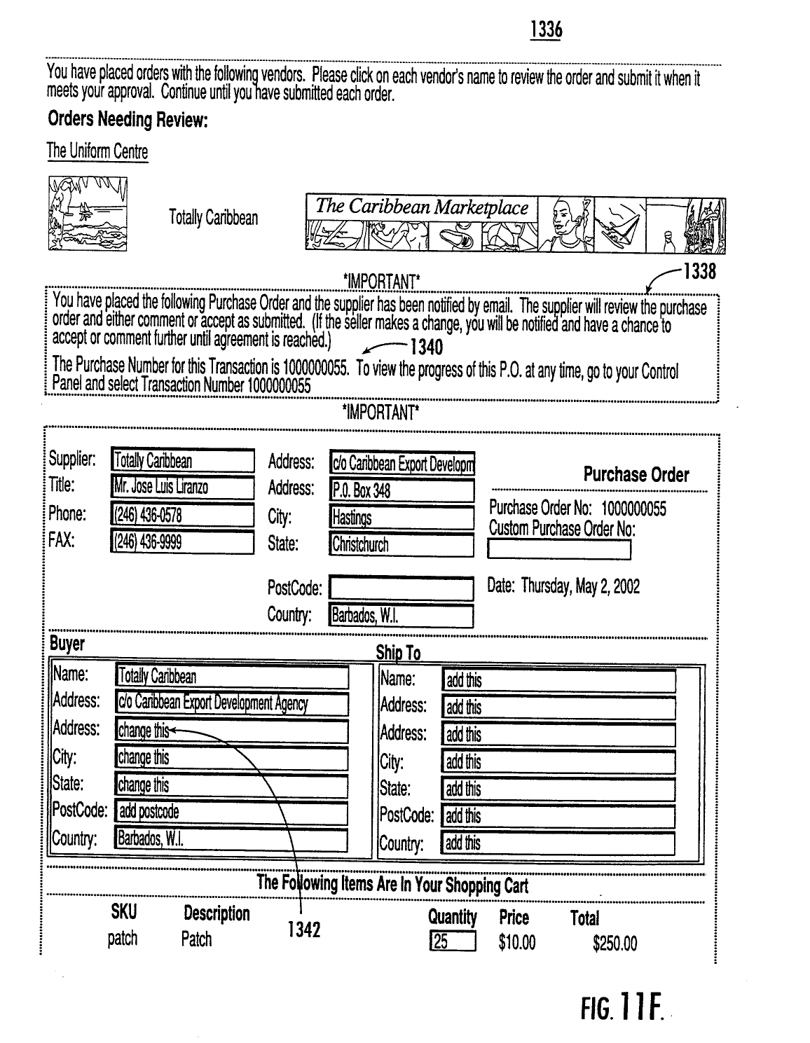

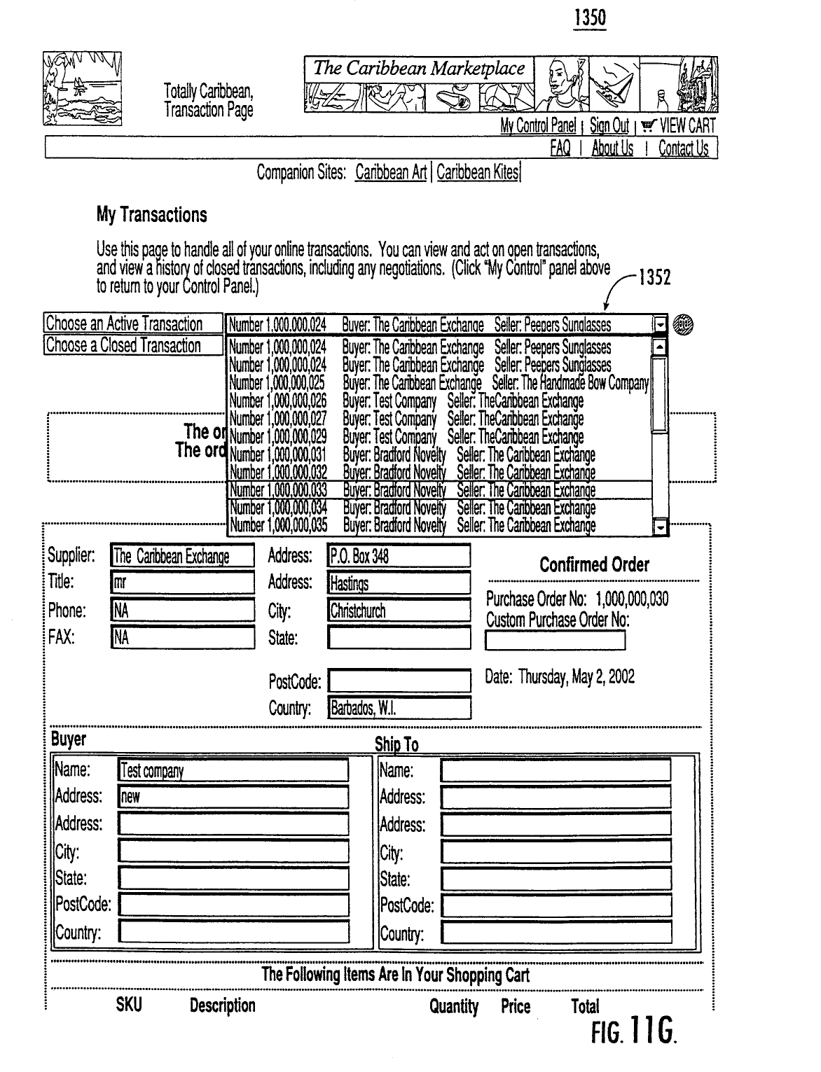

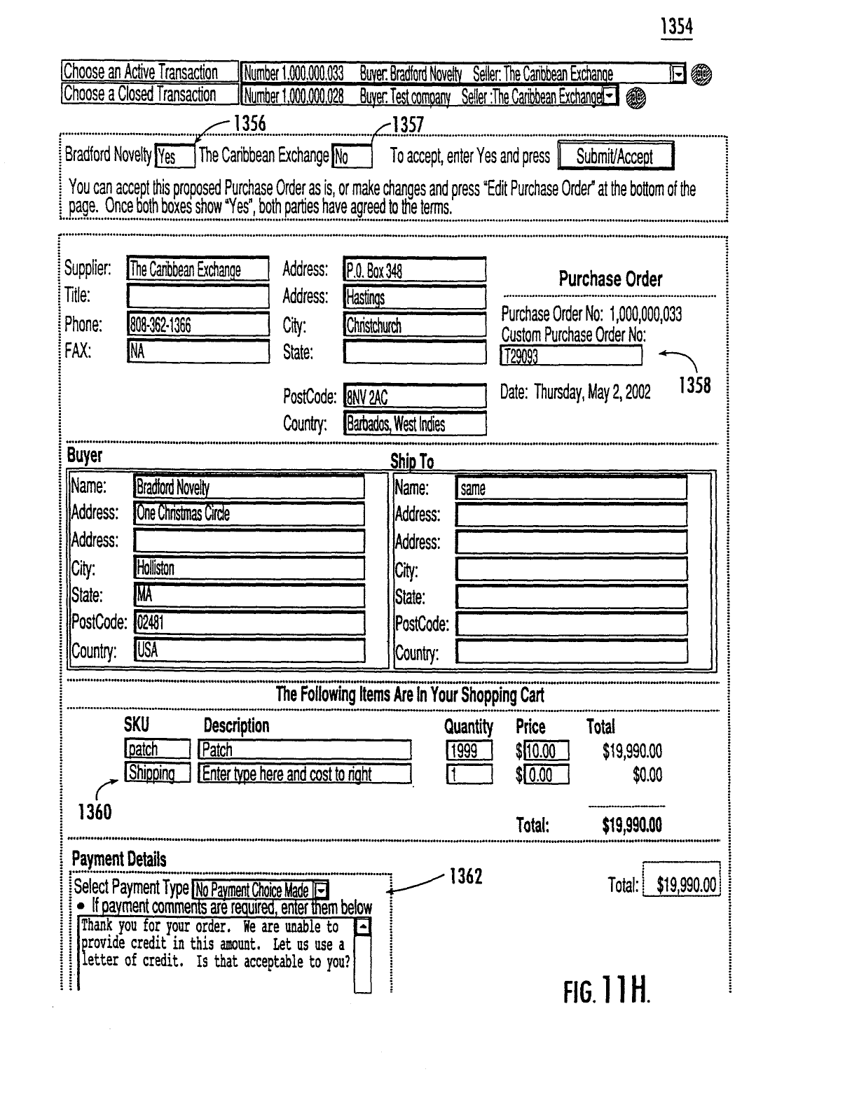

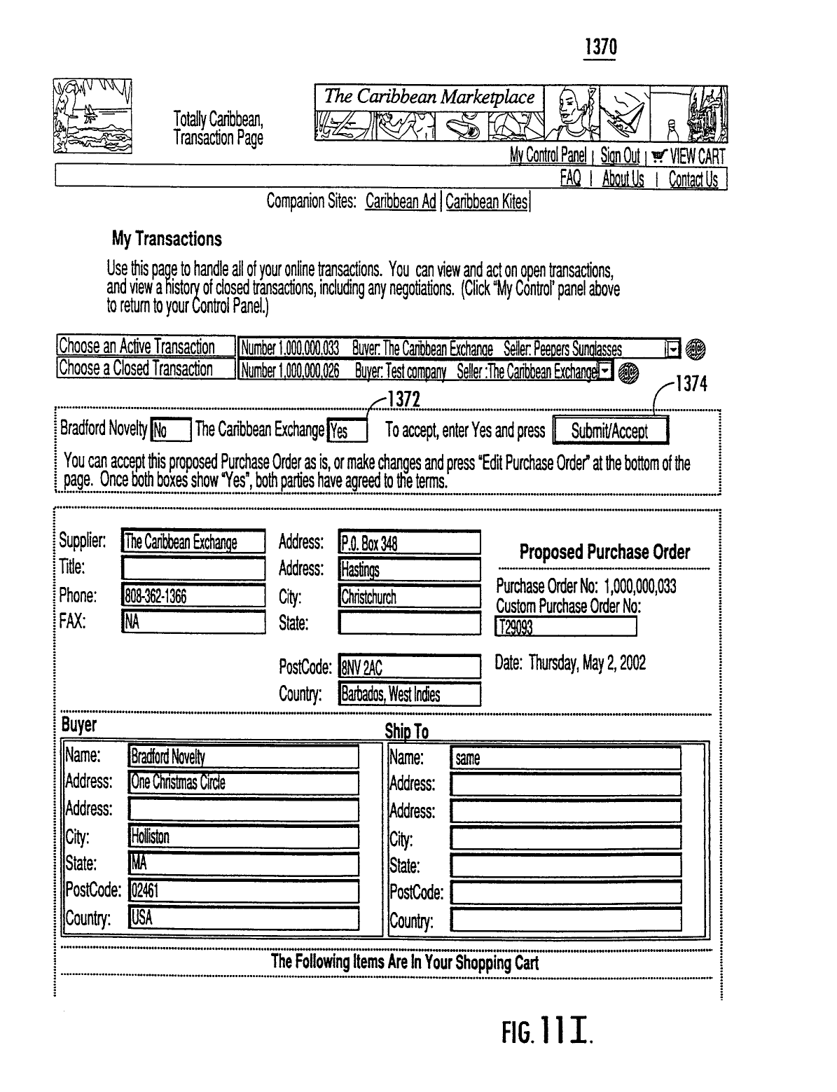

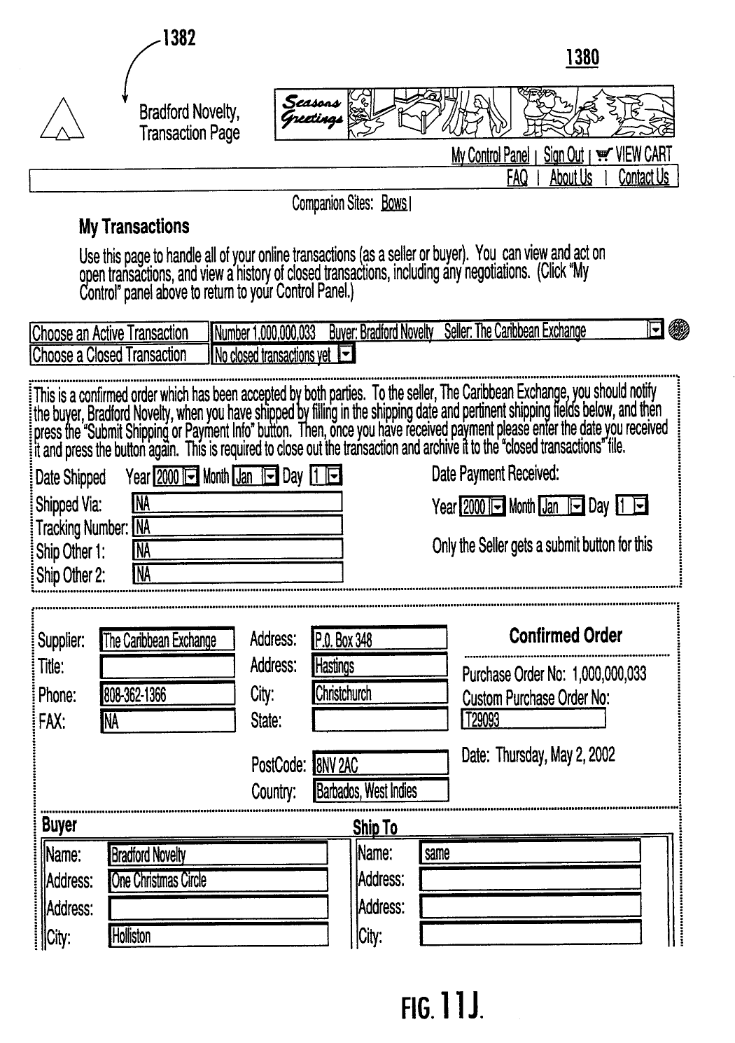

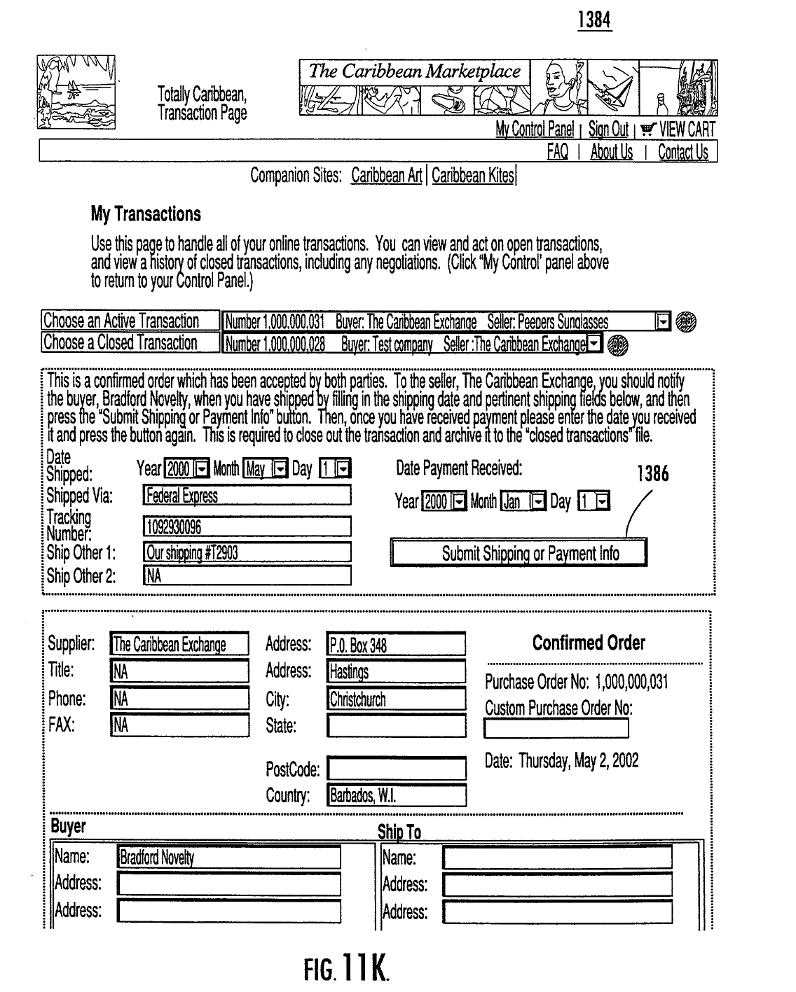

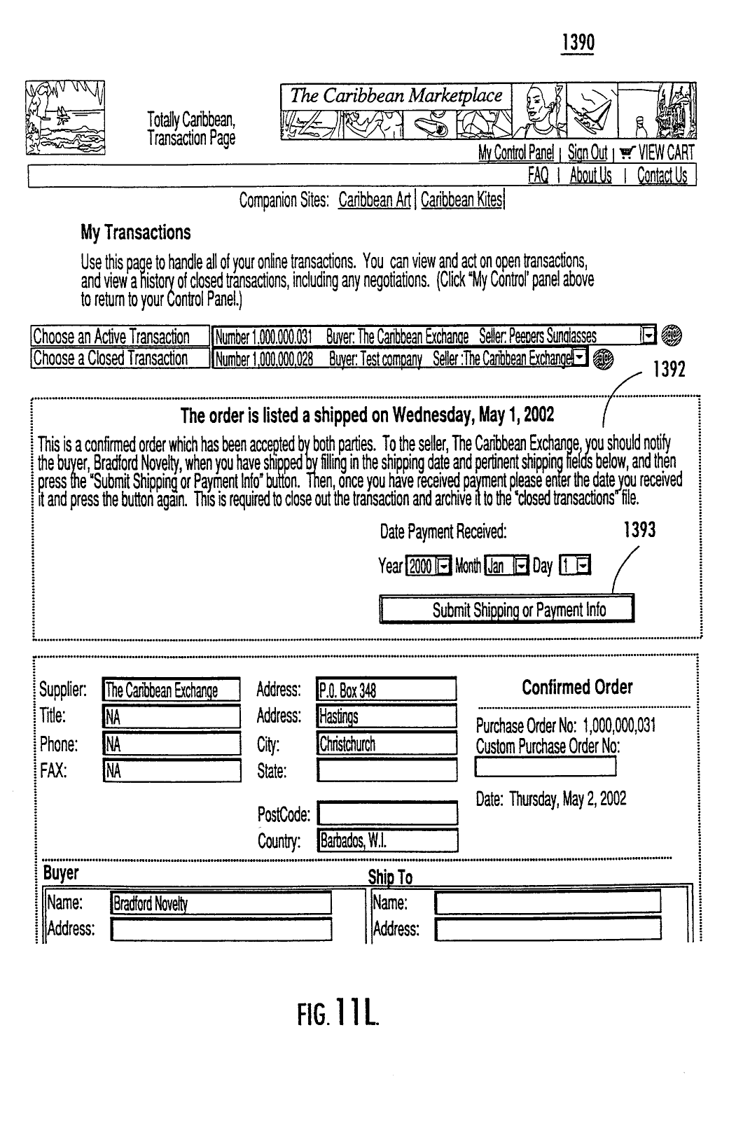

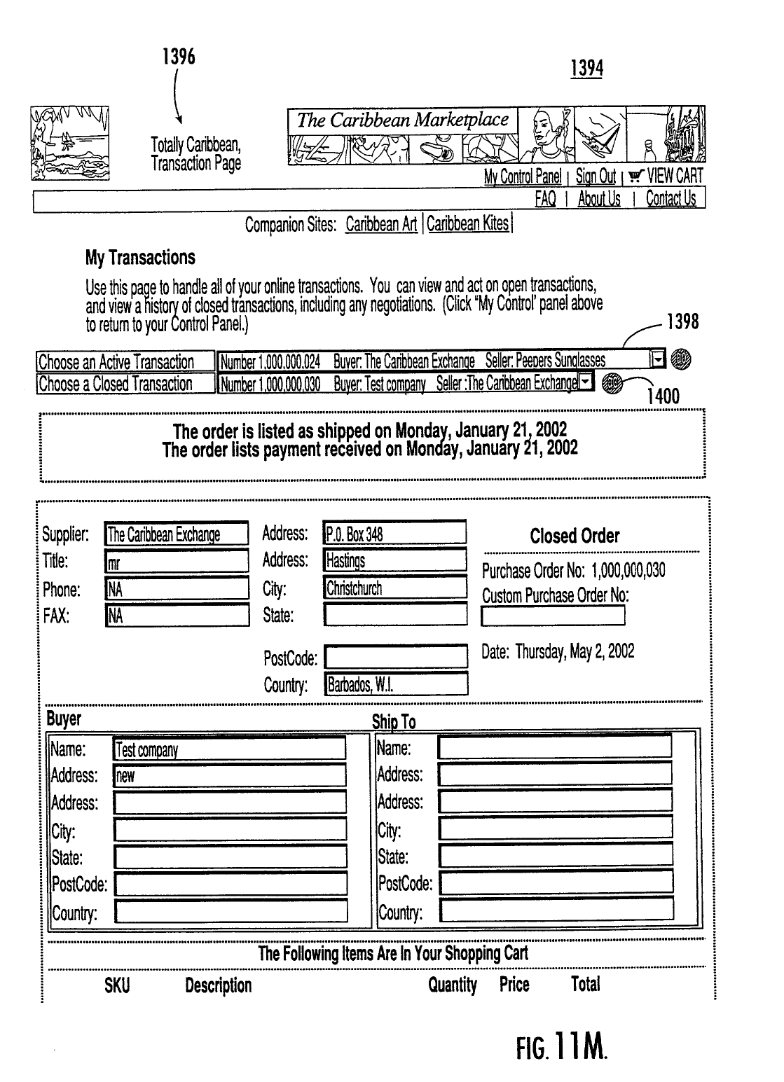

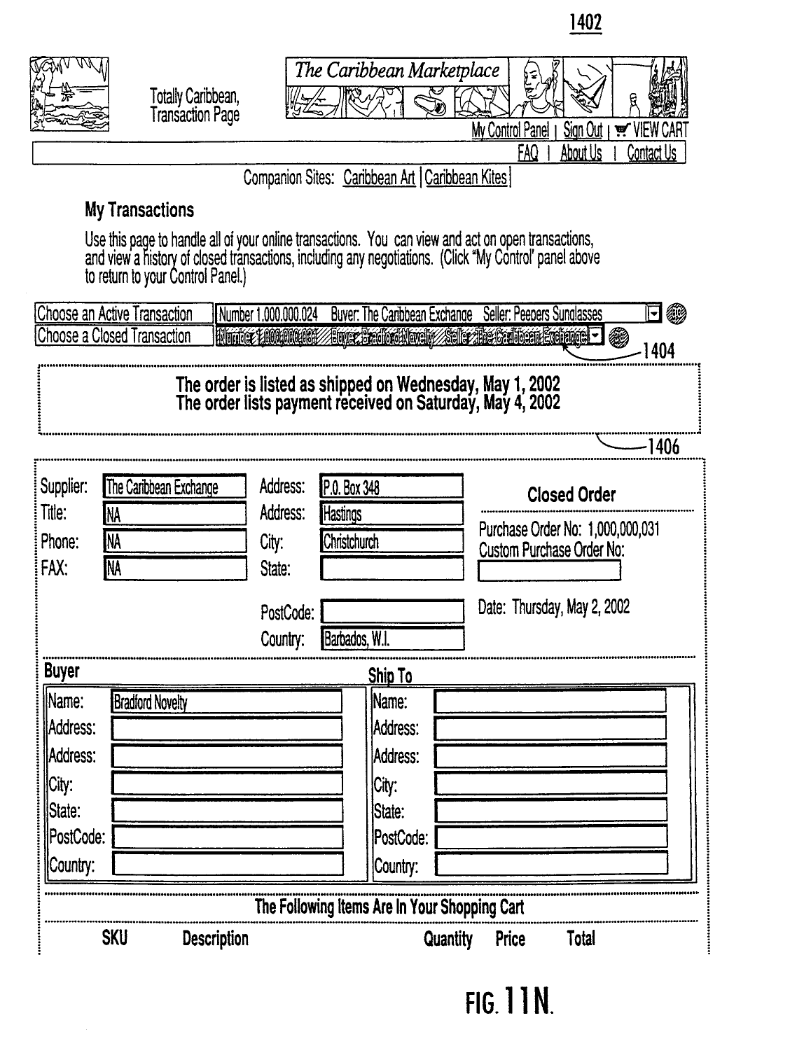

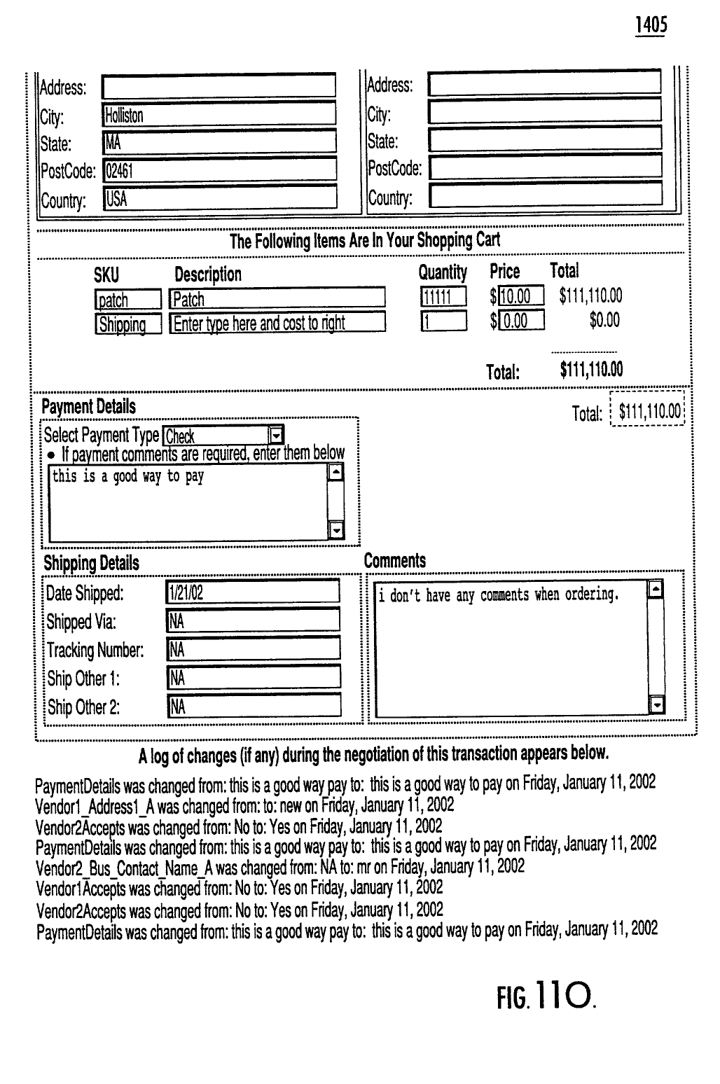

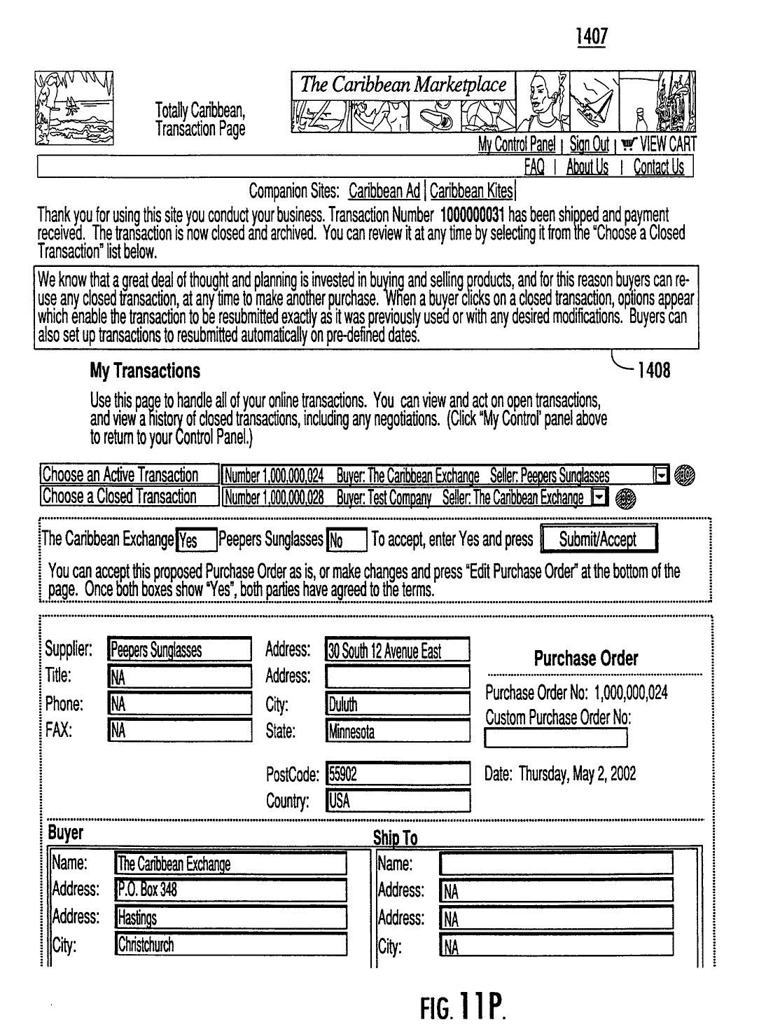

Web site screen 1300, FIG. 11A is a view of a shopper in the Caribbean marketplace viewing the products in shopping cart 306. Shopping cart 1306 indicates whether the products are ordered from wholesale vendor or retail vendor, as indicated by arrow 1308. A user presses Checkout button 1310 to process the order, Continue Shopping button 1311 to continue shopping, or Empty Cart button 1312 to empty the shopping cart. As shown in FIG. 11A, the Caribbean marketplace logo 1302 and banner 1304 are displayed.

Web site screen 1313, FIG. 11B shows a buyer reviewing pending orders. A buyer (in example in the totally Caribbean marketplace) is finalizing orders from two different sellers in a marketplace (the Caribbean marketplace) at wholesale. As indicated by arrows 1314 and 1315, the seller and buyer information comes from registration company data. As indicated by text block 1316, the buyer can negotiate the order and then submit the order. FIG. 11C is a continuation of Web site screen 1313 and shows that the buyer can change contact information, as indicated by arrow 1320, can change the quantities, as indicated by arrow 1322, and can also select the payment methods that the seller indicates it accepts from drop down select box 1324.

Web site screen 1330, FIG. 11D shows a buyer reviewing a proposed purchase order from a second seller by clicking on the link for the second seller, in this example, “Totally Caribbean” link 1332. As shown in Web site screen 1333, FIG. 11E, a buyer can initiate negotiation. In this example, the buyer is proposing a counteroffer, as indicated by arrow 1334. Web site screen 1336, FIG. 11F shows that a buyer has placed a wholesale purchase order with one seller, as indicated by arrow 1338, and receives a purchase order, as indicated by arrow 1340. The seller is then notified to review the order in the sellers Control Panel. Also shown in FIG. 11F, the buyer has made changes before sending the order, as indicated by arrow 1342. Web site screen 1350, FIG. 11G shows that the seller has received an e-mail for the new order and is reviewing an open transaction, as shown by arrow 1352. Web site screen 1354, FIG. 11H shows that a buyer has proposed terms and the buyer shows a “Yes”, as indicated by arrow 1356. The seller has yet to agree, so seller shows a “No”, as indicated by arrow 1357. If the seller makes a change, the buyer's status changes to a “No”. This allows offers and counteroffers, any number of times, until an agreement is made. If two “Yes” entries are made, an agreement is made and a final purchase order is assigned, as indicated by arrow 1358. The seller can also enter the shipping method, cost, and the like, as indicated by arrow 1360, and the payment details are shown, as indicated by arrow 1362. Web site screen 1370, FIG. 11I shows that a seller has changed a “No” to “Yes” in box 1372. The seller then presses Submit/Accept button 1374, which indicates that the seller is making a counter-offer. The buyer is notified and can agree or reject the offer. Web site screen 1380, FIG. 11J shows a buyer, in this example, Bradford Novelty, as shown by arrow 1382, has received the sellers counter-offer and accepted it by changing the “No” to a “Yes” (as shown in FIG. 11I). Both parties entering “Yes” indicated a confirmed order. The Seller is automatically notified. Both parties can then view the purchase order. Web site screen 1384, FIG. 11K shows that a seller has received notice that the buyer has accepted and the order is confirmed. The seller enters shipping data and details and clicks the Submit Shipping or Payment Info button 1386. As shown in Web site screen 1390, FIG. 11L, the seller has shipped, as shown by text block 1392. When the payment is received, the seller enters the date and clicks the Submit Shipping or Payment Info button 1393 and the transaction is closed. The buyer is automatically notified. Web site screen 1394, FIG. 11M, is a view of the transaction section of the Control Panel for the company “Totally Caribbean”, as indicated by arrow 1396. Users can select active or closed transactions, or any of the selections from drop down/select boxes 1398 and 1400. Web site screen 1402, FIG. 11N shows a user reviewing a closed transaction, as indicated by arrow 1404. Text block 1406 indicates that the product has shipped. A complete history of the order, including every keystroke either party has entered, is shown in Web site screen 1405, FIG. 11O. Web site screen 1406, FIG. 11P shows how a buyer can used a closed transaction to reorder by modifying the closed transaction and resubmitting the order with new dates, as shown by text block 1407.

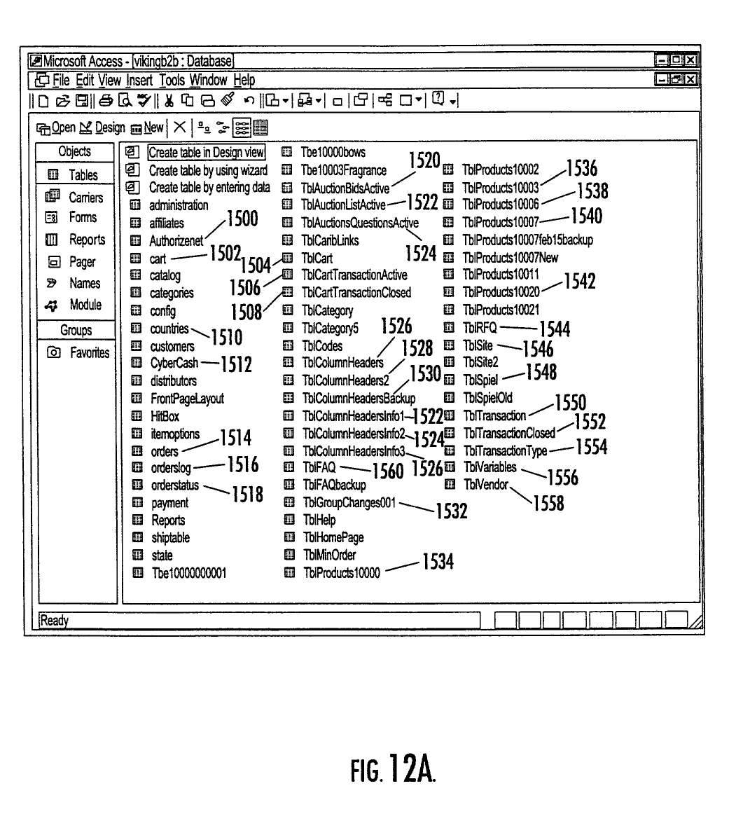

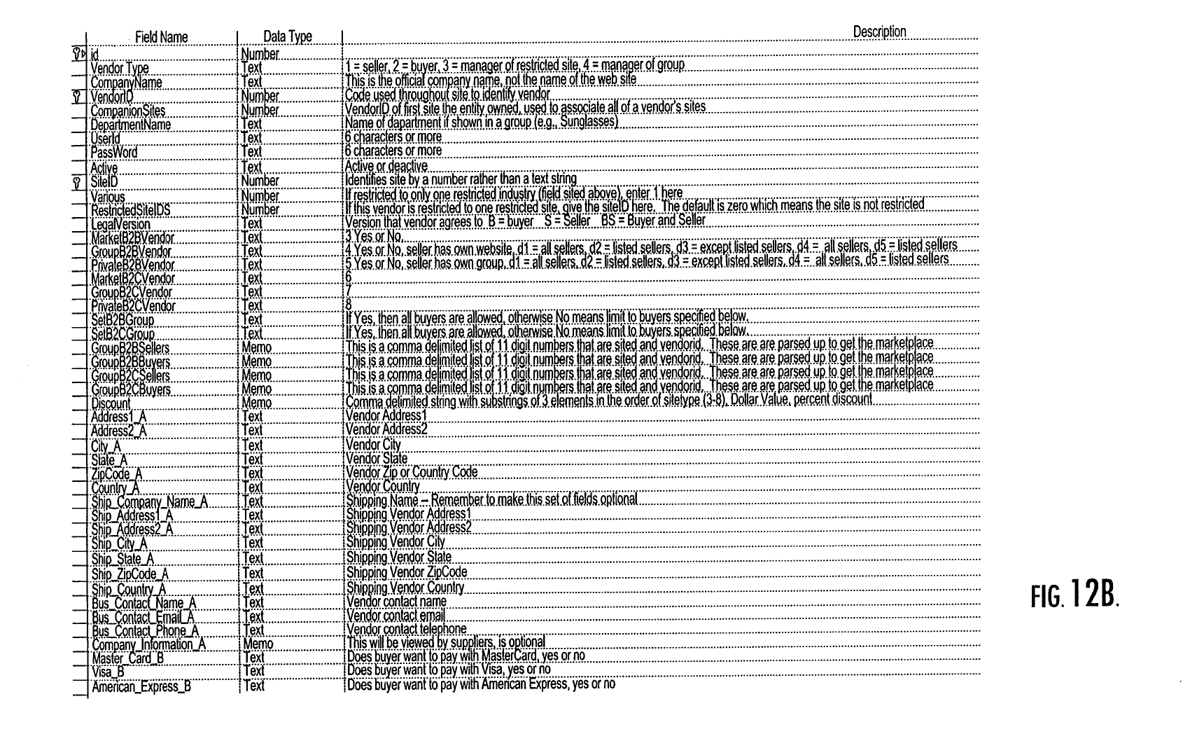

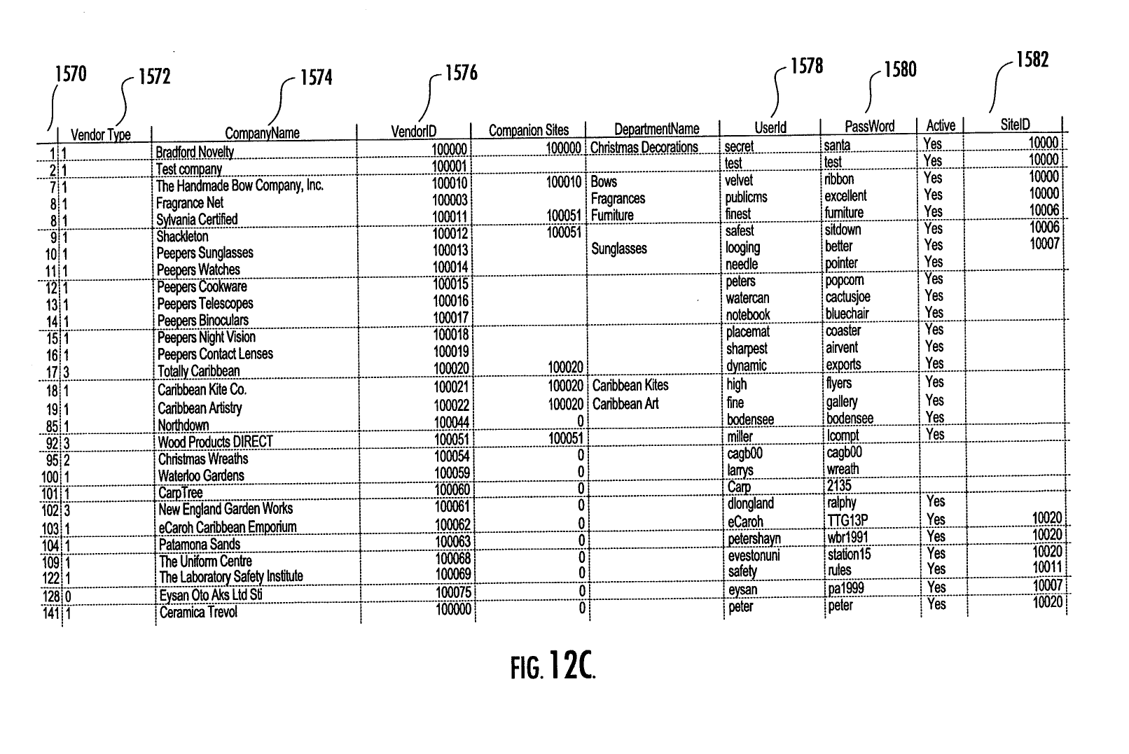

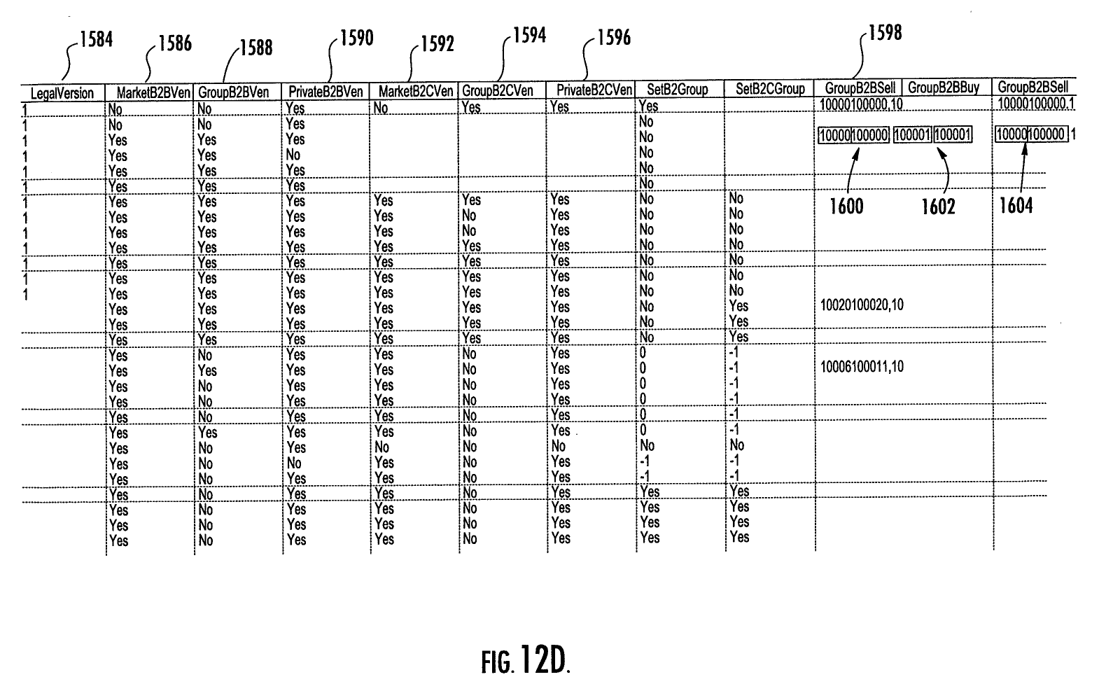

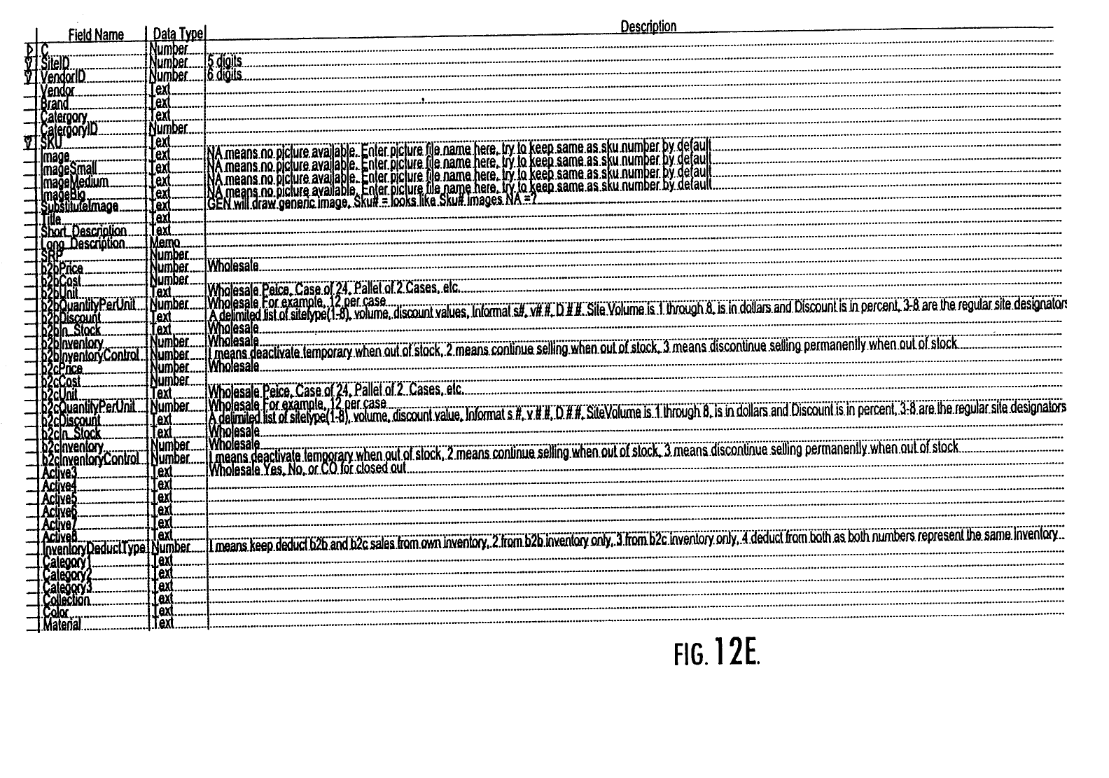

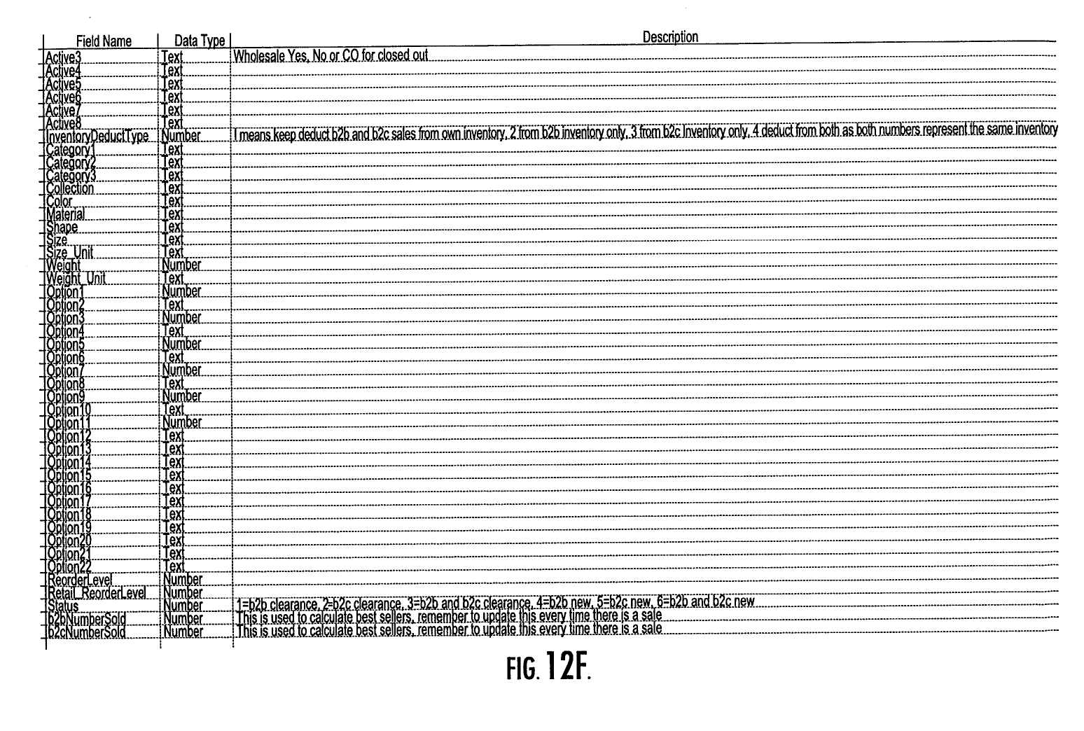

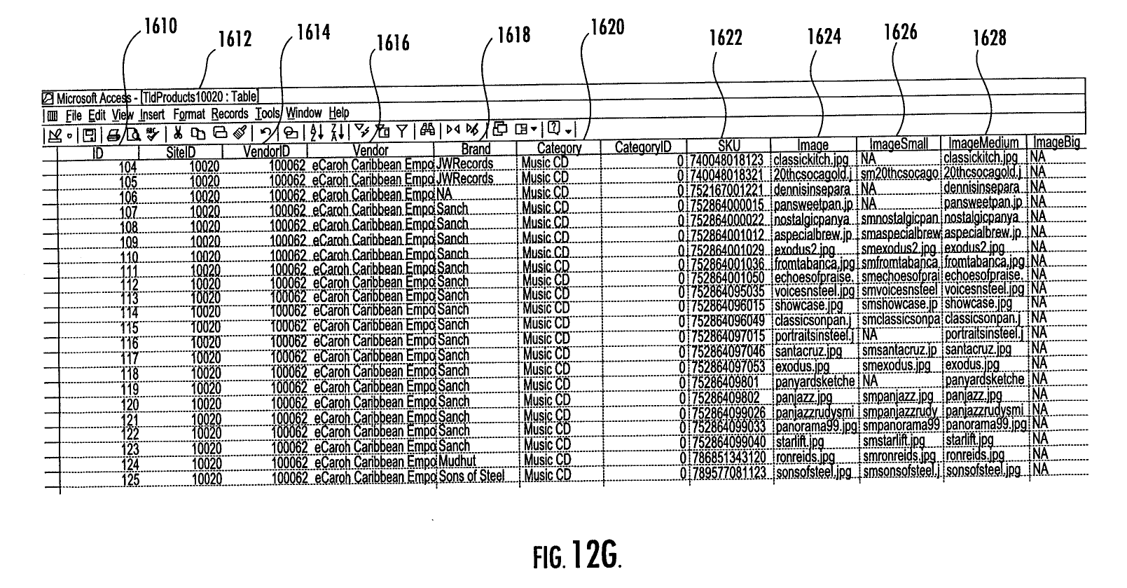

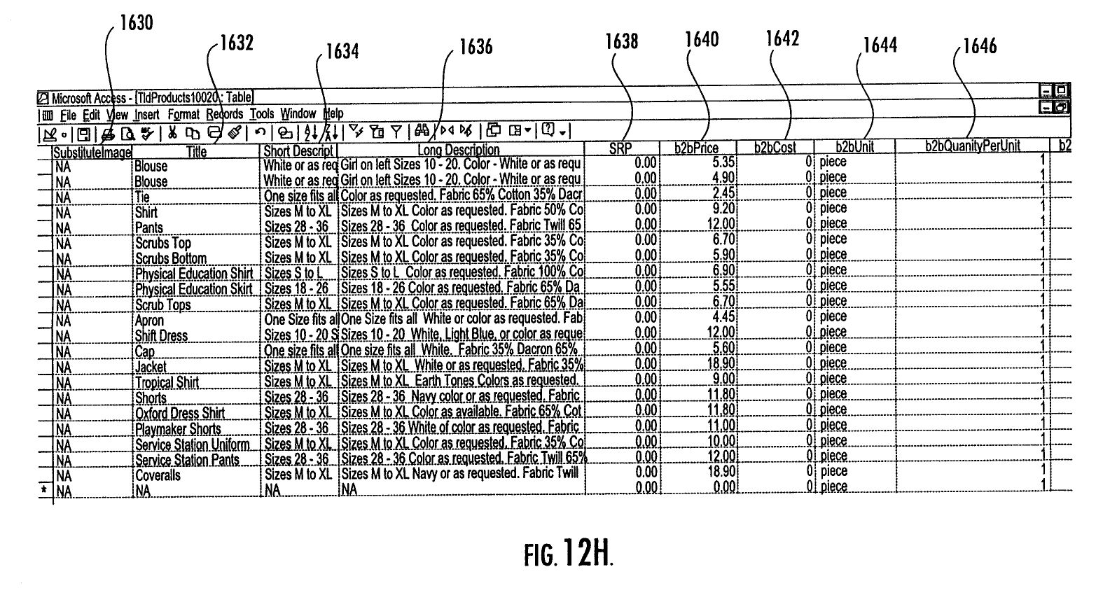

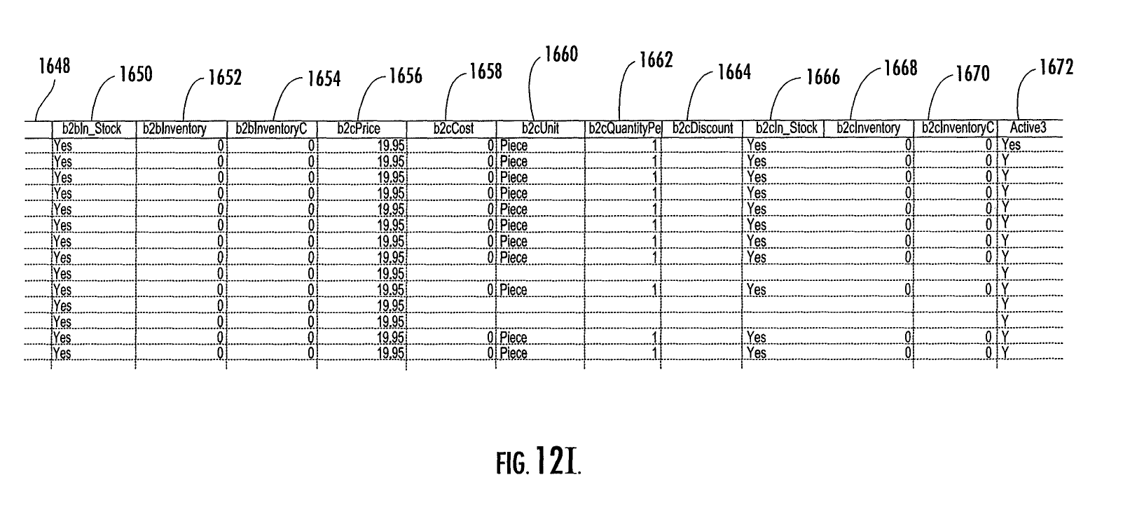

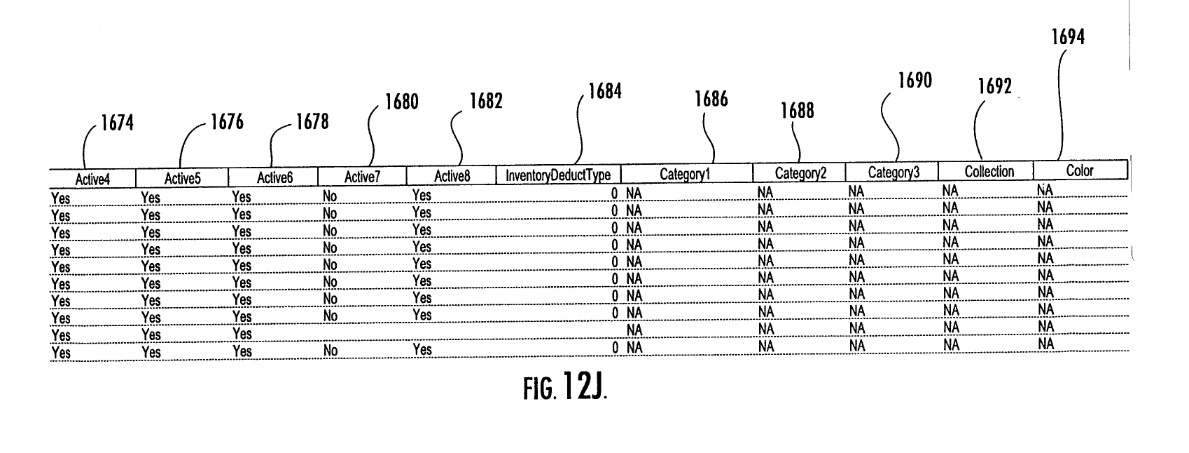

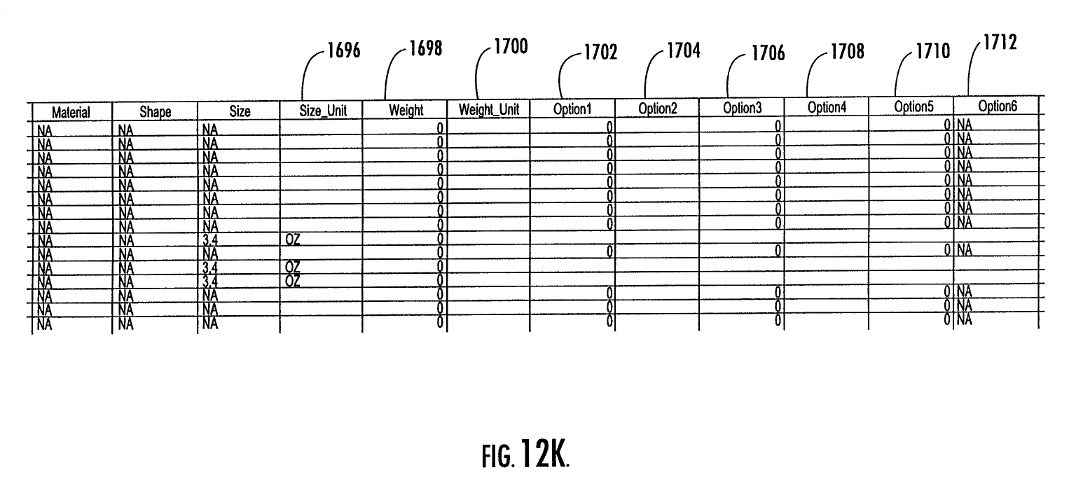

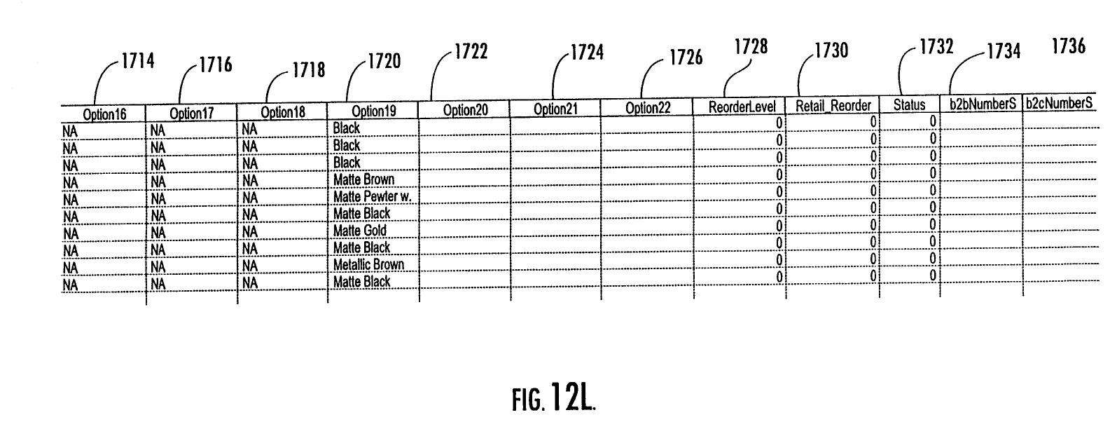

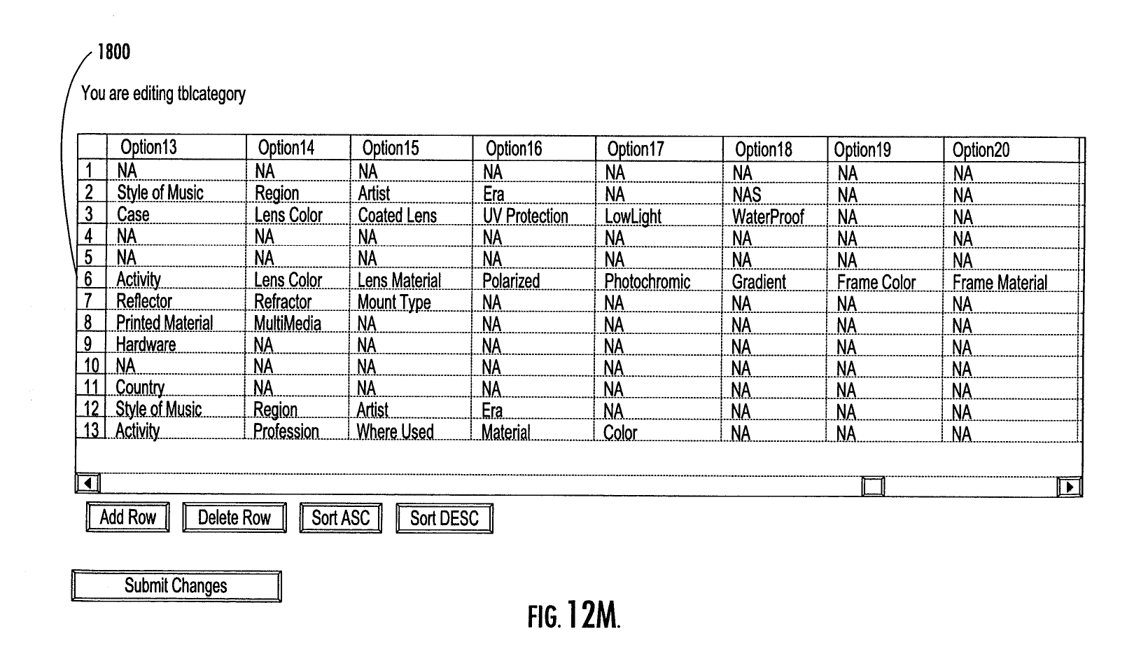

FIG. 12A shows all data in data storage 350, FIG. 4 for sellers, buyers and managers, all product information and all other required information required to drive all of the Web sites, marketplaces, and transactions in accordance with one embodiment of this invention. In one example, all of the information is stored in one database, such as Access™ or SQL Server™ database. Relevant tables include the Authorizenet table 1500 which contains information to approve credit cards. Cart table 1502, which contains shopping cart information and links to TblCart table 1504, TblCartTransactionActive table 1506, and TblCartTransactionClosed table 1508. Countries table 1510 contains every country, code and shipment cost. CyberCash table 1512 contains credit card information. Orders table 1514, orderslog table 1516, and orderstatus table 1518 contain all information related to orders and to status. TblAuctionBidsActive table 1520, TblAuctionListActive table 1522, and TblAuctionsQuestionsActive table 1524 contain auction information links. TblColumnHeaders table 1526, TblColumnHeaders2 table 1528, TblColumnHeadersBackUp table 1530, TblColumnHeaderInfo1 table 1532, TblColumnHeaderInfo2 table 1534, and TblColumnHeaderInfo3 table 1536 contain the column headings and search criteria. TblFAQ table 1560 contains customized fact information. TblGroupChanges001 table 1532 creates buying groups to qualify for minimum orders and discount levels. TbIProducts10000 table 1534 contains all Christmas decoration products. TBLProduct10003 table 1536 has all fragrance products. TBLProducts10006 table 1538 contains all wood products. TBLProduct10007 table 1540 contains all optical products. TBLProducts10020 table 1542 has all Caribbean products. TblRFQ table 1544 contains all buyers request quotes. TblSite table 1546 contains all industry/region information. TblSpiel table 1548 has all customize text. TblTransaction table 1550, TblTransactionClosed table 1552, TBLTransactionType table 1554, and TblVariables table 1526 contain all active and closed transactions. TblVendor table 1558 contains all company information.

FIG. 12B is a design view of the vendor or company table TblVendor 1558. FIGS. 12C-D show an example of the vendor table which lists all companies and marketplace managers information and includes fields for unique vendor ID 1570, FIG. 12C, vendor type 1572 (in which a 1 indicates a seller, a 2 indicates a buyer, and a 3 indicates a manager). The vendor table also includes fields for company name field 1574, vendor ID field 1576 (a unique six digit ID) user ID field 1578, password field 1580, site ID field 1582, which indicates which marketplace the vendor is in, contract signed field 1584, FIG. 12D, field 1586 which indicates whether a vendor will sell in a general wholesale marketplace, field 1588, which indicates whether a vendor will sell in a group wholesale marketplace, field 1590 which indicates whether a vendor desires its own private Web site, field 1592, which indicates whether a vendor desires to sell in a retail marketplace, field 1594 which indicates whether a vendor wishes to participate in a retail group, field 1596 which indicates whether a vendor has its own private retail site, and field 1598, which indicates whether a company or vendor in this row forms and manages a marketplace. All sellers in the group are in this comma delineated list of combined fields of site ID's and vendor ID (e.g., field 1598). This field locates all of the sellers in a given group marketplace. As shown by arrow 1600, a group of wholesale sellers is indicated (e.g., site ID 10000 and vendor ID 100000). A group of wholesale buyers (e.g., site ID 10001 and vendor ID 100001) is indicated, as shown by arrow 1604, and a group of retails is indicated, (e.g., site ID 10000 and vendor ID 100001) as shown by arrow 1604.

FIGS. 12E-F show a design view of the product table in accordance with one possible design in accordance with this invention. There is a design table for all products in each industry or regional marketplace. FIGS. 12G-L show all of the associated field for the products table. Specifically, unique ID field 1610, FIG. 12G, site or marketplace ID field 1612, seller ID field 1614, seller name field 1616, brand field 1618, category field 1620, unique model number field 1622, 50×50 pixel picture ID field 1624, 200×200 pixel picture field 1626, and 400×400 pixel picture field 1628. Fields 1624, 1626, and 1628 are graphical picture file names. These files go in a folder on the server under the graphics/siteID/vendorID location. Products table further includes image for model number field 1630, FIG. 12H, title field 1632, short description field 1634, long description field 1636, suggested retail price field 1638, wholesale price field 1640, cost of wholesale unit field 1642, wholesale unit field 1644, and quantity per field (e.g., twelve per box) field 1646. Products table also includes B2B discount set wholesale discount levels field 1648, FIG. 12I, inventory control field 1650, how many field 1652, active inventory control field 1654, retail price field 1656, cost field 1658, retail unit field 1660, quantity per unit field 1662, discount level field 1664, inventory control fields 1666, 1668, and 1670, and activate or deactivate the product in site type 3 field 1672, and activate or deactivate product in site types 4, 5, 6, 7, and 8, fields 1674, 1676, 1678, 1680, and 1682, respectively, FIG. 12J. Activate or deactivate products fields 1666-1682 gives companies the ability to activate or deactivate this product in any of the marketplaces or Web sites, wholesale or retail, where this product is sold. Users can activate or deactivate all wholesale sites, retail Web sites, any marketplace, any brands and any product. A seller can, for example, select ten products out of one hundred to sell in a wholesale marketplace but put all one hundred products in its own site. Products table also includes inventory deduct type field 1684, FIG. 12J which, when a sale occurs, deducts from the retail inventory, wholesale inventory or both as selected. Sellers can create layers of categories in fields 1686, 1688, and 1690. The product table also includes search by collection field 1692 and search by color field 1694. Products table further includes search criteria fields 1696, 1698 and 1700, FIG. 12K which allows a seller to choose any unit of size, weight, width, and an area to search from. Custom search fields 1702, 1704, 1706, 1708, 1710, 1712, 1714, FIG. 12L, 1716, 1718, 1720, 1722, 1724, and 1726 provide the creation of custom search criteria. In this preferred example, there are 22 custom search fields. Table TblCategory contains the headings for each of these options. This allows any number of sellers to create custom search field criteria for each product category. Fields 1728 and 1730 allow the seller to set inventory levels and alarms such as e-mails and notices. With permission, wholesalers can show their inventory levels to retailers. Status field 1732 provides the best sellers, what's new, and clearance information. Field 1734 contains how many wholesale units are sold and field 1736 stores how many retail units are sold. Fields 1734 and 1736 automatically drive the bestseller lists in the sites and marketplaces.

FIG. 12M is an example showing the various search options a seller has selected. In this example, a sun glass seller has set the custom search criteria, as indicated by the selections in row 1800, with search options for activity, lens color, lens material, polarized, photochromic, gradient, frame color and frame material.

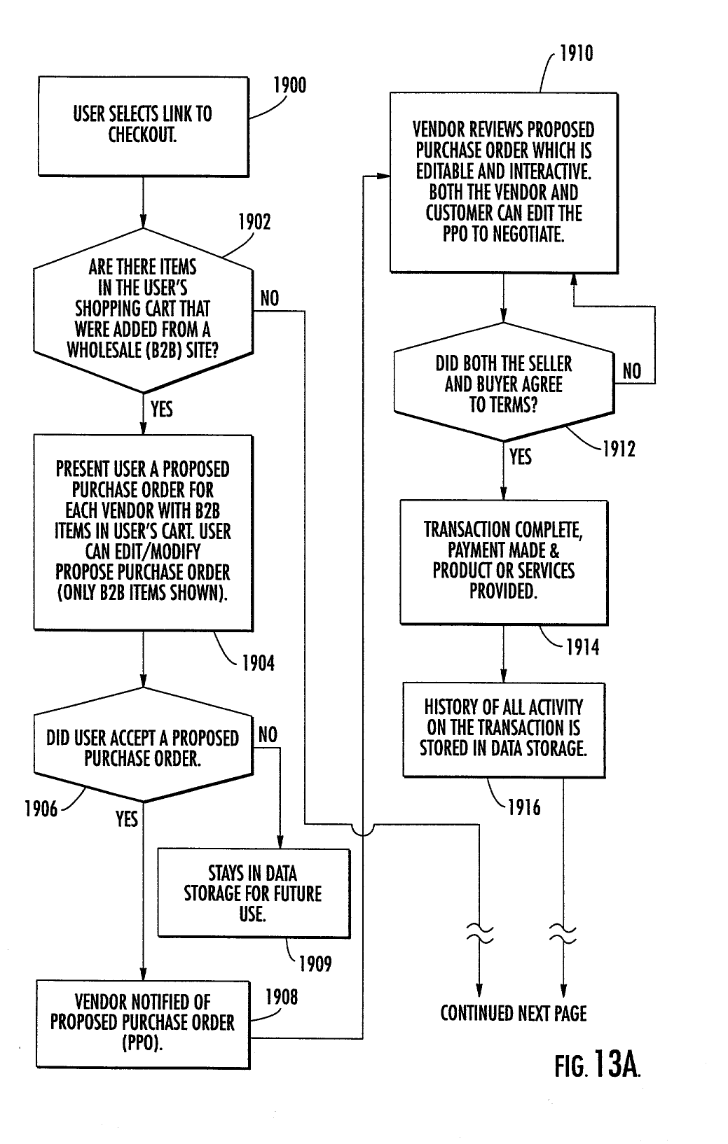

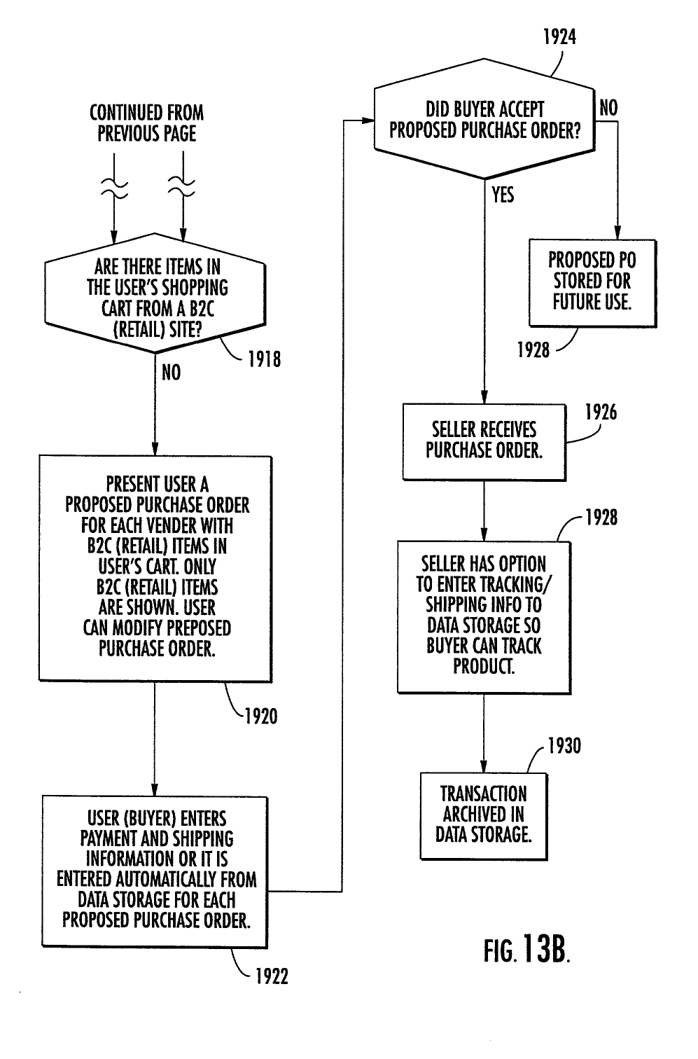

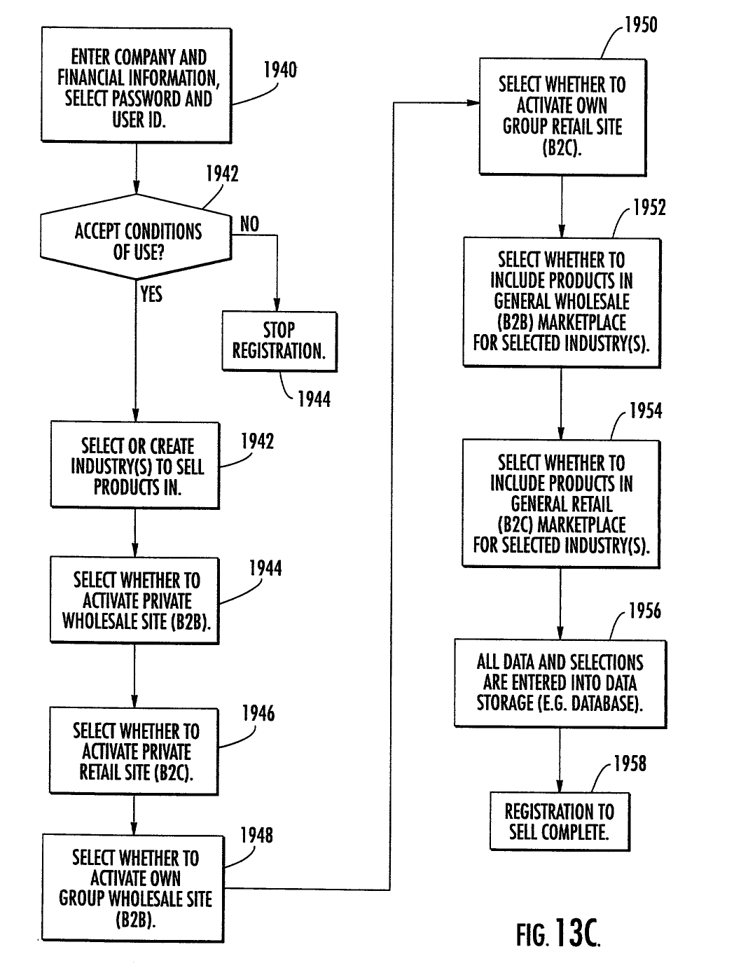

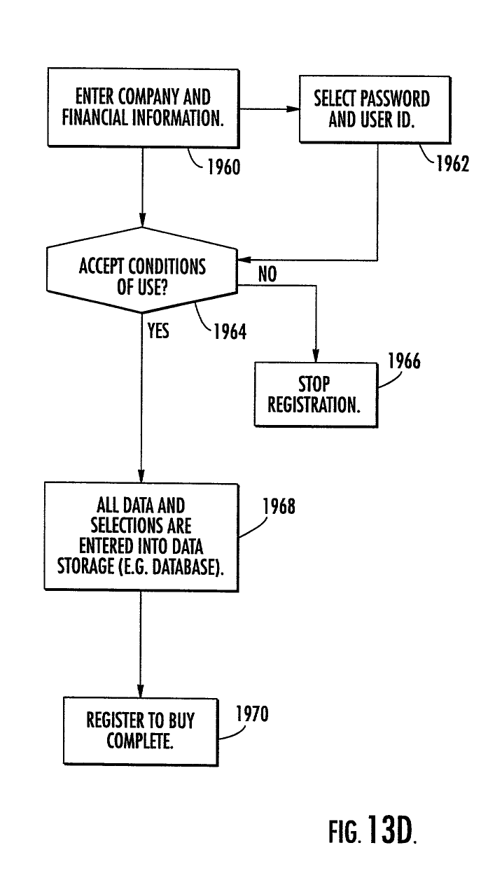

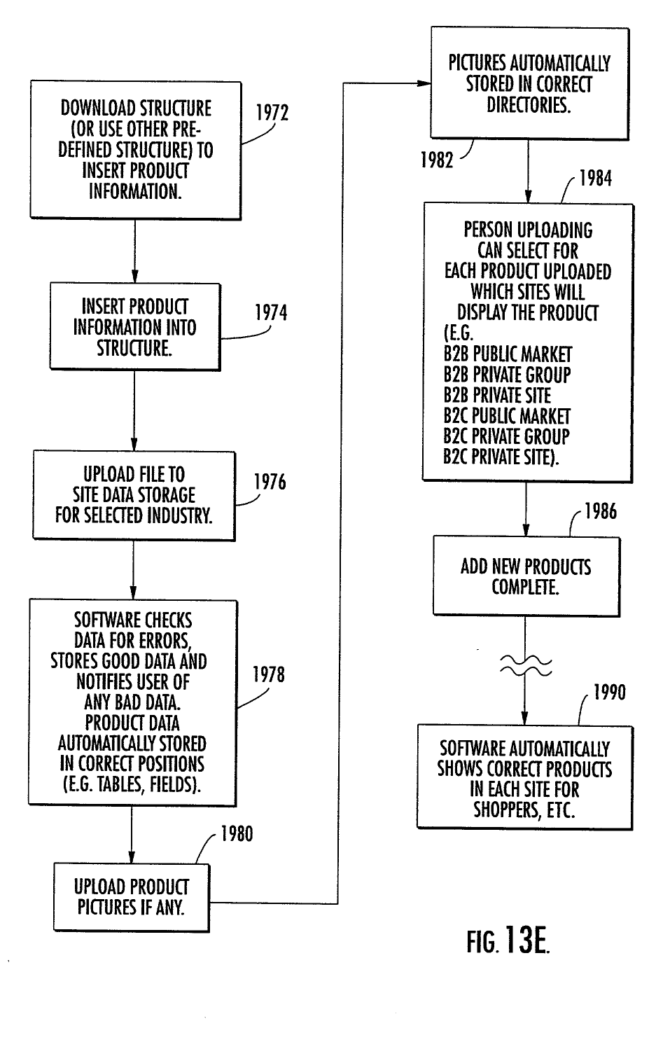

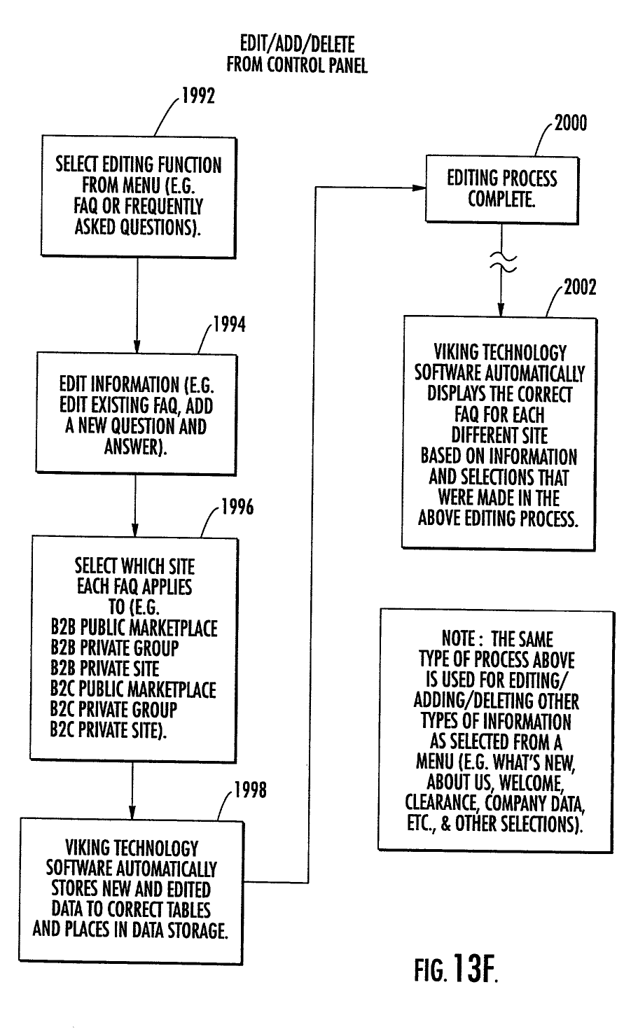

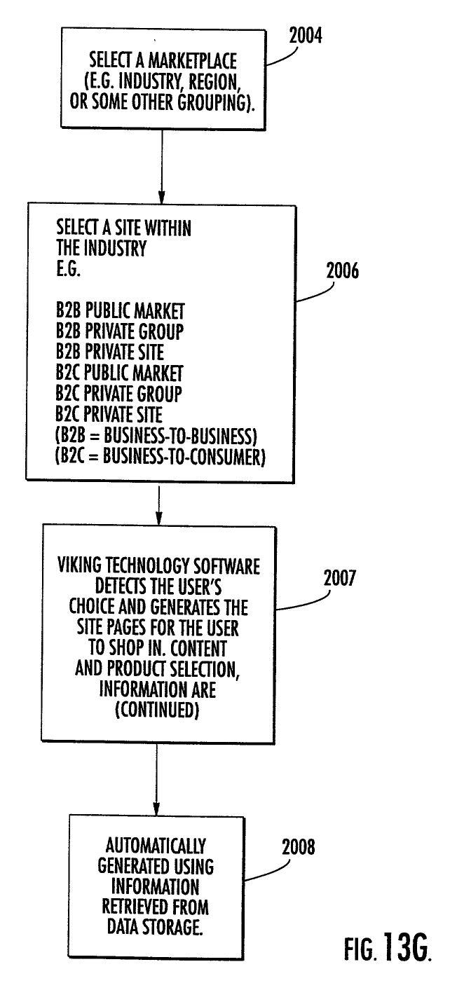

The check out process in accordance with one embodiment of this invention includes the steps of: a user selecting a link to check out, step 19OO, FIG. 13A; determining if there are items in the user's shopping cart that were added from a wholesale (B2B) site, step 1902. If there are items in the user's shopping cart, the user is presented with a proposed purchase order for each vendor with B2B items in the user's cart, step 1904. Users can edit/modify the proposed purchase orders (only B2B items shown) by checking if a user accepted a proposed purchase order, step 1906. If the answer is “Yes” the vendor is notified of a proposed purchase order, step 1908. If the answer is “No”, the data stays in storage for future use, step 1909. The vendor then reviews the proposed purchase order, which is editable and interactive, step 1910; a determination is made whether both the seller and the buyer have agreed to terms, step 1912; if both the seller and buyer agree to the terms the transaction is completed, payment made, and product or services provided, step 1914. If however, the seller and the buyer do not agree, the vendor reviews the proposed purchase order, step 1910. A history of all activity of the transaction is kept in data storage, step 1916. A determination is made whether there are items in the users shopping cart from a B2C (retail site), step 1918, FIG. 13B. If there are no items in the user's shopping cart then the user is presented with a proposed purchase order for each vendor with B2C (retail) items in the user's cart, step 1920; a user (e.g., a buyer) enters payment and shipping information, or it is entered from the data storage for each proposed purchase order, step 1922. A determination is made whether the buyer accepted the proposed purchase order, step 1924. If the buyer has accepted the proposed purchase order, then the seller receives the purchase order, step 1926. If the buyer did not accept the proposed purchase order a proposed purchase order is stored for future use, step 1928. The seller has the option to enter tracking/shipping information to data storage so a buyer can track a product, step 1928. The transaction is then archived in data storage, step 1930.

One method of registering to sell in accordance with this invention includes the steps of entering company and financial information, password selection, and user ID, step 1940, FIG. 13C; accepting the conditions of use, step 1942. If the conditions of use are accepted a user selects or creates industry(s) to sell products, step. 1942. Otherwise the registration stops, step 1944. A user then selects whether to activate private wholesale site (B2B), step 1944; selects whether to activate private retail site (B2C), step 1946; selects whether to activate its own group wholesale site (B2B), step 1948; selects whether to activate its own group retail site (B2C), step 1950; selects whether to include products in the general wholesale (B2B) marketplace for the selected industry(s), step 1952; selects whether to include products in general retail (B2C) marketplace for selected industries, step 1954. All data selections are entered into data storage, step 1956, and the registration is complete, step 1958.

One method of registering to buy in accordance with this invention includes the steps of: entering company and financial information, step 1960; selecting password and user ID, step 1962; and accepting the conditions of use, step 1964. If the conditions of user are not accepted the registration stops, step 1966; if the conditions of use are accepted, all data selections are entered into data storage, step 1968; and the registration to buy is completed, step 1970.

The method for adding new products in accordance with one embodiment of this invention includes the steps of: downloading structure (or using other predefined structure) to insert products information, step 1972, FIG. 13E; inserting product information into a structure, step 1974; uploading a file to the site data storage for a selected industry, step 1976; providing software to check the data for errors, storing good data and notifying user of rejected data, step 1978; uploading product pictures, step 1980; storing the pictures automatically in the correct directories, step 1982; selecting for each product uploaded which sites will display the product, such as B2B public market, B2B private group, B2B private site, B2C public market, B2C private group, and B2C private site, step 1984; and completing the add new products process, step 1986. The software automatically shows the correct products in each site for the shoppers, as shown by block 1990.

The method of editing, adding, and deleting products from the Control Panel in one embodiment of this invention includes the steps of: selecting the editing function from a menu, such as a frequently asked questions menu, step 1992, FIG. 13F; editing information, such as editing existing FAQ or adding a new question and answer, step 1994; selecting to which site the information applies (e.g., the FAQ), step 1996; automatically storing the new and edited data in the correct tables and placing the data in the data storage, step 1998; and completing the editing process, step 2000.

The software in accordance with the subject invention as described above, automatically displays the correct FAQ for each different site based on the information and selections that were made in the editing process, step 2002. The same type of process as shown above is used for editing/adding/deleting other types of information as selected from a menu (e.g., What's New, About Us, Welcome, Clearance, Company Data, and the like).

The method of selecting a site to shop in one embodiment of this invention includes the steps of: selecting a marketplace, e.g., industry, region, or some other grouping, step 2004, FIG. 13G; selecting a site within the industry, such as B2B public marketplace, B2B private group, B2B private site, B2C public marketplace, B2C private group, and B2C private site, step 2006; and employing the Viking Technology™ software (e.g., software engine 20, seller's interface 12, manager's interface 64, or buyer's interface 352, FIGS. 1, 2, and 4) to detect the user's choices and generate the Web site pages for the user to shop in, step 2008. Content and product selection information are automatically generated using information retrieved from data storage.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A method of selling products and/or services, the method comprising the steps of:
obtaining product or service data, seller data, and Web site choices for each seller of a proposed marketplace;
generating a marketplace including selected products or services of each seller based on the seller's product or service data; and
generating for each seller of a number of sellers, a business-to-business Web site or a business-to-consumer Web site or both.

2. The method of claim 1 further including the step generating a revenue model in which a percentage of each seller's sales is paid to a marketplace manager.

3. The method of claim 1 in which the marketplace manager provides advertising, locates sellers and manages the marketplace activity.

4. The method of claim 1 in which a commission is paid to anyone who refers a company to use the method of selling products and/or services.

5. The method of claim 1 in which the generated marketplace is a business-to-business marketplace.

6. The method of claim 1 in which the generated marketplaces is a business-to-consumer marketplace.

7. The method claim 1 in which the generated marketplace is an industry marketplace or region marketplace which includes all marketplaces for wholesale and retail industries and regions.

8. The method claim 1 in which the generated marketplace is a public business-to-business wholesale marketplace based on each industry or region.

9. The method claim 1 in which the generated marketplace is a business-to-business wholesale group marketplace based on a set of rules provided by the seller which allow the seller to select the product data available in the marketplace and which sellers can be members of the business-to-business wholesale group marketplace.

10. The method claim 9 in which the generated marketplace is a public business-to-consumer wholesale marketplace based on each industry or region.

11. The method claim 10 in which the generated marketplace is a business-to-consumer wholesale group marketplace based on a set of rules provided by the seller which allow the seller to select the product data available in the marketplace and which sellers can be members of the business-to-business wholesale group marketplace.
